(19) United States
(12) Patent Application Publication
(10) Pub. No.: US 2005/0160014 A1
(43) Pub. Date: Jul. 21, 2005

(54) Techniques for identifying and comparing local retail prices

(75) Inventors: Andy Moss, Alamo, CA (US); Frank B. Dancs, San Carlos, CA (US); Vincent Lo, San Francisco, CA (US)

Correspondence Address: BEYER WEAVER & THOMAS LLP, P.O. BOX 70250, OAKLAND, CA, 94612-0250, US

(73) Assignee: Cairo Inc.

(21) Appl. No.: 11/034,409

(22) Filed: Jan. 11, 2005

Related U.S. Application Data
(60) Provisional application No. 60/536,979, filed on Jan. 15, 2004.

(51) Int. Cl. G06F 17/60

(52) U.S. Cl. 705/26

(57) ABSTRACT

Techniques are described relating to the aggregation and use of local retail information for the purpose of providing a wide variety of valuable services to consumers and retailers.

### RELATED APPLICATION DATA

The present application claims priority under 35 U.S.C. 119(e) to U.S. Provisional Patent Application No. 60/536,979 for TECHNIQUES FOR IDENTIFYING AND COMPARING LOCAL RETAIL PRICES filed Jan. 15, 2004 (Attorney Docket No. CIROP001P), the entire disclosure of which is incorporated herein by reference for all purposes. The present application is also related to U.S. Patent Application Nos. [unassigned] (Attorney Docket No. CIROP001) and [unassigned] (Attorney Docket No. CIROP003), both filed on the same day as the present application.

### BACKGROUND OF THE INVENTION

The present invention relates to facilitating access by consumers to local retail price information and related techniques.

Many solutions already exist to provide price comparison when shopping online. However, for consumers who need something today or who just prefer to buy from physical stores, it can be very hard to accurately compare prices without visiting multiple stores.

Meanwhile, retailers and manufacturers in the “offline” world spend billions a year on promotions, weekly circulars, loyalty programs, coupons/rebates, and other advertising to drive traffic or influence brand loyalty and market share. For advertisers these are all mass market focused and it is extremely difficult for them to target specific consumer segments or reach consumers with 1-to-1 prices and promotions.

It is therefore desirable to provide techniques which can address these inefficiencies.

### SUMMARY OF THE INVENTION

According to various embodiments of the present invention, a variety of services are provided which help consumers find and compare the best prices and promotions for products at their local retail stores.

According to a specific embodiment, methods and apparatus are provided for enabling consumers to take advantage of price match offers. A search interface is presented by which a consumer can identify a first price for a product offered by a first vendor in a geographic region. Documentation of the first price which is sufficient for taking advantage of a price match offer for the product offered by a second vendor in the geographic region is then provided to the consumer.

According to another specific embodiment, methods and apparatus are provided for aggregating local retail information. A plurality of web sites including retail information are identified. The retail information includes geographic location information for corresponding retailers. At least a portion of the retail information is retrieved and stored in a database indexed by the geographical location information. The plurality of web sites are monitored on an ongoing basis to detect changes in the retail information. The database is updated in response to the changes in the retail information.

According to yet another specific embodiment of the invention, methods and apparatus are provided for comparing local retail information for a plurality of products. A consumer is enabled to identify the plurality of products. A first total price for the plurality of products is presented to the consumer according to a first shopping itinerary in a geographic region associated with the consumer. A second total price for the plurality of products is presented to the consumer according to a second shopping itinerary in the geographic region.

According to still another specific embodiment of the invention, methods and apparatus are provided for generating an optimized shopping itinerary for a plurality of products. A consumer is enabled to identify the plurality of products and acceptable alternative parameters relating to selected ones of the products. A total price for the plurality of products is presented to the consumer according to a shopping itinerary. The shopping itinerary is determined with reference to at least one of the acceptable alternative parameters identified by the consumer and current local retail information associated with a plurality of retailers corresponding to a geographic region associated with the consumer.

A further understanding of the nature and advantages of the present invention may be realized by reference to the remaining portions of the specification and the drawings.

### BRIEF DESCRIPTION OF THE DRAWINGS

FIGS. 1-6 are screen shots illustrating a specific embodiment of a price matching technique according to the present invention.

FIGS. 7-18 are screen shots illustrating various search and related functionalities according to a specific embodiment of the invention.

FIGS. 19 and 20 are screen shots illustrating ad alert functionalities of a specific embodiment of the invention.

FIGS. 21-27 are screen shots illustrating various functionalities associated with an embodiment of the invention relating to optimizing shopping itineraries.

FIGS. 28 and 29 are screen shots illustrating store locator techniques according to a specific embodiment of the invention.

FIGS. 30-32 are screen shots illustrating techniques for providing information relating to retailer price match and guarantee policies.

FIGS. 33-38 are screen shots relating to membership and preference setting according to a specific embodiment of the invention.

FIG. 39 is a screen shot illustrating set up for a mobile embodiment of the invention.

FIGS. 40-51 and 53-58 are screen shots relating to the aggregation and updating of local retail content according to a specific embodiment of the invention.

FIG. 52 is a flow diagram illustrating various modes of content extraction for use with various specific embodiments of the invention.

FIG. 59 is a diagram of an object model schema for use with a specific embodiment of the invention.

FIG. 60 is a simplified diagram of a network environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The following is a detailed description of the features and capabilities of an Internet and mobile shopping service which is referred to herein as Cairo. It will be understood that the specific details discussed are merely exemplary and should not be used to unduly limit the scope of the invention.

According to various embodiments, the features and capabilities of the Cairo solution can be divided into three primary areas both from a business and a functional design perspective:
Consumer use cases, which describe Cairo's value added services
Business services (and how they support Cairo's revenue model).
Content acquisition and aggregation

All features are available online via the Internet. They are also fully accessible using web-enabled cell phones, wireless PDAs, handheld computers, or other mobile devices—to help consumers while they are out shopping and in retail stores.

Consumer Use Cases

The consumer use case sections describe the Cairo web site and value added services, including: price matching and guarantees; search and price comparison; ad alerts for monitoring local ads for deals; mail-in rebate tracking; and everyday savings for grocery and household products. Each use case is supported by a storyboard of screen images.

Business Services and Cairo's Revenue Model

The Cairo revenue model and business services section describes how retailers, manufacturers, and other advertisers interact with Cairo, including: paid search and ad sponsorship; other web-based advertising; targeted 1-to-1 marketing; and data insight and syndication. This section also describes how these services generate revenue for Cairo.

Content Acquisition and Aggregation

The content section describes how Cairo captures and aggregates price and promotion data for local retail stores in a cost effective manner. The timeliness, completeness, and accuracy of the data, together with the degree of coverage across geography, retailer, and product category, are important for achieving a satisfactory consumer experience.

According to specific embodiments of the invention, Cairo consolidates price and promotion data (including but not limited to each retailer's weekly ads and circulars) for local retail stores based on zip code and makes this data easily searchable and comparable. Data capture and aggregation takes place through a combination of web crawler technology and an offshore content factory.

By leveraging the retailer's local content, Cairo provides value added services to consumers and extended marketing reach to retailers and manufacturers, helping to enable further convergence between the online and offline worlds, including:
Extend mainstream advertising from retailers (and manufacturers) with a channel to price sensitive consumers who would otherwise shop elsewhere (i.e. online).
Supplement existing price comparison web sites by allowing current online prices to be easily compared with currently advertised deals and pricing from local retailers—allowing consumers to buy today and still get a great deal.
Help consumers leverage “never undersold” and “price match” guarantees by finding the lowest locally advertised prices before and after making purchases.
Determine the “optimal” shopping trip itinerary within a specified geography for a consumer's pre-determined shopping list of grocery-type items, based upon current promotions, coupons, and store/brand preferences.
Enable 1-to-1 direct marketing to the consumer, analogous to “paid search”, where advertisers can deliver targeted pricing and/or promotions based on consumer requests for offers within a product category or for a specific product.
Provide mobile access to Cairo for price comparison, promotions, and direct marketing to help consumers while walking the aisles of a store.
   Consumer Use Cases
   Cairo Price Match™

Many retailers offer price match and/or price guarantee programs. Retailers that price match, promise to match the price of a competitor if the consumer can prove a lower locally advertised price for the same product. This may take place at the time of purchase. Alternatively, the retailer may “guarantee” the price of a purchase for a period of time (usually 30 days) during which the consumer can return to the store with proof of a lower advertised price and claim a refund for the price difference. Often, the retailer will refund the difference plus a percentage (e.g. 10%) for the added aggravation. The lower advertised price may be a local competitor's or even the retailer's own reduced price.

Price matching and guarantees apply to a broad range of product categories including but not limited to: consumer electronics; appliances and white goods, tires and automotive products; sporting goods; baby products; branded furniture and mattresses; home and garden products; DVDs, CDs, and video games; and many more.

The section describes functionality and use cases that help consumers better leverage retailer's price match and price guarantee programs.

Price Matching at Time of Purchase

Cairo allows consumers to easily find the lowest locally advertised price for any product (see Cairo Search section). Using this functionality, the consumer may find and print a competitor's ad with a lower locally advertised price for any product they need to purchase. They may take the print out of the local competitor's ad to any preferred or more convenient retailer that offers price matching and claim the lower price at that store. The printed ad output from Cairo provides enough detail to clearly demonstrate the validity of the competitor's ad, including any exclusions or expiry dates.

Price Matching and Guarantees after Purchase

Most consumers have little time to comparison shop prior to buying things or simply like to buy on impulse when they see something they like in a store. However, they would also like to know they are getting a good deal on these items. Many times, their purchases are covered by a price guarantee from the retailer. But the consumer does not have the time to hunt for lower prices and return to the store to claim a refund.

At certain times of year, price guarantees can yield significant savings. For example, purchases made prior to Christmas will frequently be placed on sale at much lower prices in the New Year, well before the retailer's price guarantee period expires. The same applies for seasonal goods that are usually marked down heavily towards the end of their season (e.g. barbeques or lawn mowers).

Cairo makes this much easier for consumers, by automatically searching for lower locally advertised prices and identifying refund opportunities, immediately after purchase and for the duration of the price guarantee. This is “found money” for the consumer.

The Price Match and Guarantee Process

The following steps outline the Cairo process (after the consumer has been shopping):
1. The consumer makes a purchase and records the transaction in Cairo.
2. Cairo checks the price guarantee and searches current locally advertised prices.
3. Cairo monitors local ads for lower prices during the guarantee period and emails any updates if lower prices are found and a refund is due.
4. The consumer prints refund instructions, with a copy of the ad with a lower advertised price, and returns to the original store to claim their refund.

A specific implementation of the process is described in greater detail below.

1. Consumer Makes Purchase and Enters Details in Cairo

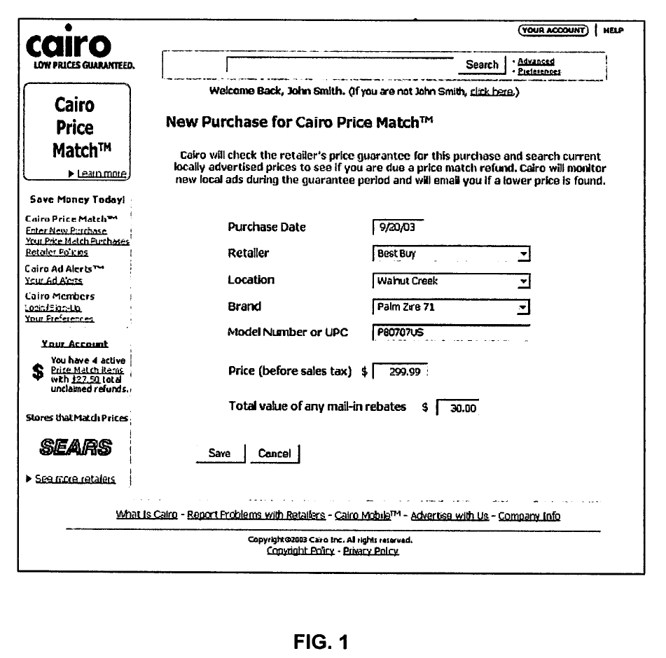

After making a purchase, the consumer enters basic details into Cairo (e.g., in an interface such as that shown in FIG. 1), including: the retailer, store location, date of purchase, purchase price (before sales tax), and the product purchased. To identify the product, the consumer may either enter details of the brand and model name/number or they can enter the UPC code printed with the bar code on the product packaging. Cairo also asks the consumer to enter the value of any mail-in rebates that apply to the purchase (for subsequent tracking).

Cairo Price Match works best for purchases of higher value, branded items, where the potential price difference is material enough to be worth claiming (e.g. products costing $25 or more). These are also typically the types of products where retailers routinely offer price matching and guarantees and which are advertised competitively.

Cairo makes it easy for the consumer to check which retailers offer price matching and/or guarantees prior to going shopping (see Retailer Price Match and Guarantee Policies section). Retailers often heavily promote their price match and guarantee programs in their stores and via TV and radio spots.

2. Cairo Checks Price Guarantee and Current Locally Advertised Prices

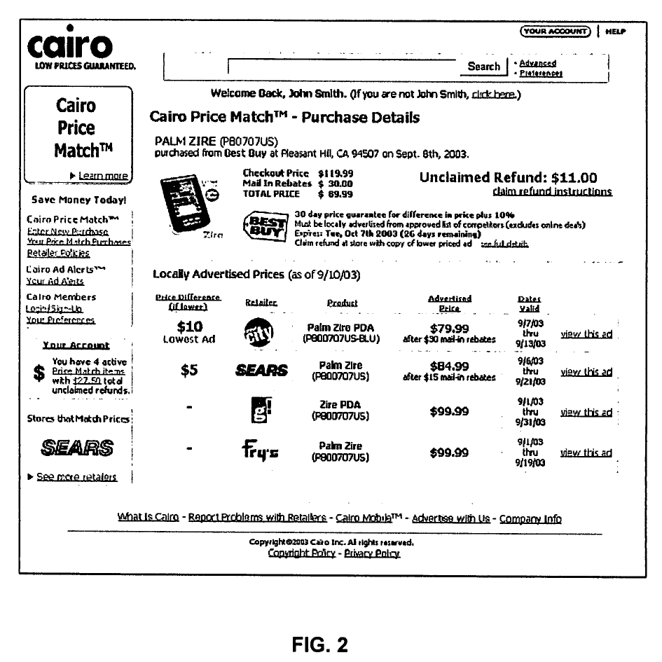

Once the new purchase is saved, Cairo provides immediate feedback on whether the product is covered by a price guarantee and displays a list of current locally advertised prices for the product, including any lower prices that qualify for a price match refund (see FIG. 2).

Cairo uses a database of retailer's price matching and guarantee policies (covering both local retail and online stores) to determine what type of price guarantee applies to any consumer purchase. Some retailers have exclusions or different terms based on the location and/or type of product purchased and Cairo ensures these are correctly applied.

The Price Match Details page (FIG. 2) displays a summary of the retailer's price guarantee terms, including expiry date and how many days remain to claim refunds. The consumer may drill down to detailed terms and conditions for more information. Cairo tells the consumer when no price guarantee applies to a purchase. For configurable or bundled products (e.g. a desktop computer system), it also warns them to check that the items being matched are absolutely identical (e.g. one does not have more or less memory).

Cairo uses the product information entered with the purchase to search for all local ads that match that unique product. To accurately match the item, the consumer must enter the brand, model name, and model number OR the UPC code for the product. The brand and model number are usually included in the ad descriptions for this type of product and Cairo looks for ads containing these items. If the consumer enters a UPC, Cairo looks up the model information in its product database and uses that to search.

The location of the store where the purchase was made (based on zip code) is used to determine which ads are considered “local” for price matching purposes. Retailers create many variations of their weekly ads, targeted to local markets, with each ad applying to a distinct group of stores or zip codes. Cairo uses each retailer's own definition of which of their ads apply to a local market to limit the search.

The Price Match Details page displays all current local ads matching the product information. These are sorted in ascending price order. If an ad is found that is lower than the purchase price, Cairo clearly indicates there is an “unclaimed refund”. If the current advertised prices are the same or higher than the purchase price, Cairo provides the consumer with positive affirmation that they got a good deal. They can view a larger version of any of the matched ads, by linking to the online circular on the retailer's own web site or by using the Cairo Ad Browser (see Cairo Search section for more details).

Cairo also supports price matching for online purchases. Price guarantees for online stores are usually good for comparison against other online prices only. Cairo uses the product information for the purchase to match against current online retailer prices. For online purchases, price matching takes place after including any shipping costs. The consumer may link to the web page containing the competitive online price for details.

3. Cairo Continues to Monitor Through the Guarantee Period

Cairo continues to monitor any new local ads published throughout the price guarantee period, sending emails to the consumer if a new lowest price is found. The email contains links to view the corresponding Price Match Details pages. Preferences may be set-up describing how the consumer wants to be notified and the minimum price difference, below which they are not interested in hearing about refund opportunities.

4. Consumer Prints Instructions and Claims Refund

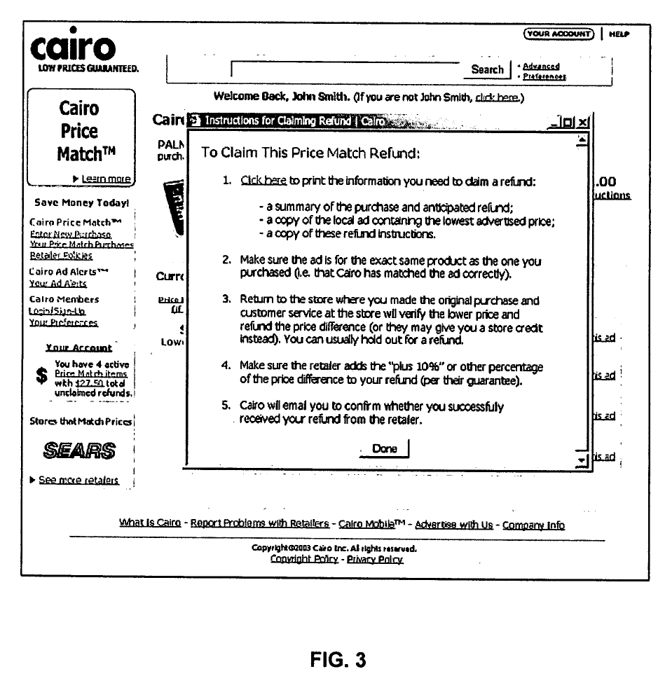

Cairo provides instructions to the consumer about how to claim each refund as shown inf FIG. 3. This allows them to easily print a copy of the competitor's local ad containing the lowest advertised price. In most cases, the consumer returns to the store where they made the original purchase, taking the ad printout from Cairo as proof of a lower advertised price, together with their original receipt. In some cases, especially for online retailers, a telephone number or email address may be used to submit price match claims (and Cairo provides instructions and links to the applicable telephone number, email, or online forms).

Occasionally, a retailer may refuse to honor their Price Match policies or will not accept the consumer's proof of a lower advertised price. Cairo provides an online form to allow the consumer to report problems of this type. Cairo uses this information to lobby retailers, improve claim instructions, and/or to warn other Cairo members of issues.

Viewing Price Match Purchases

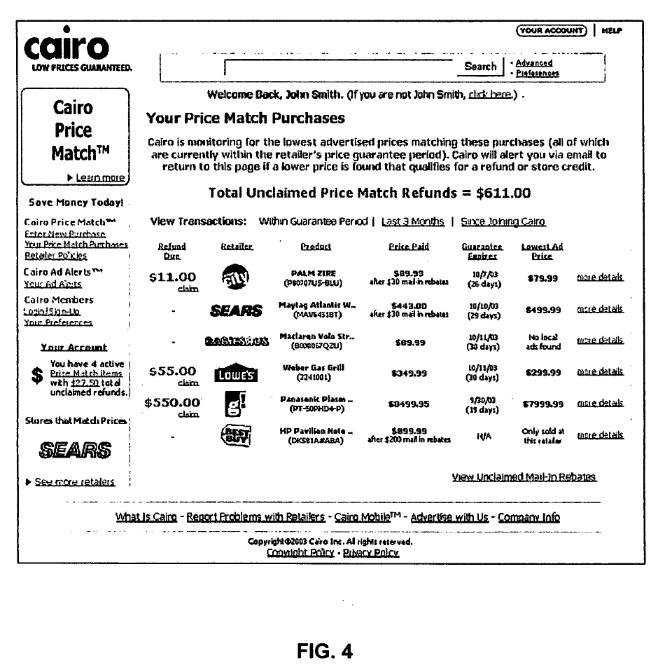

Consumers are able to view a list of their active Cairo price match transactions (e.g. those purchases that are still within the guarantee period) in an interface such as that shown in FIG. 4. For each item, Cairo shows any refund due, the product purchased, when the guarantee expires, and the current lowest locally advertised price. The consumer may drill down to view the current Price Match Details page for any item. They may also link to the claim refund instructions.

Consumers may also view their historical price match transactions (e.g. purchases that are now outside the guarantee period) and determine the outcome and savings they have received for each individual transaction. Cairo maintains an overall balance of the total savings claimed by each consumer as a result of Cairo membership.

Automating Price Match Refunds

Many retailers actively promote their price match and guarantee programs (including radio and television advertising) as this helps price perception with consumers. But, in reality, they do not expect a large number of people to actually use these programs. It is currently time consuming for consumers to find lower advertised prices and inconvenient to return to the original store, lining up at customer service to claim their refund.

Cairo makes the first part of this, finding lower advertised prices, much easier which will increase the use of price match programs by consumers. Moreover, Cairo may partner with retailers to fully automate the claiming of price match refunds by consumers.

The Cairo Price Match process for automated refunds is very similar to that for manual refunds. The consumer enters details of new purchases into Cairo and Cairo determines the price guarantee terms and any lower locally advertised prices throughout the guarantee period. But, in this case, the consumer does not need to do anything else beyond entering the purchase and waiting to see if a refund or store credit is due.

At the end of the guarantee period, Cairo determines the lowest locally advertised price for the product and notifies the retailer electronically that a refund is due, along with proof of the lower advertised price. The retailer confirms that a price match is indeed due and issues a refund or store credit to the consumer (via email or direct mail). This mailing is another opportunity for the retailer to send the latest circular, special offers, catalogs, and other promotional material to the consumer. The retailer notifies Cairo of the refund issued and Cairo automatically records the consumer savings realized.

Retailers will participate in an automated refund program if they are already a low price leader and see significant marketing benefits from publicizing truly guaranteed prices. It is likely that the retailer would issue store credits, as opposed to cash refunds, which have the added benefit of getting the consumer back into their store. Cairo may offer exclusivity for an initial period to select retailers in each product category—this will allow that retailer to uniquely market and leverage their program for a period of time.

The automated price match process yields “found money” for the consumer and this is an area where Cairo can generate transaction fees from the consumer or retailer. In many cases, the retailer currently refunds the difference plus 10%. For automated refunds, Cairo would receive a percentage (say 10%) of any refunds to the consumer.

Embeddable Cairo Price Match Widget

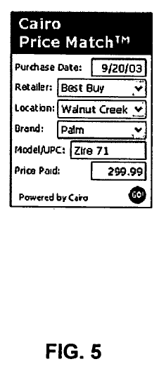

Cairo Price Match may also be accessed via an embeddable widget from within a third party web site (see FIG. 5). This allows web sites to help their own community leverage price matching and price guarantees for products of particular interest to their users. For example, Parenting Magazine could offer this as a service to their readers (and increase traffic to their web site) by helping consumers save money on baby related products.

The embedded solution functions in exactly the same way as when a new purchase is entered directly into Cairo. The Price Match Details page is displayed with details of the applicable price guarantee and an initial match against local ads. The consumer can print instructions for claiming the refund and a copy of the ad containing the lowest locally advertised price. Cairo continues to monitor the purchase through the guarantee period and emails the consumer with updates. From the email, the consumer may link to view the current Price Match Details or a list of their Price Match Purchases.

Cairo supports revenue sharing arrangements with partners for traffic generated via embedded Price Match widgets (see Cairo Revenue Model and Business Services).

Mail-In Rebates

Mail-in rebates are frequently offered by retailers and manufacturers to reduce the advertised price of consumer electronics, computers, appliances, and many other categories. However, many times consumers simply forget, lose the rebate forms, or throw away proof of purchase. The value of mail-in rebates can be significant.

Cairo helps consumers to track mail-in rebates for any purchases entered using Cairo Price Match. When new purchases are entered, Cairo determines whether mail-in rebates are currently available. The consumer is also asked to enter the total value of any mail-in rebates as part of the purchase information. Several rebates may apply to a single purchase. For example, for a desktop computer bundle, rebates may be available from the retailer, the PC manufacturer, and the printer manufacturer.

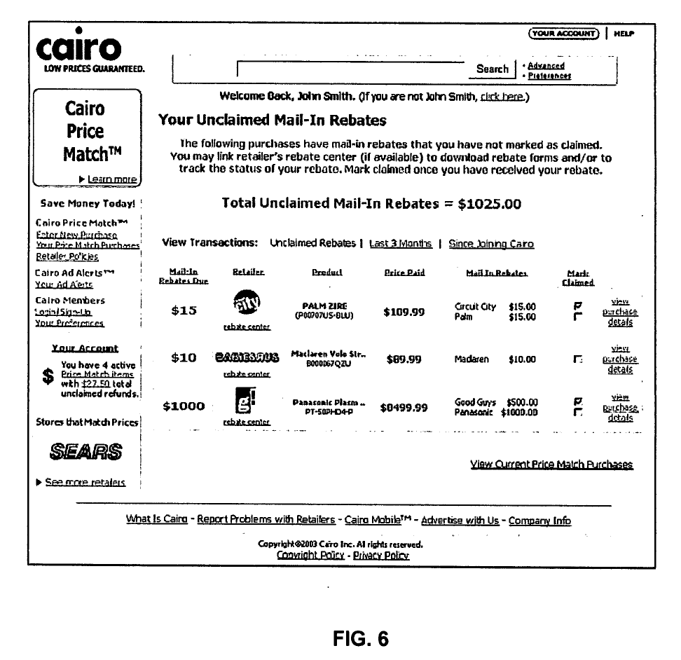

The consumer may view a list of unclaimed mail-in rebates from the Price Match Purchases page as shown in FIG. 6. This provides a reminder to them that mail-in rebates must be claimed and shows the total value of outstanding rebates. Once the rebate has been paid, the consumer checks the “claimed” box in Cairo, which removes it from the unclaimed list.

Many retailers provide online rebate centers on their own websites to allow consumers to download missing rebate forms or to track the status of a rebate claim. Cairo includes links to each retailer's rebate center (if one exists) as part of the unclaimed rebate details. Retailer rebate centers usually include forms for both the retailer and any manufacturer mail-in rebates for products carried by the retailer.

Cairo allows the consumer to view a history of purchases that had mail-in rebates and whether each mail-in rebate was claimed (for the last 3 months or since joining Cairo).

Occasionally, a retailer may refuse to honor a mail-in rebate and will not accept the consumer's claim. Cairo provides an online form to allow the consumer to report problems of this type. Cairo uses this information to lobby retailers and manufacturers, improve rebate claim instructions, and/or to warn other Cairo members of issues.

Cairo Search™

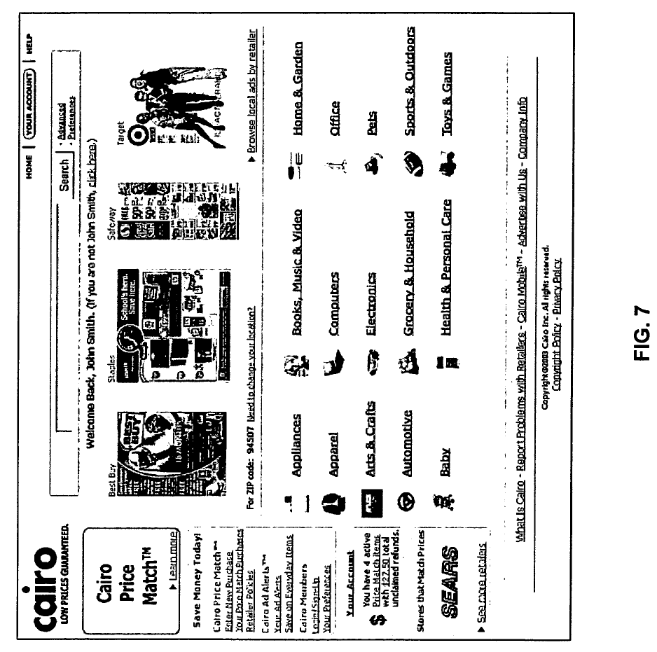

Cairo allows consumers to easily find and compare currently advertised prices for products available today at their local retail stores. The home page of Cairo (see FIG. 7) is built around a search engine which finds and displays currently valid local retailer ads based upon the consumer's zip code. Cairo provides a number of distinct ways for the consumer to search and browse local ad content.

Consumers can search local ads for specific terms entered in the search bar. Using Advanced Search, they can search based on parameters, such as brand, model number, or price range. Or they can drill down by product category to find search results for the category. Consumers may also browse the current local ads for specific retailers.

This section describes the functionality and consumer use cases for Cairo Search.

The Cairo Search Engine

The objective of Cairo Search is to allow consumers to easily find and compare all currently advertised prices for any specific product within a local market. Most of this content is already available via online circulars at retailers web sites, but it is not aggregated or indexed making it hard to search and compare across multiple retailers.

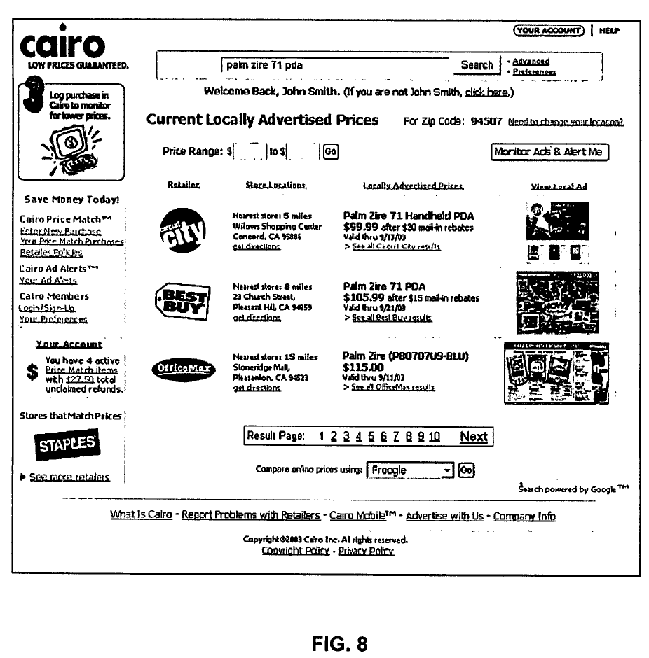

Cairo Search is a search engine that is focused on local ad content. Like other search engines, the objective is not to aggregate content into a massive centralized database, but to index content already in existence on retailers' own websites. When a consumer searches for a product name or model number, Cairo returns a list of search results, in order of relevance to the search terms, with embedded links (usually thumbnail images) to the corresponding page in the retailer's online circular (see FIG. 8). The consumer clicks through to the retailer's own website to see more details or shop online.

The consumer's location (based on street address or zip code) is used to limit the search results to retailers with stores in close proximity to the consumer. Typically, retailers create many variations of their weekly ads, targeted to local markets, with each ad applying to a distinct group of stores or zip codes. In reality, these “ad zones” are usually tied to newspaper circulation areas (the main delivery mechanism for the ads). When indexing content, Cairo determines the valid zip code(s) each variation of local ad.

To use Cairo, the consumer is prompted for their street address and/or zip code. This is also captured when consumers sign up as Cairo members. All Cairo search results (and any sponsored local ads) are based on proximity to that location, which is prominently displayed on the search results screens. The nearest store location for each retailer is included as part of search results (together with a link to the Cairo Store Locator).

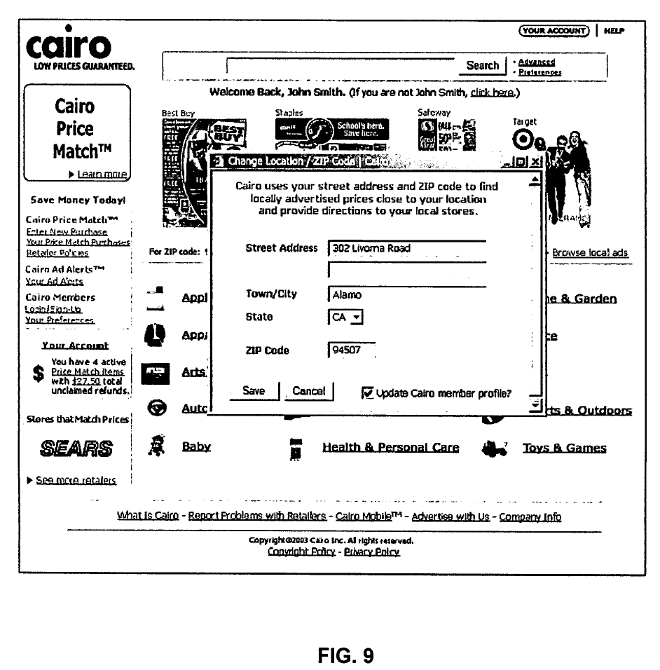

The consumer may change their location at any time from most screens within Cairo (see FIG. 9).

Cairo search results are generated based upon relevance to the search terms. The closer the match to the search terms, the higher the relevance. For example, given the search terms “palm zire 71”, any ads containing “Palm Zire 71” are given a higher relevance than ads containing only “Palm Zire”. Likewise, ads for other models or brands of pdas are given an even lower relevance. This approach means that a large number of search results will likely be found for any search terms, but that the items that the consumer is most likely to be trying to find will be towards or at the top of the list.

As for all search engines, the primary objective is to display the most relevant items on the first results page and make it easy to navigate pages or to narrow the search. Cairo does this by only showing the single most relevant result for each retailer on the initial results page. These in turn, are sorted in order of relevance. If several items have the same relevance, they are displayed in order of ascending price. The order of the search results may also be partially influenced by paid sponsorship by the retailer.

Products may be described in many different ways within local ads. Some may include the model name and number. Others just the brand and description. The search terms or parameters entered by the consumer often uniquely identify the specific product that they want to buy. But these terms may not include any of the actual words found in a local ad for that same product (e.g. if they were to enter a UPC). Cairo addresses this by extending the search terms with category, brand, and model name information prior to passing to the Cairo Search Engine (provided a unique product has been identified).

Again, Cairo uses relevance to determine the relative significance of each part of the search terms, with exact matches of model numbers or UPCs getting the highest relevance, followed by matches of product name, brand, and category (in that order).

Cairo also uses synonyms to extend the search terms and parameters. This greatly improves the accuracy of the search results. For example, if the consumer enters “pda” in the search terms, Cairo also searches for local ads containing: PDA, pdas, handheld, personal digital assistant, etc. The relevance assigned to synonyms which are simply plurals or capitalized versions of a specified search term is higher than the relevance assigned for true synonyms (e.g. “laptop” and “notebook” computers).

Cairo searches and indexes the websites of national and regional retailers (in the US and Canada) that have online circulars available and accessible to consumers. This includes the vast majority of larger players. Many of the regional or local retailers also have online circulars available.

Cairo also has the capability to manually load and extract ad circular content from printed circulars via a “content factory”—for retailers that do not have circulars online.

Finding the Lowest Locally Advertised Price

Consumers often want to be able to quickly find the lowest locally advertised price for a specific product. This could be for an expensive hi-fi component that they have researched extensively online (for a specific model). Or it could be simply to check the local prices for a branded consumer product that they purchase regularly (e.g. Tide laundry detergent). Cairo makes it easy to find the lowest locally advertised price.

Using Cairo, they can simply enter search terms that identify a unique product (either a model name and number, a UPC, or other unique description). Cairo searches all current local ads for the product and display search results in order of relevance. The consumer may then sort and compare these items based on advertised price.

As described in the Cairo Price Match section, many stores will also match any local competitor's price at time of purchase. Consumers may use Cairo to find the lowest locally advertised price, print a copy of that ad, and take it to a different retailer for Price Match—typically because that retailer is closer, they simply prefer that store, or they are going there anyway for other items. Most retailers will match ads at time of purchase.

Search Using the Search Bar

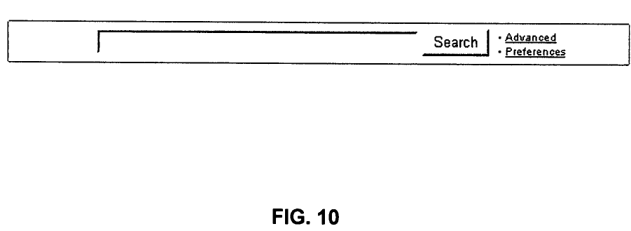

The primary way of searching within Cairo is to enter search terms directly into the Cairo Search Bar (e.g., FIG. 10) and pressing “Search” to display the Cairo Search Results page.

Typical search terms include some combination of the product category, brand, model name or number, or even UPC codes to identify the product (or type of products) that the consumer wants to purchase or compare. Wherever possible, Cairo tries to identify the unique product that the consumer is searching and tries to match individual search terms against its internal product catalog, checking for brands, model names, model numbers, and UPCs. If found, these are given higher relevance in the search results.

As discussed above, products may be described in many different ways within local ads and Cairo may extend the search terms if a model number or UPC is uniquely identified to include the category, brand, and model name information prior to passing to the Cairo Search Engine. Likewise, Cairo may search for synonyms of the entered search terms.

From the Cairo Search Bar, the consumer may also link to Advanced Search, which allows them to enter more detailed parametric search terms, or to edit their Search Preferences. Both of these are described in more detail in other sections.

Search Results Page

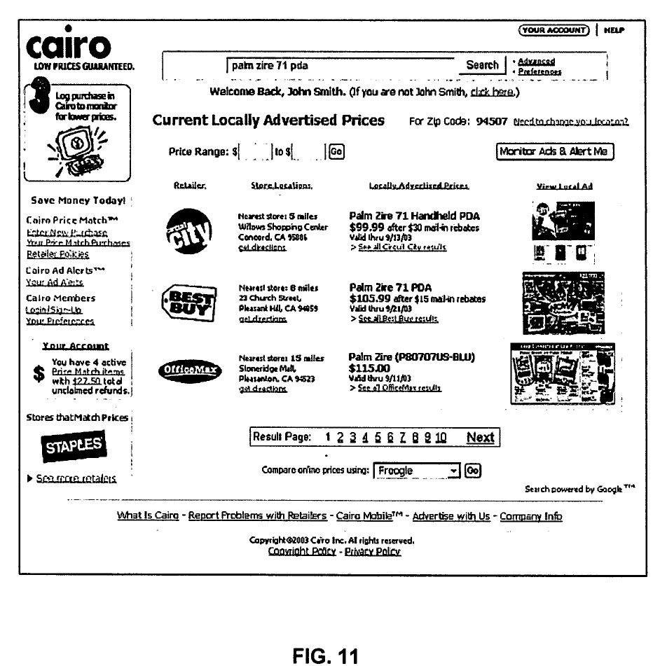

From the Cairo Search Results page shown in FIG. 11, the consumer may:
Narrow the search terms and search again
Change their location (starting address and zip code)
Restrict the search results using a price range
Create an “ad alert” based on the search terms (see Cairo Ad Alerts section)
Sort the search results by ascending/descending price
Sort the search results by nearest store location
Link to the Cairo Store Locator to find local stores and get directions
Drill down to see all results for a specific retailer (that match the search terms)
Link to the retailer's website to view a larger ad image and/or shop online
Page through additional pages of results
Jump to an online price comparison site passing the search terms.
   Search Results by Retailer (Drill Down)

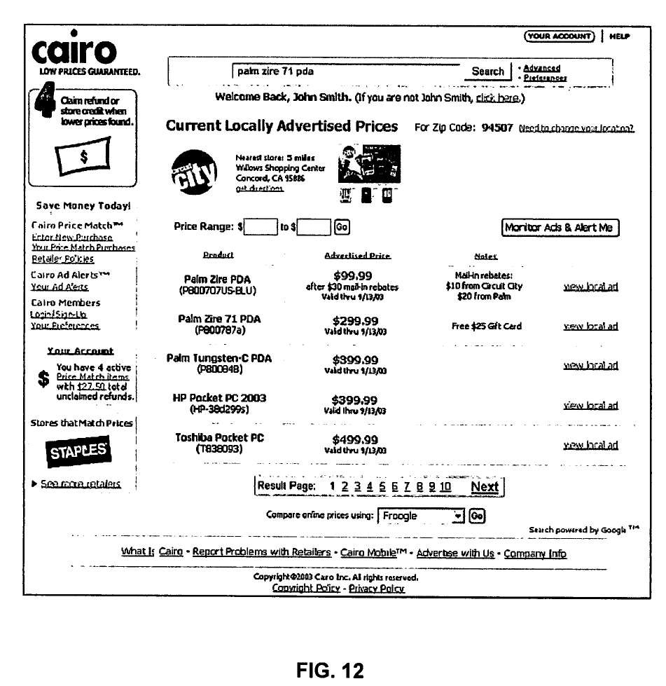

For any retailer, the consumer may drill down from the Cairo Search Results page to view all of the advertised items for that retailer (that match the search terms). As shown in FIG. 12, these results are initially displayed in order of relevance, but may be resorted by price.

From the Search Results by Retailer page of FIG. 12 the consumer may:
Change their location (starting address and zip code)
Restrict the search results using a price range
Sort the search results by ascending/descending price
Link to the Cairo Store Locator to find local stores and get directions
Link to the retailer's website to view a larger ad image and/or shop online
Page through additional pages of results (for the search terms)
Jump to an online price comparison site passing the search terms.
   Advanced Search

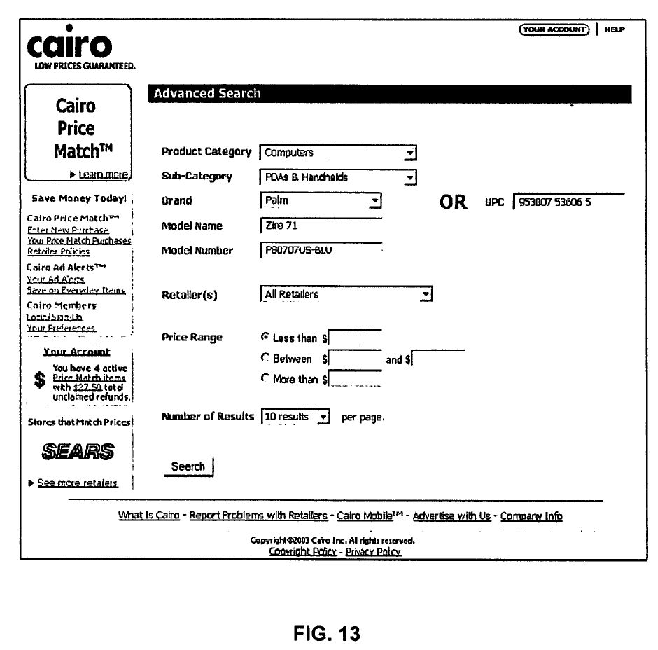

The Advanced Search page of FIG. 13 allows consumers to enter detailed search parameters using drop down lists to more precisely search for a specific product or type of product.

The consumer may search for products by: product category; brand; model name; model number; and/or UPC, in any combination. Each drop down may be used to drill down and filter the available choices in subsequent drop down lists. For example, if the PDAs and Handhelds sub-category is selected, the brand drop down will only list PDA brands.

The consumer may limit the search to a specific retailer or list of retailers. They may also restrict the search to be less than a specified price, within a price range, or even above a specified price (e.g. find all plasma TVs that are advertised at $5000 or more).

The consumer can change the number of search results displayed per page.

Search by Product Category

As shown in FIG. 7, the Cairo Home Page includes a list of high-level product categories. These represent the top levels of a product hierarchy which contains all of the product categories and sub-categories for which Cairo captures and indexes local ad content.

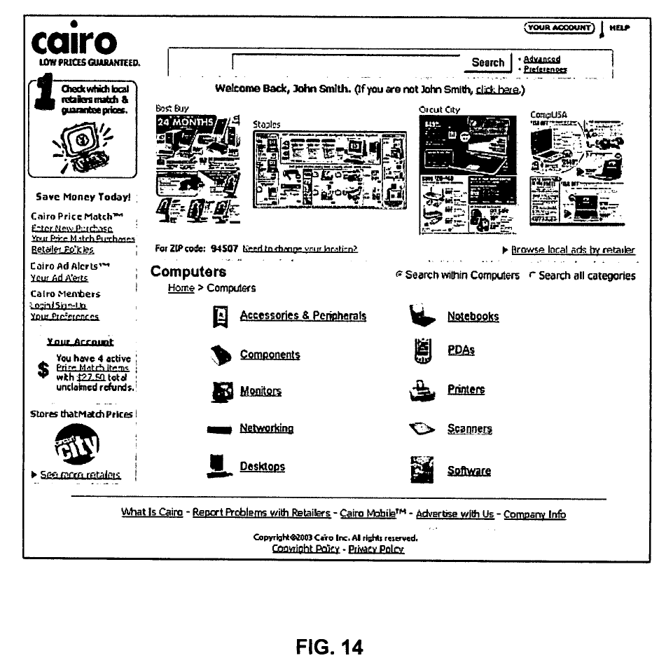

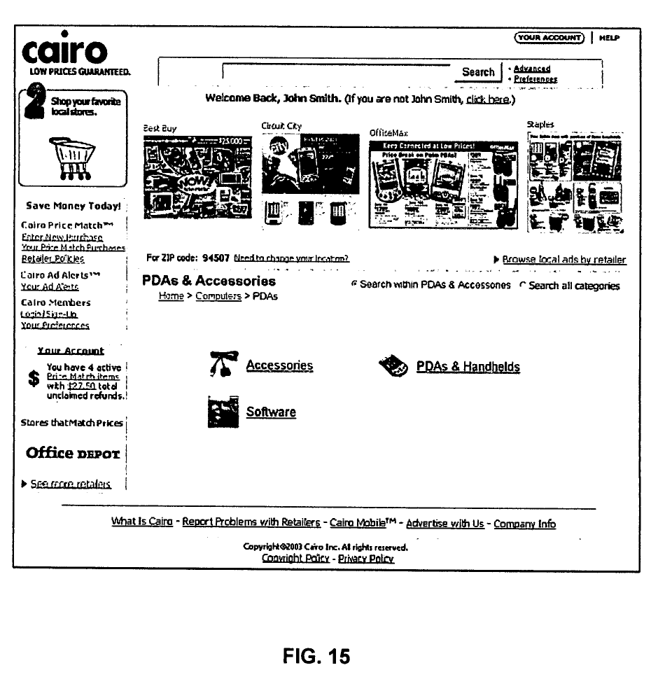

The consumer may drill down through any category to subsequent levels of the product hierarchy. For example, as shown in FIG. 14, the consumer can select “Computers” and drill down to a list of valid sub-categories within the computer category. They may then select “PDAs” and drill down further to view the sub-categories within the pda category as shown in FIG. 15.

In each case, Cairo displays thumbnail images of pages from current local retailer ads that are context sensitive to the category selected in the hierarchy. So, when the consumer selects the Computers category, the consumer will see thumbnails for local ad pages containing computers. Likewise, when the consumer drills down to PDAs, the local ad page thumbnails will change to ad pages containing PDA products.

The consumer may click any of the thumbnails to link to the retailer's web site to see the corresponding page in the retailer's online circular (integrated with their online store). Only a small number of local ads can be displayed for each level in the product hierarchy and Cairo may accept paid sponsorship to determine which retailers are displayed. This also applies to the Cairo Home Page, which displays ads solely based on sponsorship.

When the consumer reaches a bottom level in the hierarchy with no sub-categories, a Cairo Search Results page is displayed containing search results relevant to the selected category. For example, if the PDAs and Handhelds sub-category is selected, Cairo displays search results for local ads that contain PDAs. This is similar to the results the consumer would obtain by typing “PDAs” in the Cairo Search Bar.

At any level within the product hierarchy, the consumer may enter search terms directly into the Cairo Search Bar and press “Search”. By default, Cairo limits that search to within the selected product category (e.g. PDAs & Accessories). The consumer may revert back to searching all categories by selecting a radio button.

Browse Local Ads by Retailer

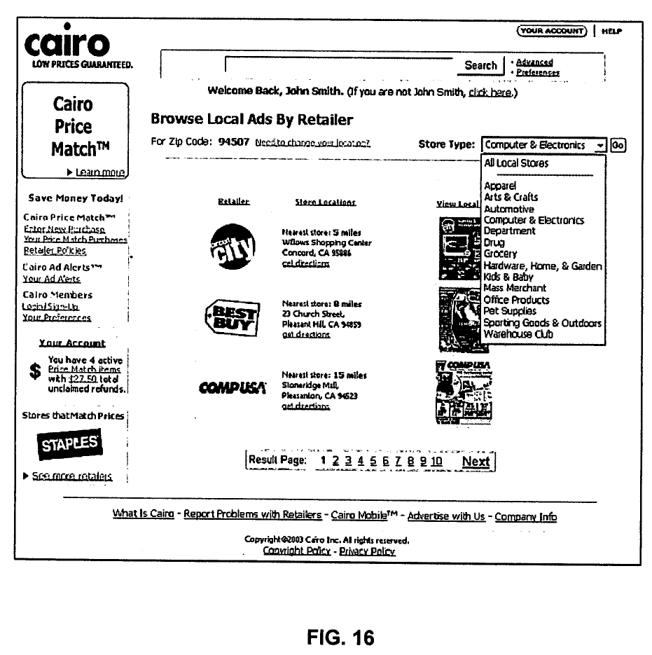

Some consumers like to browse local ads that come in their Sunday newspapers or simply want to check the local ad of their favorite retailer prior to going shopping. From the Cairo Home Page (and any page within the product hierarchy), the consumer may link to Browse Local Ads by Retailer (FIG. 16) to find the current ads for their local retailers.

A list of local retailers is displayed, based upon zip code, including details of the nearest store and a link to the Cairo Store Locator. For each retailer, a thumbnail of their current ad circular is displayed. The consumer may click on the ad image to link to the retailer's own website to browse the ad images and shop online. Retailers are initially sorted by store type (e.g. Computers & Electronics). The consumer may narrow the search to a specific store type by selecting from a drop down list.

The order in which local retailers are displayed may be influenced by paid sponsorship.

Sponsorship of Local Ads

Cairo generates revenues by allowing retailers to sponsor their local ads and influence their positioning in the Cairo search results. Accurate search results will continue to be the major determinant, but sponsorship will also help determine which ads appear on the first results page and which require further drill down.

In most cases the consumer will see thumbnails of the relevant ad page—which provide a visual to draw the consumer to want to see more—and the consumer will link from the thumbnail to the retailer's own website to view and browse a larger version of that page in the retailer's online circular. Cairo links to the specific ad page depicted by the thumbnail (e.g. the specific ad page containing PDAs). The retailer's online circulars are typically fully integrated into their online store and shopping basket.

Opportunities for paid ad sponsorship by retailers include:
Ad thumbnails profiled on the Cairo Home Page
Category specific ad page thumbnails in the Product Category pages
Relative positioning of ads within the Cairo Search Results page
Relative positioning of ads within the Browse by Local Retailer page

Fees for local ad sponsorship in Cairo Search are charged based upon effectiveness and actual results. Cairo tracks whenever consumers “click through” to the retailer's website from Cairo. Retailers bid for specific search terms and commit to a fee per click through (capped to a maximum commitment by the retailer). Cairo optimizes the paid sponsorship commitments across retailers to maximize the revenue opportunity and best meet the objectives for the advertisers. Cairo may partner with an existing “paid search” technology provider for this component.

Cairo may also generate revenues from other online advertising methods, including banner advertising, sponsorship of alternative offers and manufacturer coupons within Cairo Everyday Savings, and other 1-to-1 direct marketing opportunities.

Retailers continue to lose share to online sales. Even when they have a strong online presence, they face much more significant online competition, especially among price conscious consumers. Even if the online store is performing well, it is likely that the local stores are losing sales and it is often better for the retailer to have consumers visit the local store where consumers will often impulse buy additional products once there.

Cairo Search allows retailers to divert some of those online sales back to their local stores or to their own online store, leveraging their existing advertising investments. By displaying their ad images, retailers get to leverage their own merchandising expertise in design and layout of their local ads—to best position and/or cross-sell products.

Viewing Larger Ad Images

The local ad thumbnails provide a visual link to a retailer's local ad, but are not detailed or clear enough to really see the products and prices available. The primary way for consumers to see a larger ad image is to click through to the retailer's own online circular, which drives traffic to their site and is integrated with their online store.

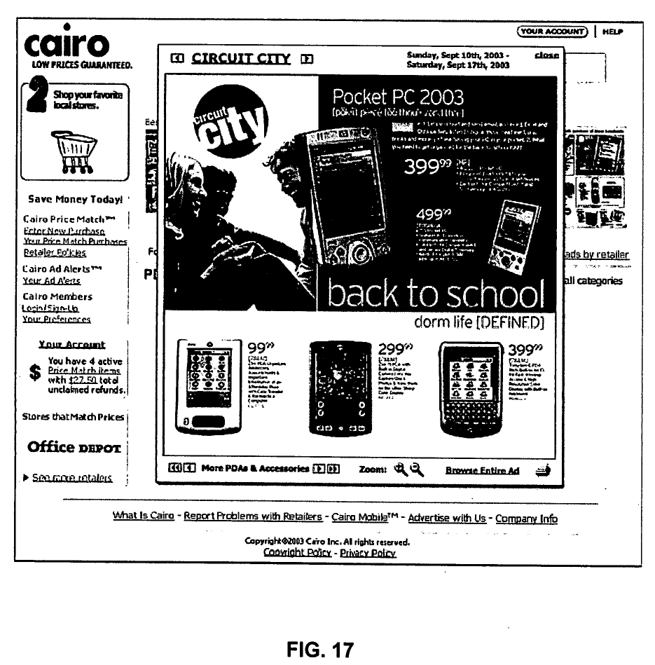

Cairo provides an alternative method of viewing larger (and legible) versions of the ad images using the Cairo Ad Browser as shown in FIG. 17. This primarily supports retailers that do not have online circulars on their websites and instead provide Cairo with the images and content to load manually (but may also be used to view a larger image of any retailer's ad).

The same ad sponsorship model may apply to retailers who provide their ad content directly to Cairo, with “click through” calculations being based on when consumers view larger versions of their ads using the Cairo Ad Browser. Retailers may also be charged set-up and operational fees for capturing and maintaining this ad content.

The Cairo Ad Browser allows the consumer to view the larger ad page image. It also includes a number of navigational controls to browse this and related local ads.
The Cairo Ad Browser allows consumers to zoom in and out on the local ad images to view the product information with greater clarity.
The consumer may print a copy of any local ad page(s).
Several pages within a local ad circular may contain products that meet the consumer's search criteria. Consumers can step backwards and forwards through all pages in the ad that contain the product category.
The consumer can view the “entire ad” and navigate through page by page. They can easily switch back to the original product category selection.
The consumer can page through competing retailer's local ads for the selected product category to avoid repeatedly jumping back to the thumbnails and reselecting the next retailer's ad. For example, they can view the larger ad for PDAs from Circuit City and easily page through all the larger PDA ad pages for Best Buy, OfficeMax, etc.—without ever leaving the Cairo Ad Browser.
The consumer may link to the corresponding ad page on the retailer's website (provided, of course, that the retailer has their ad circular available online).

In the future, Cairo may allow all local ads to be viewed either by clicking through to the retailer website OR via the Cairo Ad Browser.

This approach requires agreement with the retailers to pay the equivalent ad sponsorship fees regardless of whether the consumer links to their online circular or simply views their ad using the Cairo Ad Browser. It may be necessary to have a different fee structure for ads viewed in the browser vs. click through to their website.

Embeddable Cairo Search Widget

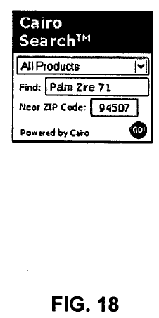

Search is a key feature of Cairo's own website. But, the ability to search local ads (and online prices side by side) is an attractive feature for many other website providers. Cairo therefore may provide an embeddable search widget (shown in FIG. 18) which may be placed in any site and allows basic search terms to be entered. Cairo may then return local ad search results for seamless display within the host website as a web service.

Cairo may allow the embeddable search widget to be limited to a predetermined set of product categories that are relevant to the host site. For example, a Cairo search widget on Parenting Magazine's website could limit searches to baby and toddler products.

The Cairo embeddable search widget may be used in conjunction with other Cairo embeddable widgets (e.g. Price Match or Everyday Savings).

The embedded solution functions in exactly the same way as if search terms were entered directly using the Cairo Search Bar. The Search Results page is displayed, listing advertised items from local retailers in order of relevance. The consumer can navigate through the Search Results page and drill down by retailer. They have full access to advanced search and can even create and maintain Cairo Ad Alerts (provided that they provide an email address and register as Cairo members).

Online price comparison web sites and product search websites are extremely popular and drive significant web traffic. They usually provide rich functionality and content for researching and comparing products, both by feature and online price, plus product ratings and reviews by other consumers.

But many consumers use the price comparison sites to simply conduct their product research and get an idea of price range and still buy from their local store—because they need it today, want to buy from an established retailer, or are nervous about shopping online and giving their credit card information (especially to the small unknown web retailers which make up the bulk of the online price comparison vendors).

Cairo may therefore partner with such web sites to provide a local search capability to supplement their online price comparison results. This targets consumers that need the product today, but also diverts some online shoppers to local stores—an attractive proposition to traditional retailers. Revenue sharing agreements will determine the split between Cairo and the partner for all resulting revenue from the embedded widgets.

Comparing Online and Locally Advertised Prices

Consumers searching locally advertised prices using Cairo are unlikely to want to see these prices in isolation and want to easily compare them to current online prices to ensure that they are getting a good deal. They can either confirm that the locally advertised prices are competitive or they can go ahead and buy the item online.

Cairo allows the consumer to select from any of the leading price comparison or product search websites and jump directly to that site from the Cairo Search Results and Search Results by Retailer pages. Cairo passes the current search terms to the target site so that the first page the consumer sees will contain online prices for the product (or products) that they were searching for using Cairo. The consumer can use the Back button in the browser to return to Cairo and even jump to another site with online prices.

Cairo may partner with the online price comparison and product search sites to obtain referral fees for consumers that link directly from Cairo. Many of these web sites already have affiliate programs where they pay referral fees or share revenues for traffic directed to their service. They typically generate their own revenues from referrals to online retailers or from ad sponsorship links. The order that these web sites appear in Cairo's drop down menu is determined based on the relative referral fee opportunity.

In the future, Cairo may embed one or more of the leading online price comparison or product search services directly within the Cairo web site to allow side by side comparison of both current locally advertised and online prices.

Cairo Ad Alerts™

Many items are advertised periodically and it is just a matter of time before they are next on sale. Cairo can automatically monitor local ads for a specific product (or type of product) and price, alerting the consumer via email when new ads are found. Ad alerts may be created for any type of product that can be found using Cairo Search, including both more expensive items (e.g. consumer electronics) and “everyday” grocery or household products. This section describes the functionality and use cases for creating ad alerts and monitoring local ads.

Creating an Ad Alert

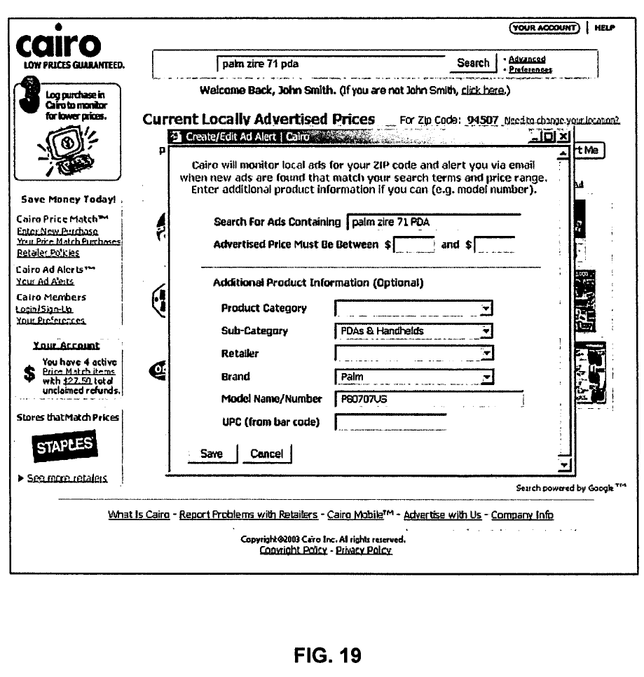

Cairo Ad Alerts are created as an extension to Cairo Search. When the consumer views the Cairo Search Results or Search Results by Retailer pages, a button is provided titled “Monitor Ads and Alert Me”. When the consumer presses that button, the New Ad Alert pop-up is displayed corresponding to the current search terms and/or parameters as shown in FIG. 19.

To create the new ad alert, the consumer reviews the search terms and product information, makes any changes or adds any additional information, specifies the acceptable price range for Cairo to alert the consumer via email, and presses “Save”.

Cairo may default as much information as possible about the product and price range based on any information entered as search terms, any parameters specified using Advanced Search, the current product category, and any price range entered in the search results screen. If the search terms identify a unique product in Cairo's product database (e.g. a specific model number or UPC was entered), Cairo may look up and default the corresponding product category, brand, and model information.

Ad alerts are most accurate when a unique product identifier, such as a model number, is specified (and where the model number is also clearly shown as part each retailer's local ads). This works very well for most higher end items, including computers and electronics, appliances, office products, etc. allowing exact matches to be found.

Ad alerts may also be created for “everyday” grocery and household products. For these items, local ads rarely include a unique identifier (such as a UPC or model number). Cairo may therefore search for these items based on product category, brand, and other key words in the product descriptions. For example, “Brand X Liquid 100 fl oz” will search based on relevance for local ads containing “Brand X”, “Liquid”, and “100 fl oz”. Cairo determines which keywords are significant for each everyday product category.

It will not be possible to always ensure an exact match for a unique product. Cairo may therefore determine the relevance of each local ad and may only send an ad alert email for those ads with high relevance to the consumer's search criteria. However, when the consumer views their ad alerts, they are able to drill down to see all of the current local ads, sorted in order of relevance. This can be very beneficial to the consumer as this list will include other variations and/or sizes of their preferred brand, which may be on sale at a much more competitive price. They will also be able to view other brands that are on sale within the same product category (further down due to lower relevance).

Notification Via Email

Based on search criteria specified in the consumer's ad alerts, Cairo monitors all new ads to determine whether any meet the consumer's criteria, for both product and price range. The consumer's zip code is used to determine whether an ad is local to the consumer (as described for Cairo Search). The consumer is notified via email when new ads that meet the criteria are found. The email contains a link to the Cairo Ad Alerts page which shows the current status of all their active ad alerts, including the most relevant product match and the current lowest advertised price for each item.

The consumer may set preferences to determine how frequently they wish to be notified about ad alerts (e.g. weekly in a single consolidated email) and may limit ad alerts to only search their preferred retailers (see Membership and Preferences section).

Current Ad Alerts

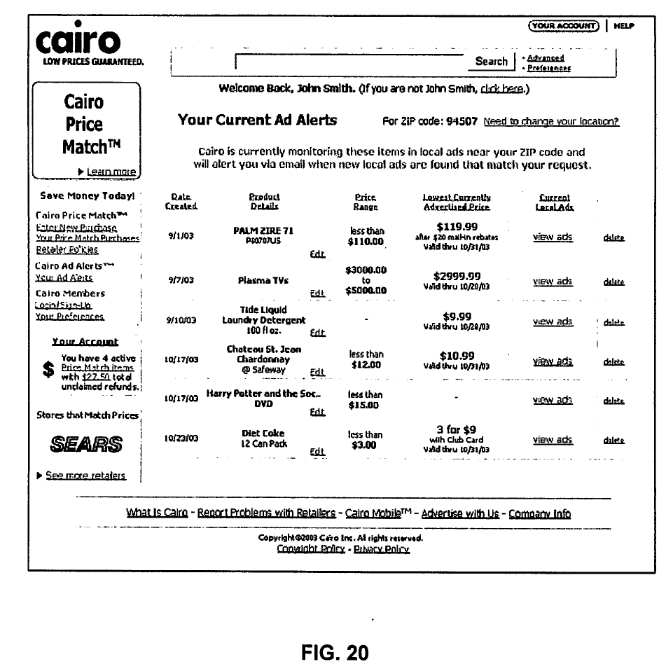

The consumer can view a list of currently active ad alerts, including the product search terms, the specified price range, and the lowest currently advertised price (see FIG. 20).

For each ad alert the consumer may:
Edit the ad alert to change the product search terms and/or price range
Link to see the current Cairo Search Results for the ad alert
Delete the ad alert.

The first result in the Cairo Search Results page correspond to the lowest current locally advertised price for the alert, but the consumer can navigate through all of the current results that match their criteria (in the same way as any other Cairo Search).

Cairo Everyday Savings™

Consumers shop for groceries and household consumer products very differently than they do for other retail items. The relative price difference for an individual item is small and consumers will seldom invest the time to comparison shop for one item. Instead, consumers are price sensitive to the overall basket or list of items that they regularly purchase. For example, my grocery bill at Safeway is $120 per week, which seems expensive, how much would it be at Albertson's for the same items. Alternatively, how much could I save if I go to Target for the eight items that are currently on sale there.

Cairo Everyday Savings allows consumers to compare prices for the basket of grocery and household items that they shop regularly. Comparison may be between the currently promoted and the regular priced items, between brands in a product category, or between competing local retailers. In addition, Cairo finds all of the advertised prices, promotions, special offers, and manufacturer coupons that are currently available for their items. The consumer can build a shopping list and “optimize” that list to find the best combinations of prices, items, and stores to visit for any shopping trip.

This section describes the functionality and use cases for Cairo Everyday Savings.

Brand Loyalty and Consumer Purchasing Behaviors

A key principle underpinning Cairo Everyday Savings is that consumers typically have significant brand loyalty and usually buy the same brand, type, and size of many items every time they shop for them—simply replacing each item as it is running out.

This applies to a large number of the branded items in a weekly shopping list, including:
household products (e.g. dishwasher powder, laundry detergent);
personal hygiene products (toothpaste, tampons, shampoo);
beverages (e.g. wine, beer, soda, juice);
pet supplies (dog food, cat litter);
baby products (diapers, baby food);
health products (pain medications, cough medicine);
and many, many more.

These are also typically the items in the store that attract huge amounts of trade marketing dollars from manufacturers to the retailers to help promote their brands and maintain market share. At any time, there are usually several promoted items valid for that particular week within each product category (with much better pricing). There are also often manufacturer coupons available for this type of product.

For some items, the consumer will happily buy a different size of the same product (or will buy more than one of the same item), if that means they can leverage a current promotion and get a better deal. In addition, for some types of product, they may happily switch brands to a cheaper or promoted substitute—but for others they would absolutely never switch, whatever the price considerations.

Create/Edit Shopping Preferences

Consistent consumer purchasing behaviors mean that it is possible to create an up front list of “favorite” items for each consumer which will seldom change from week to week. This includes the preferred brand, type, and size for each item, together with the consumers preferences for substitute sizes and brands (when a better deal is available).

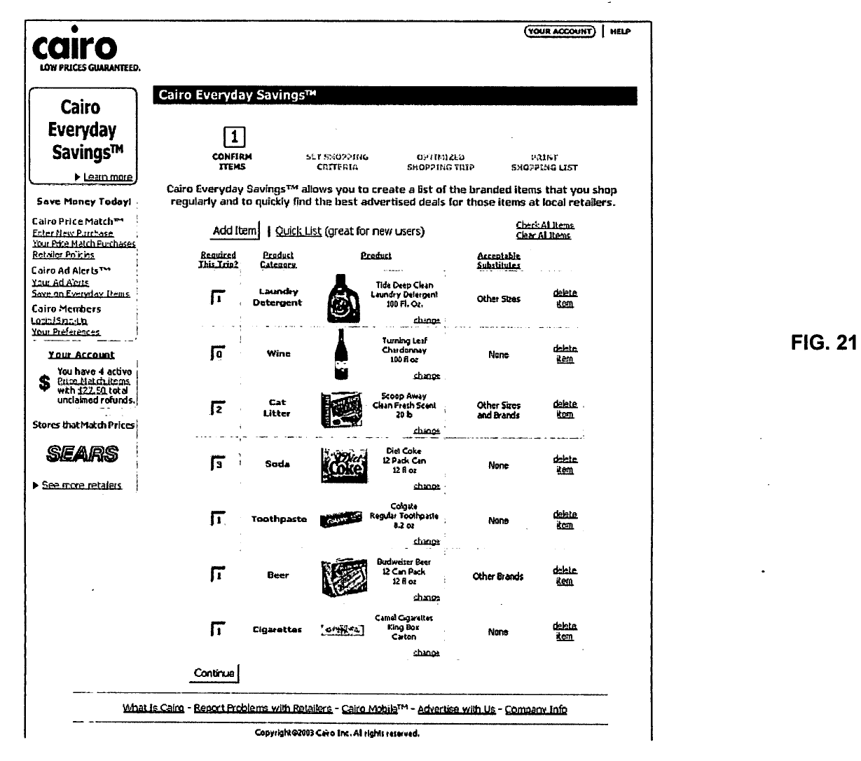

Cairo allows consumers to create a list of their shopping preferences using an interface such as that shown in FIG. 21. This is something the consumer does upfront, one-time—as opposed to every time that they go shopping. Occasionally their preferences may change and these can be easily reflected in Cairo.

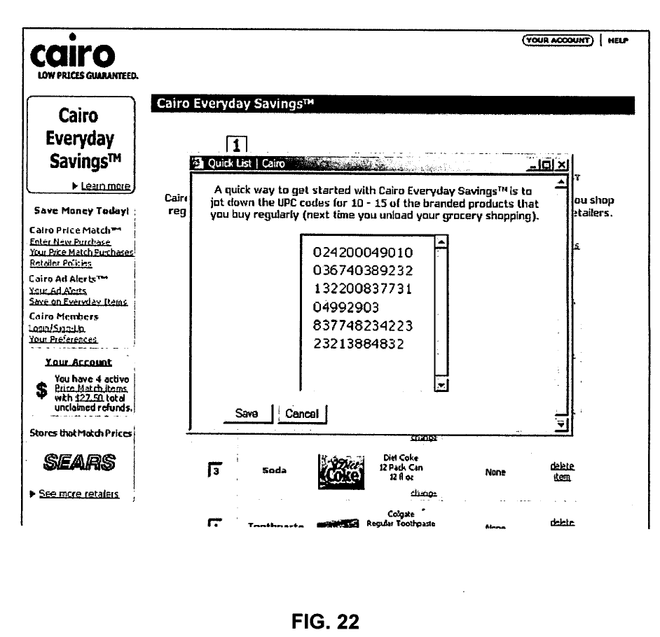

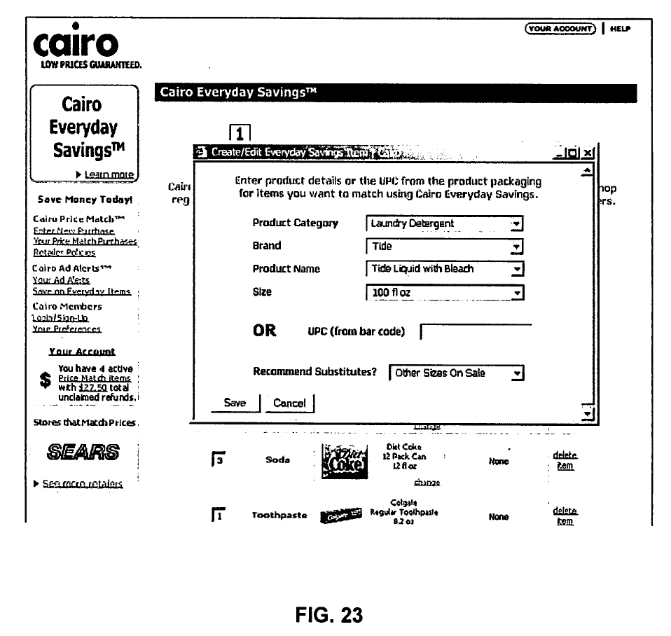

Making it easy to build the list of shopping preferences is critical for adoption. Cairo provides three distinct ways for the consumer to capture their preferred products:
1. The consumer can jot down the UPC codes from the packaging of regularly purchased products next time they unload their grocery shopping. These can be entered into Cairo using a “Quick List” feature (see FIG. 22) which allows a list of UPCs to be quickly typed. These are validated and the corresponding brand descriptions and images are displayed to ensure the correct product selection.
2. The consumer can use the Ad Item popup (see FIG. 23) which contains drop down lists to help identify a product by drilling down through product category, brand, product type, and size preference for any “everyday” item that is purchased regularly.
3. Cairo may partner with mobile device providers to provide a cheap UPC scanner that is integrated or connects to web-enabled cell phones or wireless PDAs (or can be connected directly to a PC). The consumer scans the UPC barcodes of the items that they purchase frequently and uploads the list of items to Cairo.

The Ad Item popup also lets the consumer specify additional instructions regarding acceptable substitutions for either size or brand. These are used when recommending items to the consumer when “optimizing” a shopping trip.

Size substitution preferences determine what Cairo should do if a different size of the consumer's regular product is on sale any week (usually at a better price). The consumer can elect to never substitute for different sizes, whether to only substitute for larger sizes, or whether to always substitute if they can save money.

Brand substitution is similar but for equivalent products within a product category. For example, the consumer may never be willing to switch between Diet Coke and Diet Pepsi. Or they may be happy with either product and always want to buy whichever brand is on sale that week. Cairo allows the consumer to specify whether they will accept any substitutes for an item and specify which brand substitutes are acceptable (from a list of equivalent national brand and private label alternatives).

There is some upfront work in creating the initial shopping list and preferences. Cairo may encourage consumers to “test drive” Cairo Everyday Savings by picking 5-10 of the more expensive branded items that they buy regularly to get started. They can then add additional items week by week as they see the value of using Cairo Everyday Savings.

However, once the initial shopping list has been created, there is very little data entry required to use Cairo Everyday Savings from week to week, typically generating between $10 and $25 in savings per week from an average grocery shopping basket.

Each time the consumer uses Cairo Everyday Savings, they can update their shopping preferences to add new items (using either the Add Item or Quick List popup), change existing items (either product or substitution details), or delete items from the list.

The Cairo Everyday Savings Process

Consumers use Cairo's Everyday Savings wizard to calculate an “optimal shopping trip”, which walks the consumer through four simple steps to find the lowest prices:
Select items for this shopping trip
Confirm optimization criteria
Review optimization results (and adjust as necessary)
Print shopping list (with detailed instructions on stores and items)

Step 1—Select Items for Shopping Trip

The first step of the Everyday Savings wizard allows consumers to choose the items from their list of shopping preferences that they need this particular shopping trip.

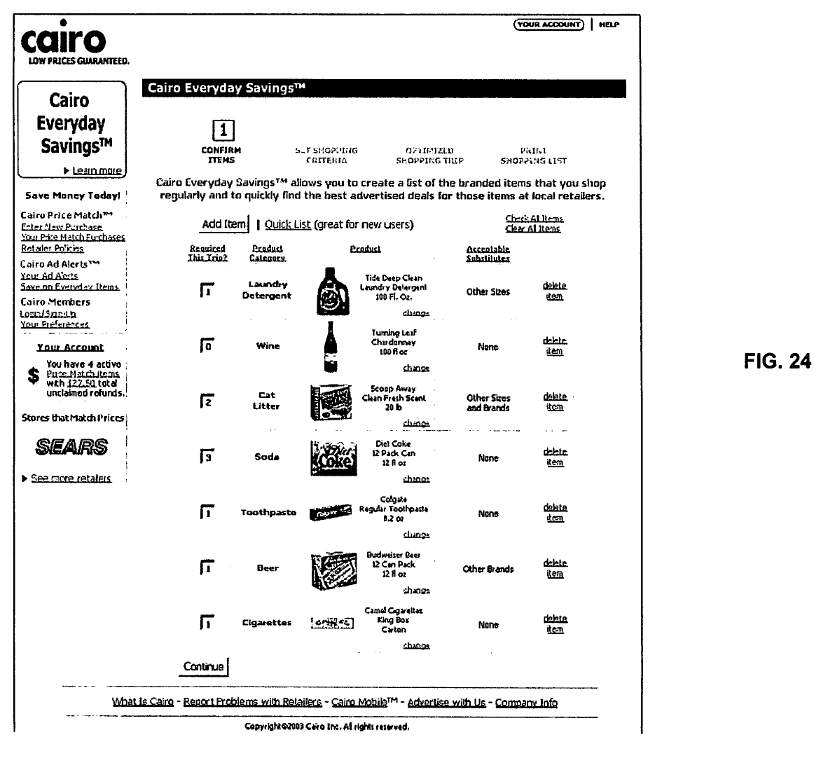

Cairo displays their preferred items (as shown in FIG. 24) and the consumer goes down the list marking how many of each item they need. The consumer simply enters a zero for any items that they do not need this shopping trip. They can start with either a full list of items (by clicking the “check all items” link) and then zero any items that they do not need. Or they can start from an empty list (by clicking the “clear all items” link) and add items they need one by one. By default, Cairo initially displays the selection from their last trip.

The consumer can edit their list of shopping preferences, as described above, especially if they need new items or their preference for a particular type of product has changed.

Once the consumer has selected all the items they need, they press “Continue” to move to the next screen in the wizard. The consumer can always come back to this step to make further changes to the selected items by using the Back buttons or by clicking on “Step 1” in the navigation bar at the top of each wizard page. This applies to all subsequent pages within the Cairo Everyday Savings wizard.

Step 2—Set Shopping Criteria

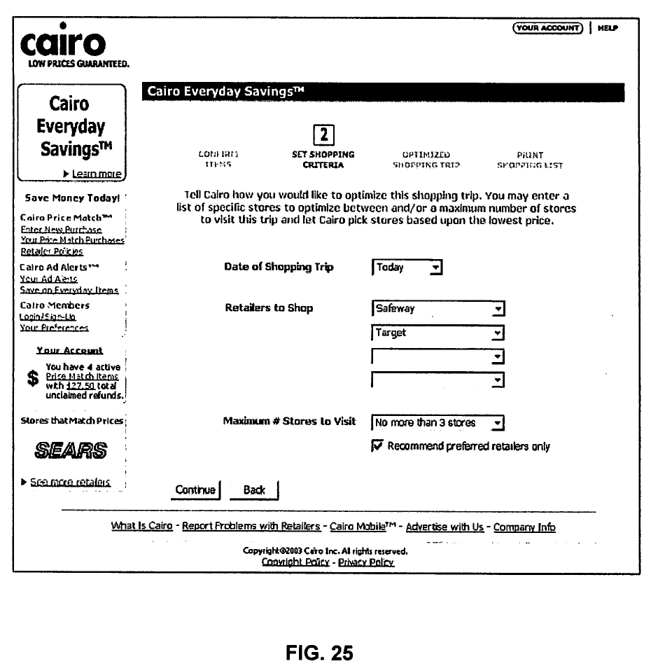

As shown in the interface of FIG. 25, the consumer enters:
the date of the shopping trip
a list of the retailers they plan to visit during this shopping trip
the maximum number of stores they are prepared to visit
and whether to only recommend “preferred retailers”.

Cairo can optimize across a list of named stores recommending which items to buy from which store (for consumers who know they plan to visit multiple stores on this shopping trip). Cairo can also recommend an optimal combination of local stores to deliver the maximum price savings (limited by the maximum number of stores the consumer is prepared to visit). Cairo recommendations may be restricted to their list of preferred retailers. Cairo remembers and defaults the information they entered last time, which may not change much from week to week, usually making this step a simple confirmation.

Step 3—Review Current Deals and Cairo's Recommendations

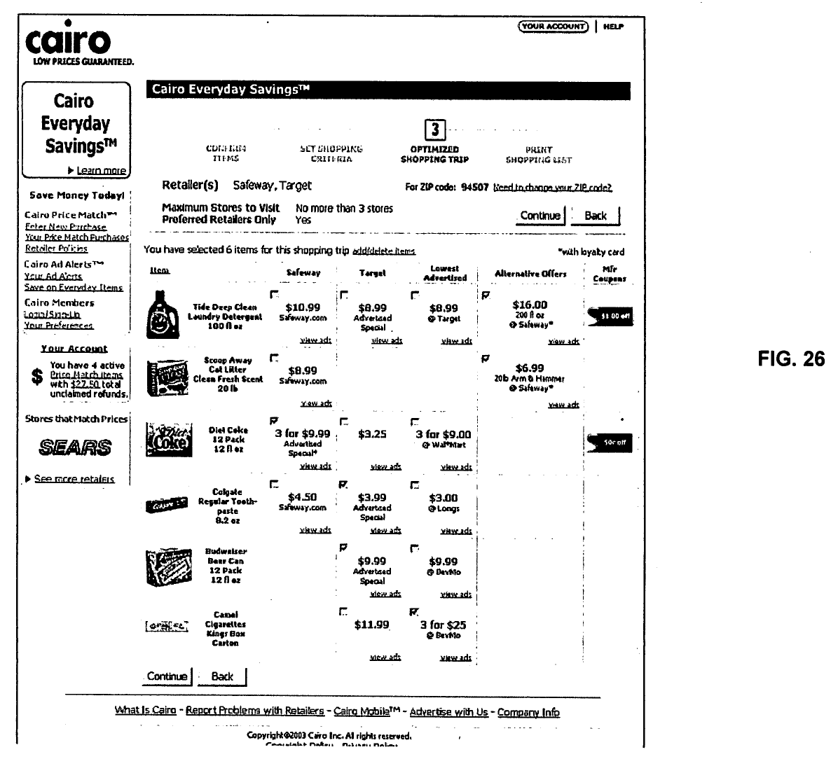

Cairo calculates an optimal shopping itinerary that delivers the lowest overall price while meeting the consumer's shopping criteria as shown in FIG. 26. This is based upon the specific items selected for the shopping trip matched against current local prices and advertised specials.

The offer (and retailer) that Cairo recommends for each item is highlighted. Cairo displays the advertised price (or regular retail price, if available) for each recommended or requested retailer, the lowest locally advertised price, relevant alternative and/or substitute offers, and any available manufacturer coupons. The consumer can link to the retailer's online shopping site or online circular to view more details for the advertised price/offer. They may also drill down to see current Cairo Search Results for any item.

The consumer may re-optimize as many times as they like until they have a list of items at a price and convenience that is acceptable. They may also override the optimization results on any individual item by manually checking an alternative offer for the item.

Step 4—Print Shopping List

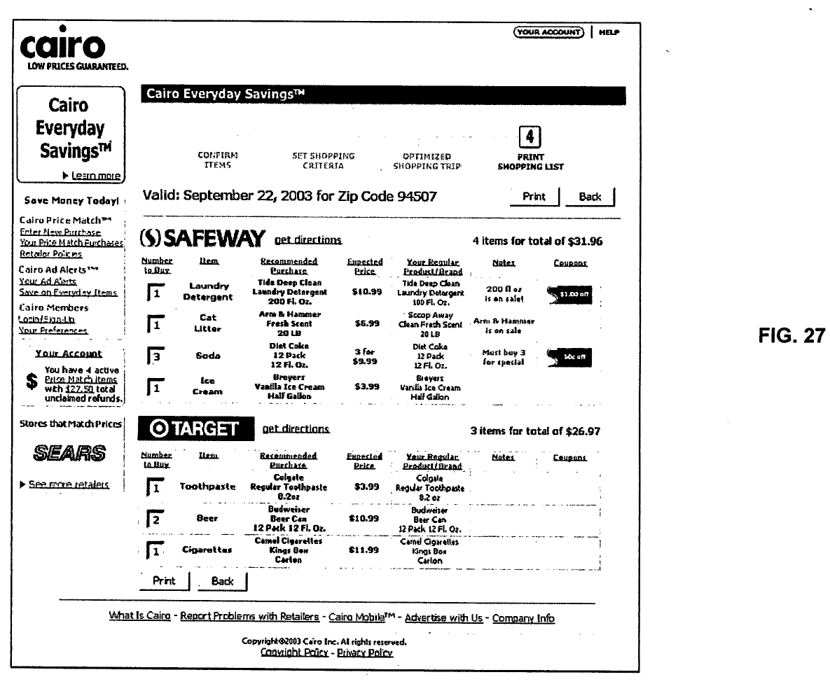

Cairo prints a shopping list (shown in FIG. 27) detailing which items to buy from which store, including instructions about where substitute sizes or brands should be purchased and whether to buy multiples of an item to secure special offers. The list also includes images of any available manufacturer coupons, including bar codes (where possible). The consumer may show the list on checkout and the cashier can scan the coupon bar codes directly.

Sponsored Advertising and Direct Marketing

Cairo Everyday Savings provides retailers and manufacturers with many opportunities to offer the consumer special offers, one-to-one promotions, and/or individual pricing.

Through Cairo, deep consumer segmentation information can be captured based on consumer behaviors and preferences. This may be combined with retailer's own customer loyalty data. Cairo makes this information actionable by providing a delivery mechanism to the consumers at the point of decision making about what to buy on their next shopping trip, targeting information tailored to their specific shopping preferences.

Traditional grocery stores face increasing competition from discounters for some of the most competitive (and profitable) items that make a typical consumer's grocery basket, including items like laundry detergent, pet supplies, and personal care products. Once they lose those items, it is likely that the consumer ends up buying other items while at the discounter (given that they are there anyway). This impacts the overall profitability of the consumer for the grocery chain. More and more consumers are defecting in this way.

Cairo allows grocery stores to fight back by offering “individual pricing” and/or additional coupons/discounts to consumers if they buy the entire shopping list from them. Cairo preferences can be combined with customer loyalty data to specifically target consumers that leverage discounters (and never buy certain items from the grocery store).

Alternatively, the grocery retailer may offer additional discounts targeted at some of the individual items that drive overall basket profitability—matching locally advertised prices.

Cairo may charge transaction fees for delivering 1-to-1 prices and targeted discounts.

Manufacturers are addicted to both promotions and new product introductions. Cairo captures rich consumer segmentation and preference information which Cairo Everyday Savings makes actionable by the manufacturer, who can sponsor which deals are displayed in the “Alternative Offers” column, including offers for competing brands or new products. Similarly, they can sponsor which manufacturer coupons are displayed.

Cairo may charge sponsorship fees for both alternative offers and manufacturer coupons. In addition, banner ads from manufacturers may be displayed to highlight their products.

Store Locator and Directions

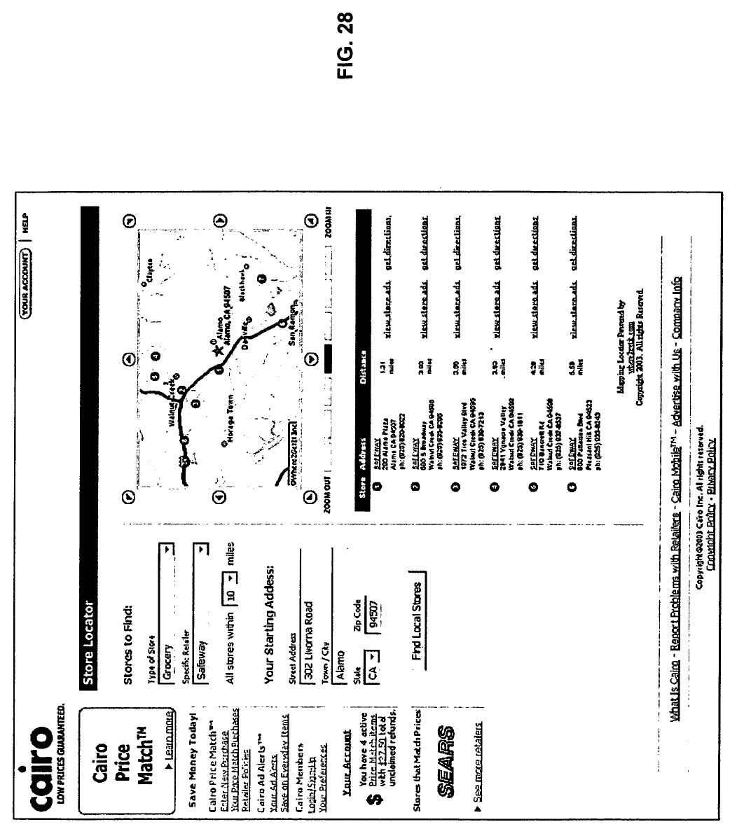

Cairo is focused on helping consumers find the best prices and deals at their local retail stores either online or via a mobile device. The Cairo store locator (e.g., see FIG. 28) further helps consumers by providing maps and directions to nearby stores based on a zip code or from a street address. The Cairo store locator is powered by a third party mapping service provider, such as Zip2, Mapquest, or Where2GetIt. For illustrative purposes only, where2getit.com is shown as the embedded solution in the following screen images.

Finding Local Stores

Cairo Search displays the nearest local store as part of the search results. The consumer may easily get directions or find other local stores by linking from Cairo Search to the Cairo store locator. The store locator is also accessible through links from most other Cairo pages where a retailer's logo or name is displayed.

Nearby store locations are marked on a map (which can be viewed at increasing levels of magnification). A corresponding list of stores is also displayed. For each store the retailer name, address, and telephone number are shown. In addition, the consumer is able to link to get directions or view current ads for that store.

The initial map is displayed for the specific retailer that contained the link from which the store locator was opened. The map is local to the consumer's zip code and the street address. The consumer can change the store selection to find local stores for any specific retailer or to find all stores of a specific type (e.g. electronics retailers or grocery stores). The consumer can also change their starting address.

Viewing Local Ads by Store

The consumer may view the current local ad for any store listed in the locator, using the Cairo Ad Browser or linking through to the retailer's own web site.

Paid Banner Ad Sponsorship

Retailers may sponsor banner ads to be shown to consumers using the Cairo Store Locator. These ads are context sensitive and displayed based on the type of store that the consumer is trying to find. For example, grocery ads from one or more specific retailers may be displayed when the consumer asks for directions to a particular store.

Getting Directions

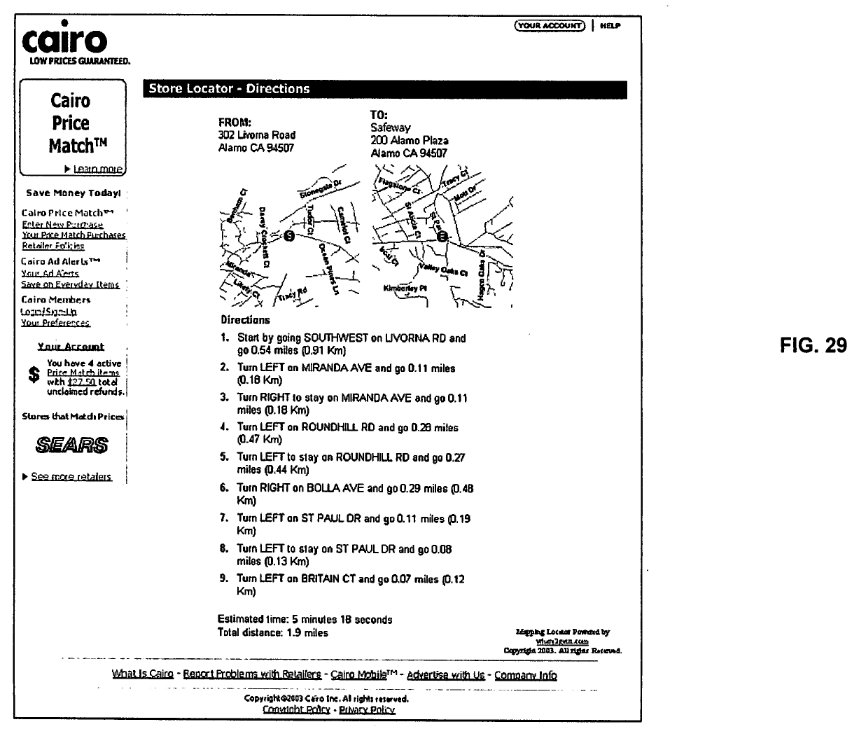

The consumer may get directions from their current location to any store by following a link in the store listing. This is based on their starting address and they are shown driving directions together with a map(s) for the suggested route as shown in FIG. 29.

Retailer Price Match and Guarantee Policies

Cairo aggregates details of retailer's price match and guarantee programs. These are used by Cairo to support Cairo Price Match features and are also made available to consumers to determine and compare the different programs that retailers offer. This section describes the information available and use cases for these retailer policies.

Comparing Price Match and Guarantee Programs

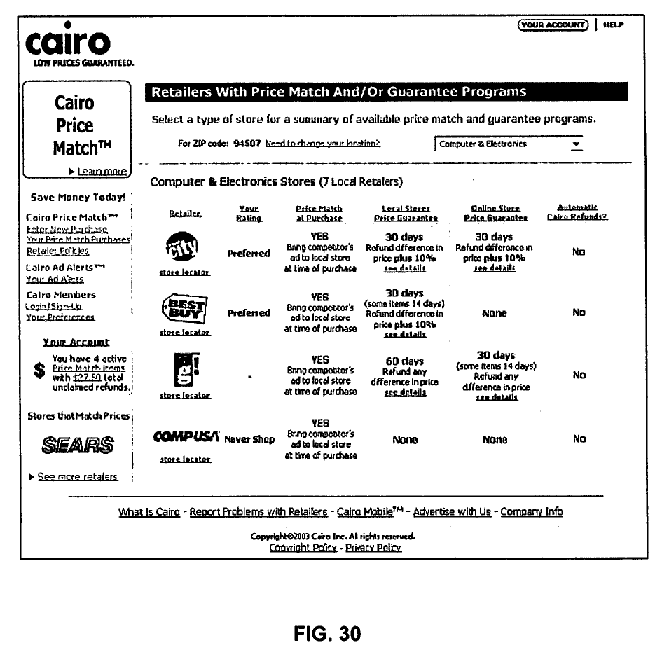

Before shopping, especially for regular Cairo Price Match users, consumers can check and compare retailer's price matching and guarantee programs as shown in FIG. 30. They specify a type of store and Cairo displays the list of local retailers (based on the consumer's zip code) and their policies for: price matching at time of purchase; for price guarantees at their local stores; and for price guarantees at their online store (which are usually different). In addition, Cairo shows whether the retailer supports Cairo's automated price match refund capability (as described in the Cairo Price Match section). The consumer may drill down on any of the policies for a more detailed description.

Finding Details for a Specific Retailer

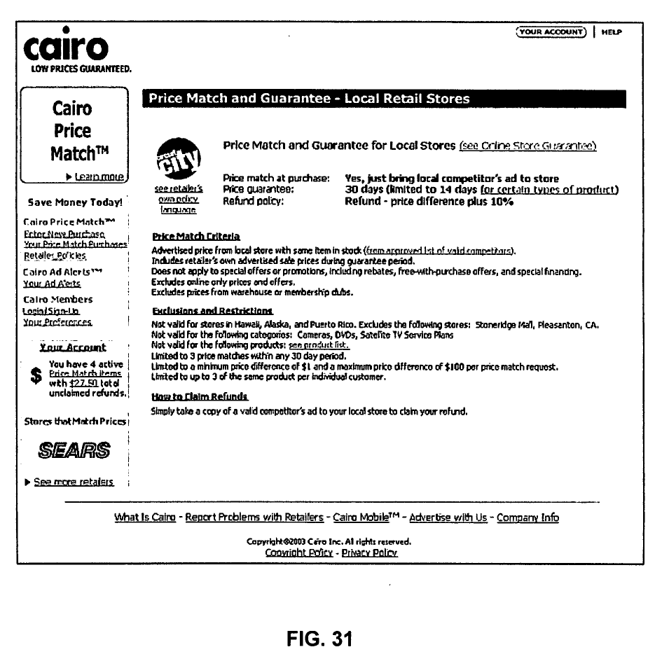

The consumer may also look up the detailed price match and guarantee policies for any local retailer by selecting a retailer name as shown in FIG. 31. A high level summary, plus detailed terms and conditions (with any exclusions and restrictions) are displayed.

The policies for local stores will often be different from the policies for the retailer's online store. Cairo displays the local store and online store policies on different pages. The consumer can easily link back and forth between local store and online store policies.

Highlighting Retailers that Price Match

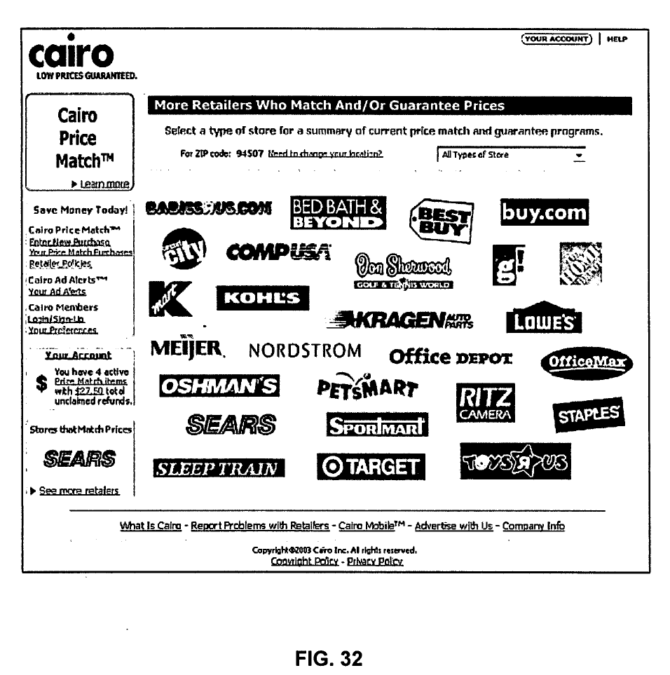

To help promote its Cairo Price Match capabilities, Cairo draws consumer attention to retailers that offer price match and guarantee programs. The names and/or logos of major local retailers that price match are displayed in the “Stores That Price Match” box in the bottom left corner of most Cairo pages (see FIG. 31). A larger list of local price match retailers (e.g., as shown in FIG. 32) may be viewed by following the “See more retailers” link within that box.

Membership and Preferences

Cairo requires membership for access to some value added services, including Cairo Price Match and Cairo Everyday Savings. Membership allows the consumer to specify basic details about themselves, including their zip code and email address. In addition, Cairo may charge fees for different tiers of member access and usage. It should be noted that Cairo membership fee payment mechanisms are not shown in the following use cases.

New Visitors to Cairo

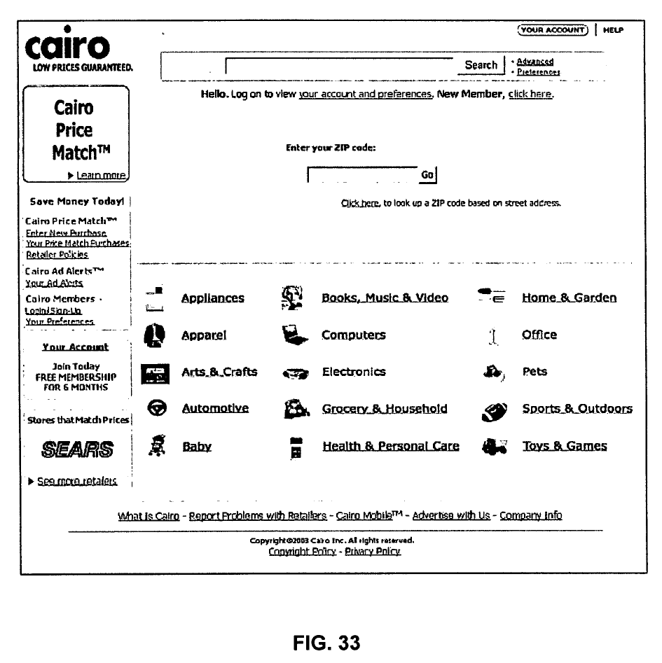

New visitors to Cairo are recognized based upon whether a Cairo cookie exists on their PC. If no cookie is found, the New Cairo User page shown in FIG. 33 is displayed, asking the consumer to become a Cairo member or for existing members to log in. At minimum, the consumer must specify their local zip code to use Cairo. If the consumer does not allow cookies, they must login or reenter a zip code every time they use Cairo.

Member Registration

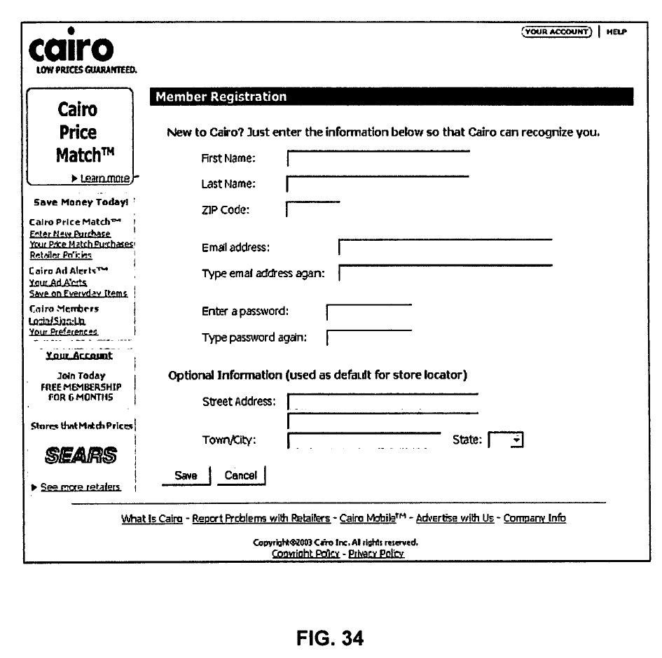

Most consumers will find it simple and convenient to become Cairo members. Cairo lets consumers register (see FIG. 34), by capturing their name, email address and password. Cairo does not require any additional information, although they may specify a street address, which is used as a default in other parts of the website. The street address is not required.

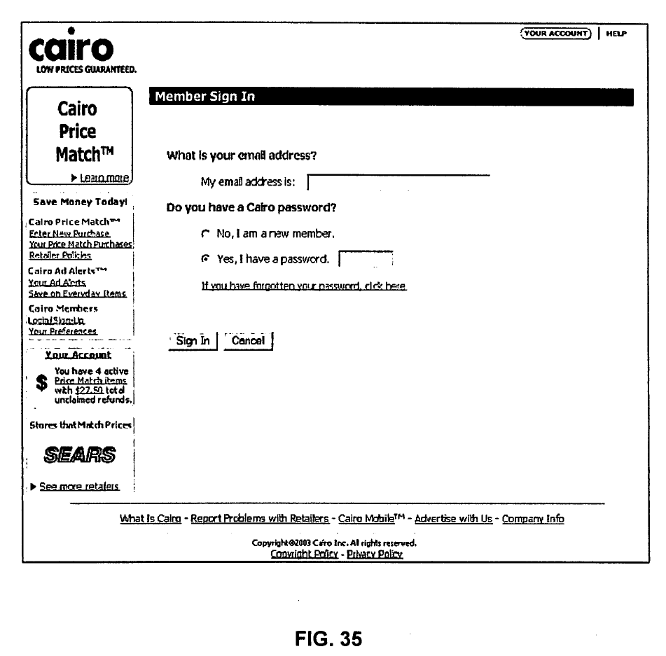

When entering the Cairo website, a cookie tells Cairo whether this is a returning member and displays a welcome message. If this is a returning user, they are welcomed and asked to confirm they are the user named by Cairo as shown in FIG. 35. If not, they can log in as someone else or register as a new member. If no cookie is found, the welcome message asks the consumer to log in or to register as a new member.

Cairo provides assistance to the consumer if they should forget their password, asking them to verify their email address and zip code, before emailing them a link that allows them to reset their password to something new.

Member Preferences

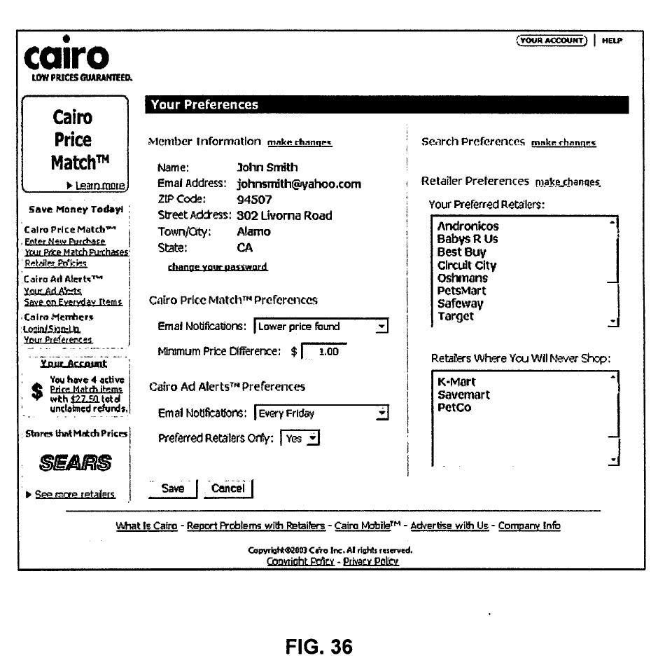

Members may set a number of preferences using, for example, the Membership Preferences page of FIG. 36. Such preferences may include, but are not limited to:
Notification preferences and tolerances for Cairo Price Match
Notification preferences and settings for Cairo Ad Alerts
Search preferences (see Cairo Search section for details)
Retailer preferences.

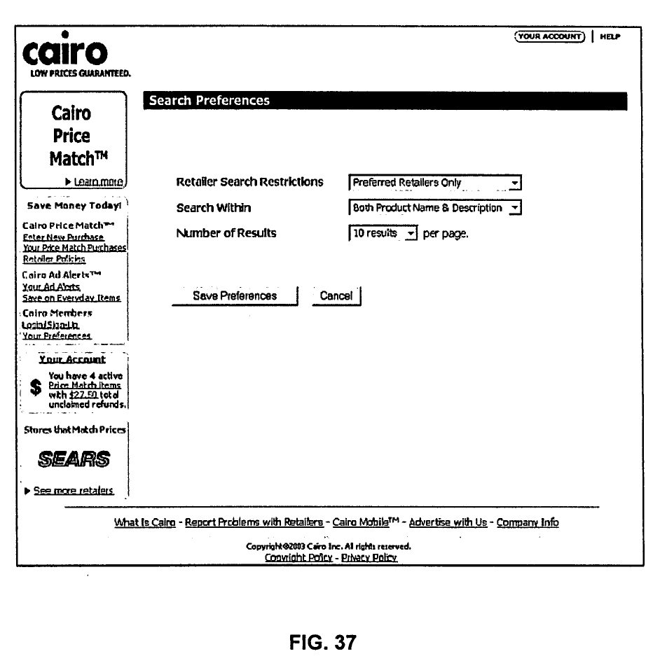

Cairo allows search preferences to be defined (see FIG. 37) that set defaults for every Cairo Search that the consumer executes, including, but not limited to:
Limiting searches to preferred retailers only
Making Cairo Search faster by restricting the search to product name only
Setting the number of search results shown per page.

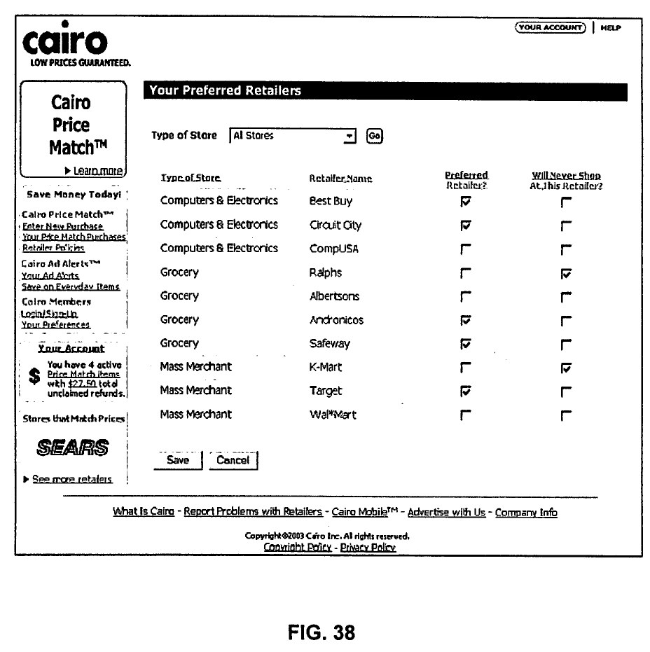

Retailer preferences (see FIG. 38) allow the consumer to identify their preferred local retailers and also those retailers where they will never shop. Cairo allows searches and filters to be applied based on these preferences (e.g. show me only preferred retailers) and excludes “never shop” retailers from recommendations and local ad searches.

Cairo Mobile™

Cairo Mobile allows all of the features, functionality, and use cases of Cairo to be accessed while out shopping and even walking the aisles of a retail store.

3.8.1 Cairo Mobile™ Use Cases

Many Cairo use cases are further enabled or enhanced by Cairo Mobile. A consumer may find the product they want in a local store, but be unsure of whether they are getting the best available price. Of course, they would prefer to just buy it there, as opposed to driving from store to store or going home to compare prices online.

Cairo Mobile allows the consumer to enter the product's UPC (from the shelf label or product packaging). They may also enter the brand and model number. Cairo finds and displays (to their cell phone, PDA, or handheld computer) the current prices at other local stores, plus current online prices, for the product. The consumer can then determine whether to buy today, go elsewhere, or postpone the purchase.

Cairo Mobile allows a consumer to easily look up the price guarantee policy for any product and/or retailer to determine whether it is a price match candidate. If they know that the product is covered by a price guarantee, they can safely buy today and use Cairo Price Match to ensure that they ultimately get the best price.

The Cairo Store Locator allows consumers to find and get directions to any local store based upon a zip code or street address. Retailers may use Cairo's sponsored ads capability to provide links for the consumer to receive special deals/promotions.

A consumer may suspect that a product is frequently on sale and therefore be hesitant about buying a regularly priced item. Through Cairo Mobile, the consumer can look up when the product was last on sale, at which retailers, at what price, and also the average prices that other local Cairo members have typically paid for that same item.

Capture of Local Store Prices

When using the price comparison capability via Cairo Mobile, the consumer will usually be in a store looking at the product they want more information about. When they enter the UPC or model information, consumers are also asked to specify the retailer where they are shopping and the current price of that item. This helps Cairo validate the information they entered. It also allows Cairo to build up a comprehensive price history for items that members are seeing in their local stores (and capturing for Cairo).

Cairo Mobile Setup and Access

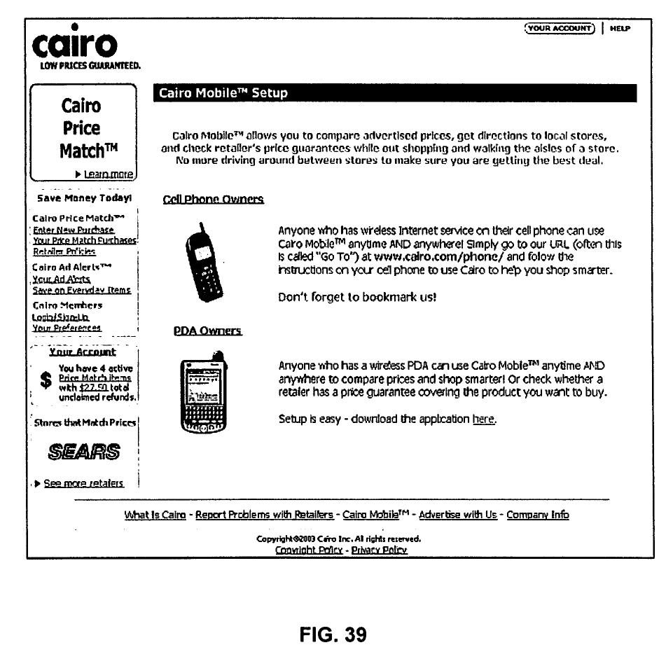

From the Cairo home page, consumers can follow a link to the Cairo Mobile Setup instructions (see FIG. 39), which will guide the consumer through accessing Cairo from web-enabled cell phones and/or allows them to download a Palm application for Cairo Mobile access.

Further Opportunities with Enhanced Mobile Technology

Cairo may partner with mobile device providers to integrate small UPC scanners into their products (or provide plug in attachments) which will allow Cairo users to simply scan the bar codes on shelf labels or product packaging to initiate price comparison requests.

Mobile devices will more frequently be GPS enabled in the near future. Knowing the location of the cell phone user further enhances Cairo Mobile features. For example, the Cairo Store Locator no longer needs to be told a starting address but provides directions based on the current location of the cell phone. Likewise, knowing the GPS location allows current store location to be defaulted when requesting price comparisons.

The combination of Cairo content and services with location based data and services significantly extends Cairo Direct Marketing capabilities for accurate targeting of 1-to-1 pricing and deals delivered via cell phones or mobile devices. Through Cairo Mobile this is more akin to “paid search”, solicited by the consumer, as opposed to intrusive spam.

Content Acquisition and Aggregation

Content lies at the heart of the Cairo business model. The ultimate goal is for Cairo to “know” the current regular retail price, plus any advertised lower prices or special offers, for every product in every local store (for all national, regional, and local retailers). This data must be easily searchable and comparable (by local zip codes). It should also be easily comparable with the current corresponding online prices and deals.

Coverage includes all advertised prices from any source, including weekly circulars (from store, newspaper inserts, or direct mailing), newspaper and other printed ads, in-store and loyalty program specials, online pricing and Internet deals, mail-in rebates, manufacturer coupons, and any other available published or advertised pricing/deals.

This section describes the approach to enable and automate the content acquisition and aggregation process.

Data Sources

Ultimately, Cairo may develop relationships with each retailer to provide price and promotion data electronically for regular upload into Cairo. However, in the short-term, it is unlikely that retailers will provide this information due to the sensitivity of retail price data in a highly competitive market. Cairo may also not start off with a large enough consumer base to attract significant retailer attention and advertising. Prior to achieving critical mass, Cairo must therefore find other ways to capture and aggregate content.

Cairo may initially focus upon aggregating published advertised prices from weekly circulars and newspaper ads. This is supplemented, where appropriate, by online prices and by competitive price shop data, collected using a third party firm, such as QRS, who actually visit physical stores to scan current price data for high volume items.

Nearly every US retailer produces some form of weekly (or other frequency) circular. In addition, the majority of retailers and newspapers post their current circulars on their own web sites, making the circulars searchable and highly integrated with their online shopping experience. But this information is retailer specific and not available in an aggregated form searchable across retailers, a core Cairo capability. In some cases, the weekly circulars may only be available in printed form (for consumers to pick up in-store or sent to them via direct mailings). Cairo may capture both online and print only ads.

Online prices are available on retailer's web sites. In addition, many web sites already offer price comparison for online prices. Search engines, such as Google, have also expanded into “product search” (e.g. Froogle) to allow consumers to find and compare online prices. Cairo may partner with one or more of these existing providers to obtain content for online prices—for easy comparison with local retail prices.

Data Capture and Aggregation

According to specific embodiment, Cairo employs a combination of automated and manual processes to capture price and promotion data. It is unlikely that this process can be fully automated. Cairo may therefore establish an offshore “content factory” with the capability to manually re-key and verify content based on ad images and any available supporting data. The content factory supports the capture of ads from both online and print only sources. Tools and processes are provided to facilitate timely and accurate data entry. These processes are highly integrated with and supplement web crawler data capture.

Cairo web crawlers monitor a targeted list of retailer and newspaper websites for new postings and/or changes to the retailer's ad circular images and content. Given the finite universe of websites that Cairo is monitoring (very different from a traditional search engine web crawler that requires significant flexibility) the web crawler is customizable to the specific design and data availability of each target website.

The web crawler attempts to automatically extract the following information for each new retailer ad that is posted to a retailer's or newspaper's website:
Retailer name
Valid locations (by zip code) for the ad
Start and end dates that the ad is valid
Manufacturer, brand, and product information for each item within the ad
Price and promotion information for each item within the ad
Key search words associated with each page and/or item within the ad (e.g. product category, brand, manufacturer, model name/number, UPC)
Full size and thumbnail images for each page of the online or printed ad circular.

Where the web crawler cannot obtain this information automatically, the missing data elements are highlighted and an alert is automatically sent to the content factory to start the manual process of adding and verifying the missing data. At minimum, the web crawler identifies that an ad has changed and notifies the content factory that action is required for that retailer (parsing out the different variations of ad based on zip codes).

Web crawlers are also be deployed, where necessary, to capture online prices for retailers that are not well represented by existing product search or price comparison engines (for example, online prices for grocery chains such as Safeway) or online prices for everyday low price retailers that use ad circulars less frequently (e.g. Wal*Mart).

A separate web crawler captures which retailer's ads apply to which zip codes and store locations. This significantly reduces the number of ads that need to be searched each week as a single ad can be captured that applies to all of the stores and zip codes within each of the retailer's “ad zones” (as opposed to crawling for every zip code/store).

The content factory may be an offshore, outsourced operation which may allow ad circular data to be manually keyed from scratch or to manually supplement base data extracted automatically using a web crawler. The content factory leverages contract workers with significant flexibility in accommodating peaks and troughs in workload. Content factory locations with time differences with the US works in Cairo's favor by allowing ads posted during the night in US time zones to be immediately addressed.

Cairo provides significant technology in support of the content factory to enable as much automation as possible, ensure greatest accuracy, and achieve cost effectiveness for manual data entry processes, including, but not limited to:
Tight integration with Cairo web crawlers (automated alerts for new work orders, pre-population of web crawler data to content factory processes, links to original data sources for online investigation and data acquisition, etc.)
Product identification tools and databases to help uniquely identify a product based on ad descriptions, brand, model name, model number, size, UPC, or any other distinguishing characteristics that enable a product to be uniquely mapped.
Data validation techniques to cross validate manual data entry and eliminate keying errors. This would include automated validation against common typing errors, testing of numerical entries against expected tolerances, and other common techniques to ensure accuracy. A blind, double entry approach may also be adopted whereby the data is entered twice by different people and automatically cross validated against each other to highlight any discrepancies.
Automated generation of key search words associated with each ad, ad page, and individual ad item—derived from the retailer, product, and price data.
Publish and upload processes to automatically transfer completed data from the content factory and to publish this to the Cairo web site for access by consumers.

Additional details regarding the management of content according to specific embodiments of the invention are provided below.

Content Management

The following sections describe in detail the end-to-end process and technical design for content acquisition and aggregation according to a specific embodiment of the invention. The content management design allows Cairo to cost effectively capture retailers' locally advertised prices from various content sources, including pricing and online circulars on the retailer's own websites and/or hard copy printed versions of ad circulars, through a combination of innovative “adaptive” web crawlers and an automated content factory.

Requirements and Data Sources

According to some embodiments, Cairo uses a combination of web crawler technology and manual data entry to capture retailer's ad item data. This is highly targeted against the top 100-200 US retailers that publish regular ad circulars. The data requirements are very specific and granular including, for example, the advertised price, product description, model number, and any mail-in rebates for each advertised item on each page of the retailer's ad circular. Cairo also captures ad page images and links to the online circular on the retailer's own web site (for click through by consumers). In addition, each ad is only valid for a specific timeframe and may only apply to specific group of zip codes and/or store locations (the retailer's ad zones). Cairo requires a high degree of accuracy and timeliness. Using generic web-crawlers may not be feasible. They are not designed to segregate data by responding to http POST protocols and cannot extract the specific and required data elements from the resulting web page. In addition, existing online price comparison and shopping sites do not need to deal with time sensitive pricing data that only applies to certain retailer ad zones and store locations.

To make matters even more difficult, there is significant variation in what data is available on the retailers' websites and how that data is presented. Many retailers have sophisticated online circulars (using technology from third party vendors like CrossMedia Services) which clearly enumerate all of the required data elements. Some enumerate every element of the ad item except for the price or display the online price instead of the locally advertised price. Some enumerate only those items that can be ordered online, but omit items exclusively available at the store. Still others don't enumerate any part of the ad item and only provide images of the ad circular. A few retailers don't even make their ad circulars available online and Cairo must capture coptent from printed ad copy (or they only make their ads available as downloadable PDF files which amounts to the same thing).

Cairo employs a specialized tool that addresses all of these content extraction requirements and variations. This tool is called the Content Management application and is used to manage, schedule, and automate the entire end-to-end Cairo content acquisition process.

The Content Management Application

The Content Management application has the following purposes:
Define and configure content sources based on retailer website abilities. A content source constructs the method for obtaining content from each retailer. There are three types of content sources that are initially implemented (and one more planned in the future).
   1. Fully automatic content extraction.
   2. Partially automatic content extraction for images and data elements followed by manual completion.
   3. Manual entry of ad item data elements from scanned images of print only ads
   4. Direct feed from retailer in the form of a CSV or XML file.
Construct retailer store locations, automatically by crawling the retailer's web site, and/or manually, when store locations are not available online. The retailer's store locations provide an entry point for Cairo to crawl for ad images and ad items, minimizing the number of hits on the retailer's web site to only those zip codes where they have physical stores.
Automatically extract as much content as possible from a retailer's website by using an “adaptive” web crawler for the specific content source configuration. This includes automatically comparing and determining whether ad pages are identical so that subsequent manual completion and QA activities may only be completed once per unique ad page.
Implement a manual content entry system to allow manual completion of ad content that could not be fully crawled and/or for the manual entry of hardcopy print circulars.
Interpret and stage the results of the content gathered from either the web crawler or the manual data entry system. Provide tools to identify questionable ad items, add missing ad items, and correct existing data elements as necessary.
Implement a process to review and activate content from staging to the production Cairo system (making the content available to Cairo consumers). This also allows for processes to selectively pull data back from production if problems are subsequently found.
Periodically perform housekeeping to remove and archive staging data.
Manage all of the workflow and scheduling of the above activities, including the timing of running web crawler jobs (e.g. when retailer posts new ad data) and the management of work queues for Cairo employees that are supporting the content management process.

The process and sample screens in the following sections are meant to demonstrate a flow through the content management process. The actual layout and exact functionality may vary according to different implementations.

Automated Content Extraction

Automated content extraction is performed by a tool hereafter referred to as the “adaptive crawler”. The adaptive crawler is so named because it performs a somewhat similar task as a generic web crawler but it is highly configurable to the specific needs of periodic ad content.

Instead of exhaustively following every link and indexing the page with limited ability to interpret the contents of the page, the adaptive crawler uses site specific configuration to help interpret a given website. This configuration must be manually created and maintained. Generic web crawler technology is not appropriate for periodic ad content since determining what constitutes ad item information from online content is difficult. Creating a generic mechanism to do this would be far too expensive. Furthermore, ad data is not always in a form ideal for searching. Ad items are often displayed as images of newspaper inserts and employ popup windows to highlight or zoom into specific items on the image. As a result, the content is often embedded inside method calls that provide the popup window functionality for “mouse over” on areas of the image. Cairo must extract detailed information to identify each advertised product, together with the advertised pricing and any terms associated with that ad item.

Even deciding where to start is not something that can be done in a generic way. It is not enough to start with a specific web site address for example. Cairo must find the start of the weekly ad page, possibly POSTing zip code information, and cycle through each possible zip code for a given site.

The Cairo adaptive crawler is designed to automatically crawl websites but is tailored for specific website HTML tag and location information. A configuration file, that is specifically configured for each site and can be automatically searched, is utilized. This aids the adaptive crawler in traversing the HTML document to find the exact location of the desired content. The adaptive crawler is specifically designed to crawl for partial data when full ad item data is not available (e.g. ad images, URLs, and whatever ad item data elements are available).

Since a retailer may divide their ad circulars by geographic region, Cairo provides a way of downloading all available unique ads. It does this by capturing a list of store locations and using the zip codes of those locations to access the retailer's website. Therefore, at most, Cairo captures one unique ad per retailer for each of their available store locations. A configuration file is similarly used to help crawl for store location information and build a database of store locations for each retailer's site (usually based on their store locator). In summary, each site has an individual configuration file called the Site XML Configuration file that tailors the crawl for the particular retailer's website and content availability. The detailed design for the site configuration file is described in the Adaptive Crawler section.

Users and Roles

The Content Management application is operated by individuals in three different roles: Content Source Manager(s), Content Factory Operator(s), and Content Factory Supervisor(s). There are distinct entry points into the Content Management application for each purpose.
The Content Source Manager constructs and maintains methods to obtain content from the various retailers, including the configuration of each data source. This is referred to as Content Source management and can be accessed from the initial Content Management screen. This function may be handled by a single individual given the limited number of retailers. The Content Source Manager is also responsible for creating and maintaining users.
Content Factory Operators manually review, insert, and update content streamed in from various Cairo data sources. They are responsible for both the manual completion of partially crawled ad data and for the manual entry of ad items associated with scanned ad images (where only print ads are available and Cairo cannot crawl for content).
Content Factory Supervisors are responsible for the final review, approval, and activation of ad content, controlling the release to production once quality levels have been satisfied.

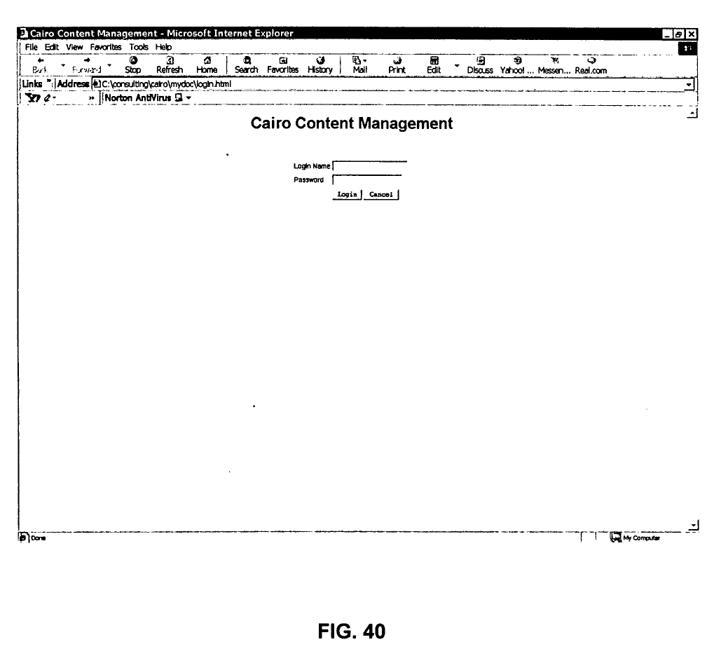

All content management users start by logging into the Content Management application (FIG. 40).

Content Source Management

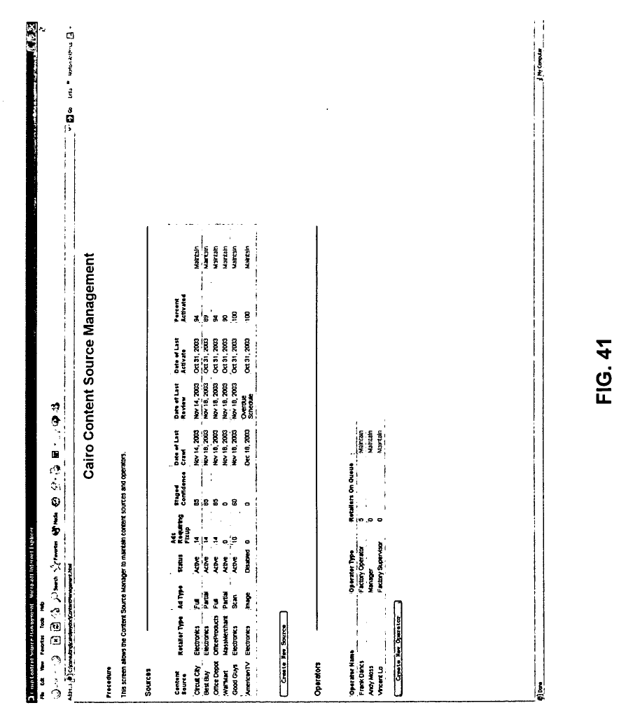

The initial Content Source Management screen (e.g., FIG. 41) displays a list of the current Cairo content sources (usually one per retailer) and allows the Content Source Manager to edit/maintain the configuration of an existing content source or to create a new content source. It also displays the list of valid Content Management operators, together with their status. This allows the Content Source Manager to create and manage user accounts for all of the Cairo Content Factory staff, providing access to the Content Management application.

The current status of each content source is displayed which allows the Content Source Manager to quickly identify problems and/or changes to retailer websites that are causing the adaptive crawler to fail. It also allows the Content Source Manager to manually disable content sources while the configuration is being repaired, before bringing a content source back on line.

Current status information for each content source includes:
Retailer Type
Ad Type
   Full—adaptive crawl for full ad image and ad item content
   Partial—adaptive crawled for content but may require additional manual input
   Image—adaptive crawled for the image only. Requires full manual input
   Scan—image must be scanned through from a print only (hardcopy) source.
Status—indicating whether an ad has been disabled manually or automatically by the adaptive crawler when an error has occurred (e.g. unable to locate website)
Ad Items Requiring Fix-Up—displaying a count of the current ad items requiring manual review or completion.
Staged Confidence—the cumulative confidence of the staged items waiting for review. This number is derived from calculating the average confidence of all ad items staged for this retailer. This helps estimate the amount of work required to review and fix up the ads.
Date Last Crawled—to determine the timeliness of the content and any scheduling issues.
Date of Last Review—to indicate when the retailer's staged items were last reviewed and updated by a Cairo Factory Operator.
Date of Last Activation—showing when ad content for this content source was last activated to production by a Cairo Factory Supervisor.
Percent Activated—this number indicates the percentage of ad items that were activated (went live) verses the number of ad items that were discarded.

The list of content sources may be sorted by clicking on any of the column headings. To create a new content source, the Content Source Manager presses the “Create New Source” button.

The operator list shows all of the current Cairo operators that have access to the Content Management application, which allows the Content Source Manager to control access. The operator list contains:
Operator Name—the user name for the Cairo operator.
Operator Type—either Content Factory Operator, Content Factory Supervisor, or Content Source Manager. An operator may be assigned more than one user name if they have more than one role or the implementer may chose to allow more than one role to be assigned.
Retailers On Queue—the number of retailers currently waiting activity by that operator.

The operator list may be sorted by clicking on any of the column headings. To create a new operator account, the Content Source Manager presses the “Create New Operator” button.

Source Creation Screen

The adaptive crawler can “crawl for” one or more of the following data elements:
Ad item data elements (e.g. title, model number, price, etc)
Ad images and URLs (e.g. the distinct ad pages assigned to one or more locations)
Retailer locations

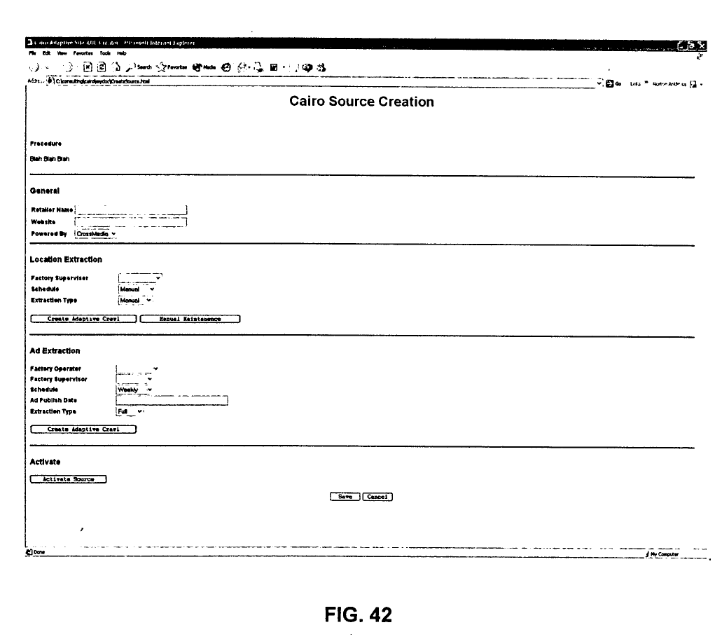

To create a new content source, the Content Source Manager evaluates the availability of both store location and ad content on the retailer's web site (if any) and determines which content extraction techniques are appropriate. The Content Source Manager uses the screen shown in FIG. 42 to create and manage the configuration for a retailer's site (to support extraction of both location and ad content).

Location Extraction must be configured first, as location information is required for the ad crawler to function. If location content can be crawled, the Content Source Manager presses the “Create Adaptive Crawl” button and creates/tests the configuration. If location content is not available online, they press the “Manual Maintenance” button and create locations manually.

Once locations have been successfully created, the Content Source Manager proceeds to configure and test the Ad Extraction crawler, by pressing the “Create Adaptive Crawl button. For example, if only ad images were available on a retailer's website, the adaptive crawler is configured to crawl the site and extract just the ad images. It obtains an ad image for each available store location and automatically determines which of those images are a duplicate of an image in a different store location. This is done by comparing each image with the image already captured in the staging tables. Cairo then places an item in a Content Factory Operator queue to manually add the corresponding data elements. Many retailers have purchased their online ad circular technology from third parties (e.g. CrossMedia Services) with fairly standard implementation across multiple retailers.

Ad Extraction Screens

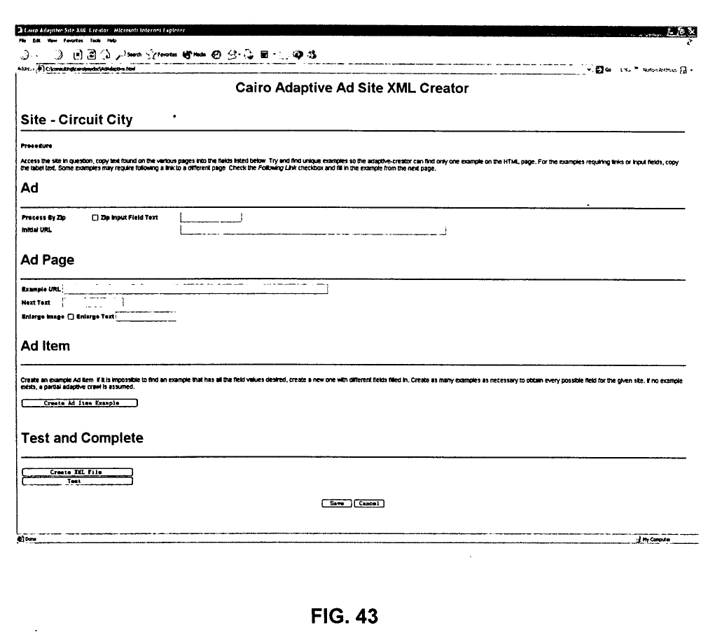

The Content Source Manager uses the screens of FIGS. 43-47 to create a site XML configuration file for the adaptive crawler. These screens help the Content Source Manager manage this process without requiring him to create the site XML configuration file by hand.

The Content Source Manager first specifies how ad information is accessed on the retailer's web site (e.g. by zip code), the initial URL for accessing online ad information, and the text (e.g. Enter Zip Code) associated with any data input fields required to access the ad data (see FIG. 43). They then enter initial ad page configuration information, including an example ad pager URL, the text associated with the “next page” button, and the method for enlarging the ad page image.

Once, the basic configuration has been created, the Content Source Manager uses the “Create Ad Item Example” button to create multiple examples of ad page and ad item content.

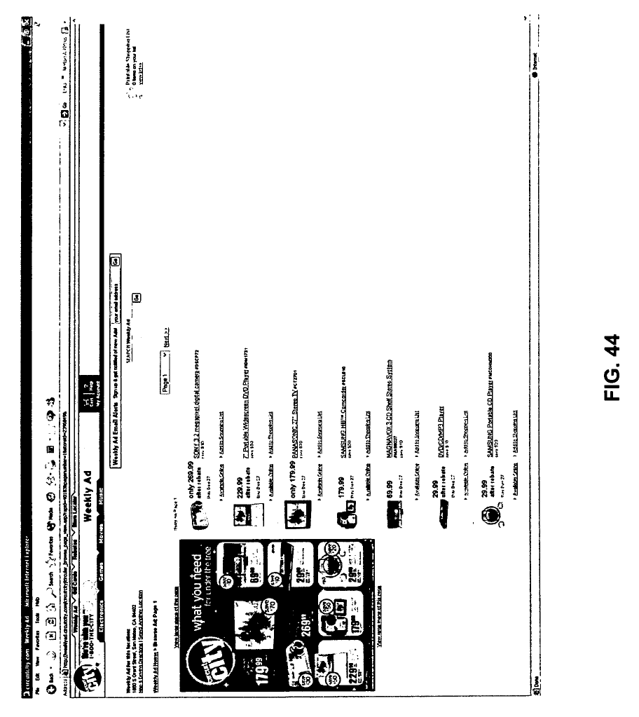

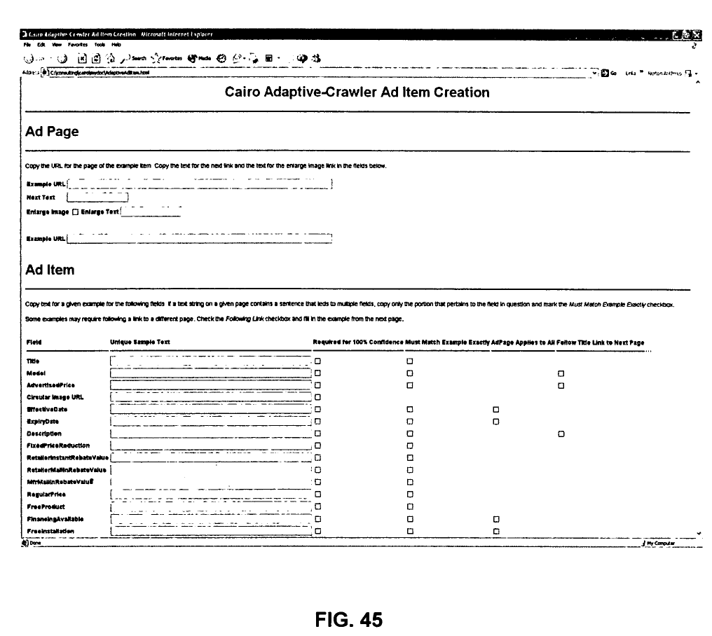

This is done with two windows open on their PC, one containing the Ad Items screen of the Cairo Content Management application (see FIG. 45) and the other containing the retailer's ad item pages on their own web site (see FIG. 44). The Content Source Manager chooses some example ad pages and ad items, copying the data elements from the retailer's site to the corresponding Content Management maintenance screens.

For example, the Content Source Manager cuts a product description from the retailer's online ad page and pastes it into the title field in the example screen. When the example tool runs, it parses the HTML document searching for the example text that was provided. The path to these example items is recorded enabling the adaptive crawler to interpret the site's HTML document to find appropriate content in the future. The site XML configuration file contains these paths. However, in some cases the site XML configuration file may contain errors. This tool is used as a starting point. A Content Source Manager(s) with skills in configuring adaptive crawls, including XML, are required for source management.

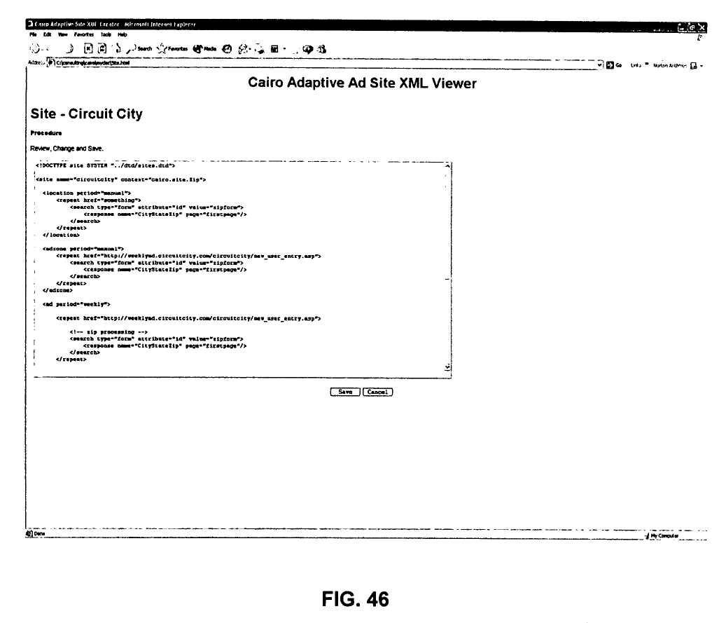

After fully configuring the site for ad extraction, the source manager selects the “Create XML Button” in the Test and Complete section (FIG. 43) to create the actual site XML configuration file. The screen of FIG. 46 then gives the Content Source Manager the option of making any modifications.

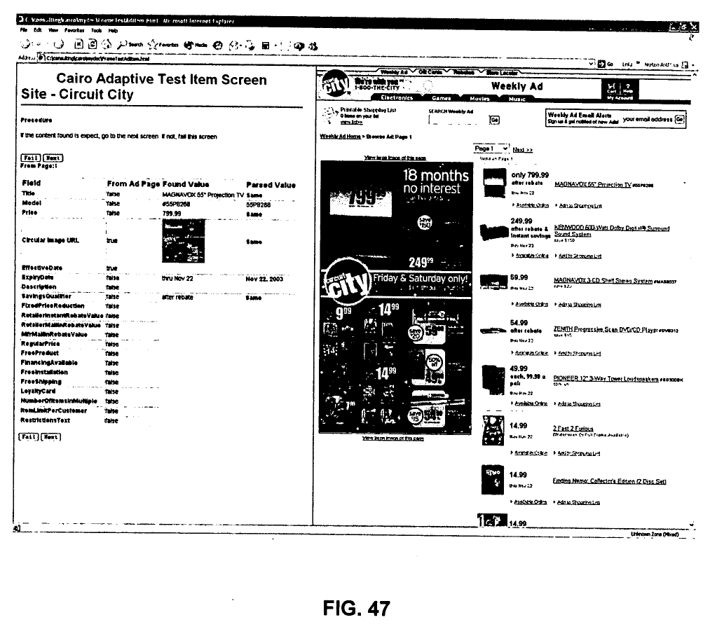

If the source appears proper, the Content Source Manager tests the site by hitting the “Test” button on the Adaptive Ad Site XML Creator screen (FIG. 43). The content manager application leads him through a set of screens that displays the ad item content as found by the adaptive crawler (e.g., FIG. 47). Typically, the Content Source Manager iterates between creating ad page and ad item examples, making manual XML configuration changes, and testing the XML, until they are completely happy that the ad crawler is functioning correctly for that content source.

It should be noted that least a subset of accurate retailer locations must have been successfully created before the Ad Extraction crawler can be tested. This is because the ad crawler uses the zip code from the retailer locations to restrict where to look for ad content on the retailer's site. The Content Source Manager can always manually create a small number of valid retailer locations to allow the testing of ad extraction to proceed in parallel with retail location extraction.

Location Extraction

Retailer location content is required before any ad extraction can be scheduled for a given retailer. Ad extraction is based on the zip codes of valid retailer locations. Therefore, it requires at least a partial list of retailer locations before it will function. Retailer locations may be obtained by crawling, through a third party data feed (e.g. CSV or XML), or through a manual entry screen. The content source manager determines and initiates the appropriate method when a new content source is constructed.

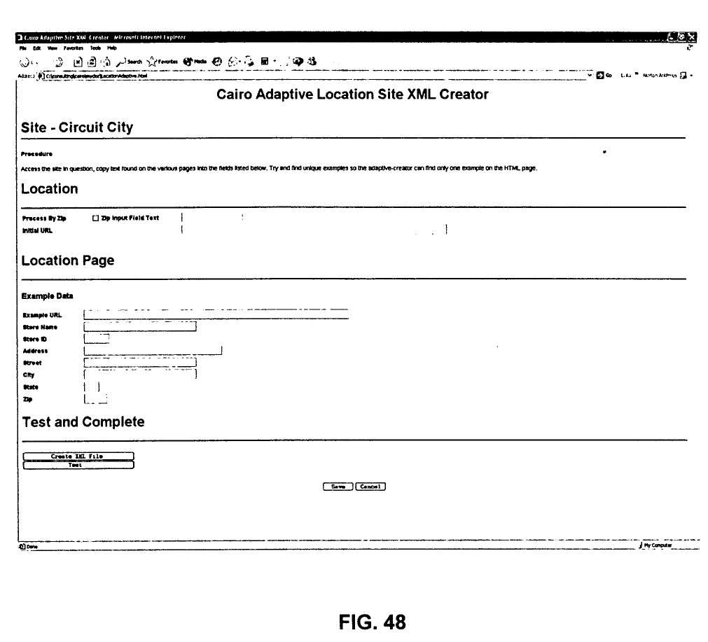

The adaptive-crawler (illustrated in FIG. 48) uses the same techniques for extracting store locations as with ad items. It also uses the same technique to create the site XML configuration file through example screens.

Many retailers' websites require a starting zip code before a list of locations are made available to the user. A list of starting zip codes is obtained from the Cairo Ad Zone utility. Cairo ad zones are created and maintained based upon by a third party data source which maps zip codes to Designated Marketing Areas (DMAs) representing every media market in the United States.

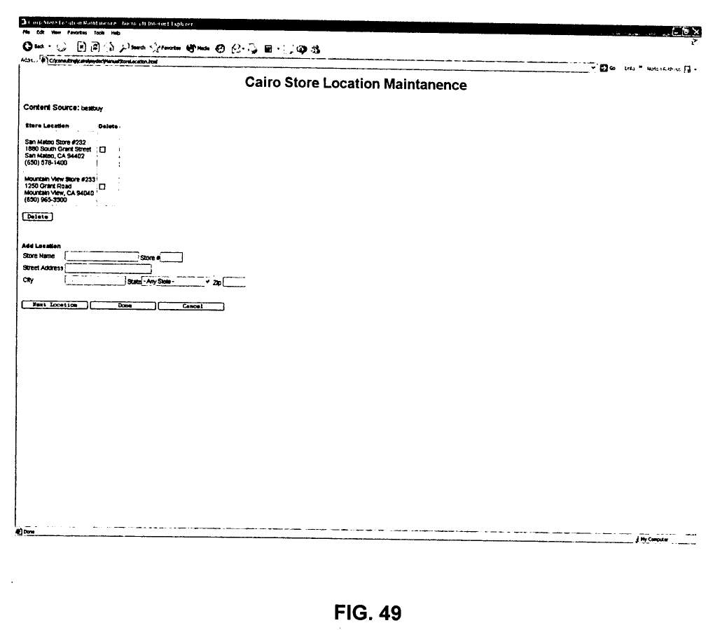

After testing and running the retail location crawl, the operator uses the manual maintenance screen (FIG. 49) to review results and determine if the adaptive crawler successfully crawled the site.

Occasionally, a retailer's website does not provide easy access to store location information. It may not be possible to adaptively crawl for location content. Furthermore, for some regional store chains (e.g. AmericanTV in the Midwest), the small number of store locations may make it easier to add create those retailer locations manually. Therefore, the Content Management application provides a screen (FIG. 49) to manually create retailer location content. This is a basic screen allowing the Content Source Manager to add or delete from a list of retailer locations (and is also used to review the results of crawled location data).

It is also possible to purchase Retailer Location databases from third party providers (such as Trade Dimensions which is part of AC Neilsen). Data is typically provided either annually or on a monthly basis, capturing any new store openings, closings, or changes of control during that period. The data is available in a number of acceptable file formats, including CSV.

Retailer location data is likely priced by store location. It may therefore actually be most cost effective to crawl for content from large retailers (with many store locations) and purchase store location content for mid-size and smaller retailers (with smaller numbers of locations).

Activating a Content Source

Once the Content Source Manager is satisfied with the configuration and testing of the content source setup, he selects the “Activate Source” button on the Source Creation screen (FIG. 42) to enable the content source for scheduled processing. It should be noted that a Source Maintenance screen (not shown) is almost identical to the Source Creation screen, however it also has a “Disable Source” button for disabling the source from scheduled processing, to allow reconfiguration and further testing.

Operator Maintenance

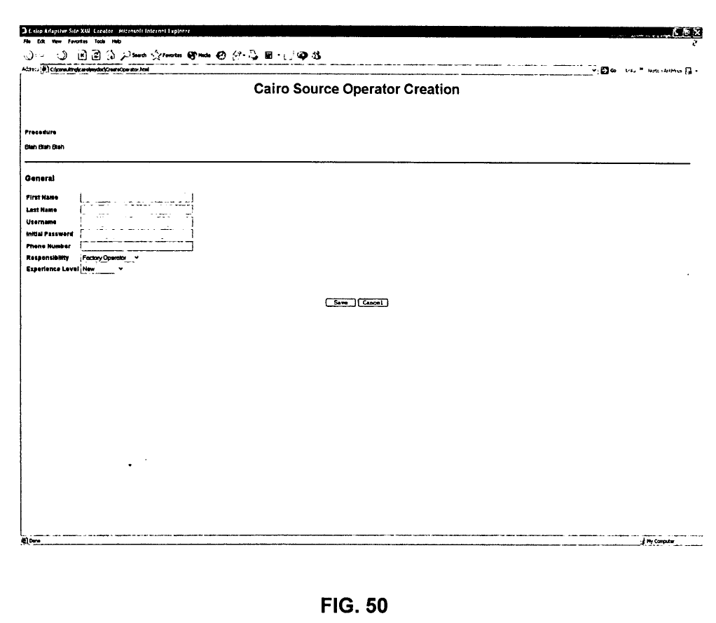

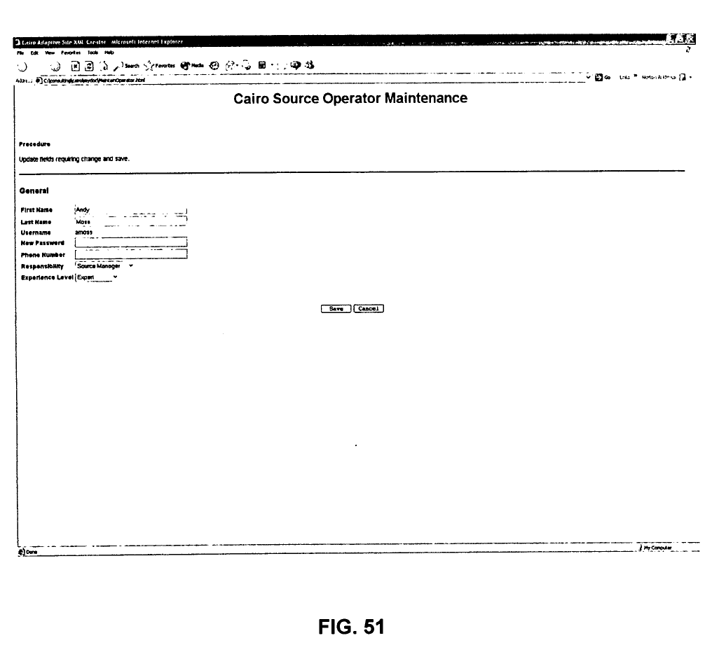

The Content Source Manager is also responsible for creating user accounts for content factory staff. This is done through a simple screen to initialize the accounts as shown in FIG. 50. The Content Source Manager may also maintain an existing operator with the screen of FIG. 51. Both of these screens are accessible from the main Content Source Management screen.

The Content Extraction Process

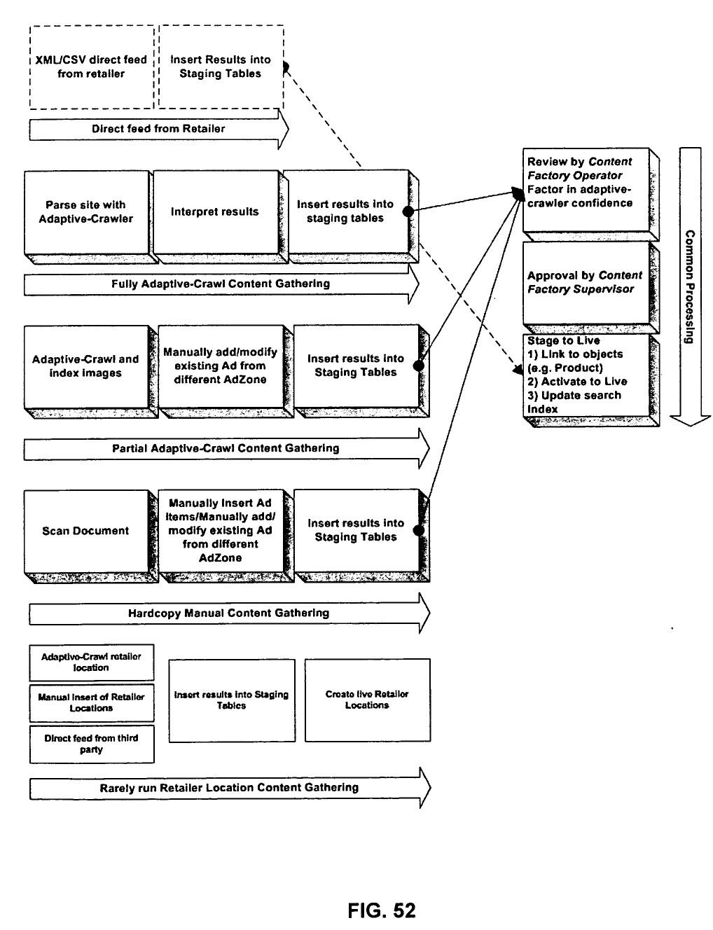

Once a content source is properly configured, a periodic process is performed to regularly gather content for that retailer and ultimately construct live records for release to the Cairo production database. The detailed flow of this process is illustrated in the flow diagram of FIG. 52.

The diagram lists the approaches in order of preference from most desirable to least desirable from the perspective of which approach will yield the best, cheapest, and most accurate data. Obviously, a direct feed from the retailer would result in the best solution. However, at this time it is unlikely a business arrangement can be made to make this a feasible solution.

In absence of retailer feeds, a process to adaptively crawl the retailer's websites can be made to effectively gather content. This process either crawls for all of the required ad content for review by a Content Factory Operator or can be configured to crawl for partial ad content to be manually completed by the Content Factory Operator.

The most undesirable option is to scan from printed ad images and have the Content Factory Operator manually insert all of the associated data elements. This would likely be an expensive proposition but evidence suggests it is only necessary for a few retailers.

Gathering location information is also required to initiate ad extraction. Therefore, a process is implemented with the same flexibility as ad content extraction. For most sites, the adaptive crawler is configured to extract and create location objects.

The direct feed method of content extraction uses data feeds generated by retailers in the form of a CSV or XML file. This method is preferable because there is no review required, all data is presented and the confidence is 100%. It would also be the best performing method. However, full design of this method would require extensive interaction and cooperation from each retailer.

The fully adaptive-crawl method is used for websites that properly enumerate all ad items in a readable text format displayed with each of the ad pages. This method is used for retailer sites that have all required data elements available for each ad item. Generally, the adaptive crawler begins with a list of zip codes obtained from the list of store locations for a given of retailer. Each zip code used is simply the zip code of a given store location. The crawler accesses the retailer's online ad circular for each zip code in the list and HTTP POSTs this zip code to the retailer's website. As a result, the current ad for a given region is returned to the adaptive crawler. Of course, the adaptive crawler also works with websites that do not require entering a zip code to display the ad page (e.g. where they have national ads).

Next, it parses each ad page interpreting the data as specified in the Site XML configuration file described elsewhere herein. Once the data elements are segregated, the adaptive crawler further parses the data elements and inserts them into staging tables. If a particular ad item does not have all the required data (e.g. price, model number, title, ad image), it is marked with a low confidence for further review. However, it is assumed relatively few ad items will require manual review by a Content Factory Operator. In fact, for many sites it may be deemed unnecessary and any ad item that does not fulfill acceptable confidence requirements may simply be automatically deactivated.

Each data element has a predefined confidence weight. Many elements have no negative weight associated with them while others, such as price, have a relatively high numbers associated with them. During the data element parsing stage, if unsatisfactory data formats are extracted (e.g. the price is not a number or is blank), the confidence number is decremented with the predefined confidence weight. As a result, the total confidence is established and recorded in the staging table. Experimentation may be required to refine appropriate values for each data element.

For those retailer sites that contain difficult and somewhat problematic HTML structures, manual review is likely required and must take place before the ad items are released to production.

The first step in processing an ad page is to extract the image and/or image URL. The image is compared to the ones already downloaded from the previous zip codes. Likewise, it is compared with the previous periods ads (e.g. last weeks) downloaded from that retailer. If the image is the same, the data are not duplicated. While parsing the page and duplicating the data is a little wasteful, saving those steps is not the motivation for doing this. The real motivation comes from eliminating any subsequent manual steps. Therefore, if an ad item requires review and modification, only one zip code's ad will require the work and the other zip codes containing the same page automatically benefit.

Generally, the same ad image will result in the same URL. Therefore, comparing images is as simple as comparing the URLs. However, this does not work in all cases, so the CRC for the image is also compared to locate additional possible duplicates and a full memory compare of the image can be executed if required.

Creating a thumbnail image of each ad page is part of the processing for staging an ad. Free image reduction software can be obtained on the web. Furthermore, the URL for the given ad and the URL for a given ad page are recorded and staged by the adaptive crawler. This is useful for both the user UI as well as for manual review steps within the content factory.

For those sites that enumerate the ad items but do not contain ad images, a blank image is referenced. However, a more complicated ad comparison is utilized to compare all ad items.

The partial adaptive-crawl method is used for websites that do not contain all ad item data elements enumerated in HTML even though the site does contain at least the images of the online ad circular.

This is processed in the same way as the full adaptive-crawl, but leaves some or all of the data elements blank. As with the full adaptive-crawl, the images, thumbnails, and all available ad item elements are interpreted, staged and scheduled for review. Sometimes a partial adaptive-crawl source is one that contains all the ad items enumerated with all appropriate data elements except for the price. The manual review process must fill in this price which is typically available by looking at the image. As with the fully adaptive-crawl, the ad images are compared to weed out those ads that are not unique.

After all the content that can be automatically extracted is staged, an event is queued on Content Factory Operator's task list. This task specifies that they have a new set of ads and ad items that require manual completion. Screens displaying the ad image and allowing manual entry of the ad item data elements are presented to the operator. The manually entered data may also be staged and subject to review depending on the experience level of the user.

The data elements that can be located on the website are staged and pre-populate the manual entry screens. Any required fields that cannot be extracted are highlighted to alert the operator to the minimum fields they must enter. In some cases, this field may be pre-populated with a questionable value as a default for the operator. For example, the online price and the ad price is often the same. Therefore, the online price may be pre-populated and flagged as questionable.

The hardcopy manual entry method is for those retailers that do not publish their ad circulars online. Therefore, each ad circular must be scanned and a manual entry system to input the ad items is required. Unfortunately, two pictures scanned separately will not result in images that can be automatically compared. In other words, the same picture scanned twice will not produce two JPG files that are identical. Therefore, it is assumed the operator, that does the scanning, will first need to do determine which ad zones contain unique ads (and ad images). In practice, it is likely many or all ad zones have the same ad circular, but if not the case, the implementation will allow for manual entry of hardcopy ad circulars that are unique for different ad zones.

From examples found on existing sites, if an ad circular page is different, the entire content is different. Therefore, at this time there is no screen that implements a pre-populated manual entry screen with the ability to change a small subset of ad items and/or data elements (e.g. price). However, such embodiments are contemplated. Furthermore, it is believed such a method of input is prone to error due to the likely occurrence of a human operator to miss the ads' subtle differences (e.g. a price change). All ad pages that are not identical will start from a blank manual entry screen and must be keyed from scratch.

Operator Work Flow and Queues

There are two types of content factory users, Content Factory Operators and Content Factory Supervisors. Each Content Factory Operator is responsible for a set of content sources, either manually entering data for each content source or reviewing the results of the adaptive crawler. The Content Factory Supervisor is responsible for reviewing and approving all content sources ready for activation.

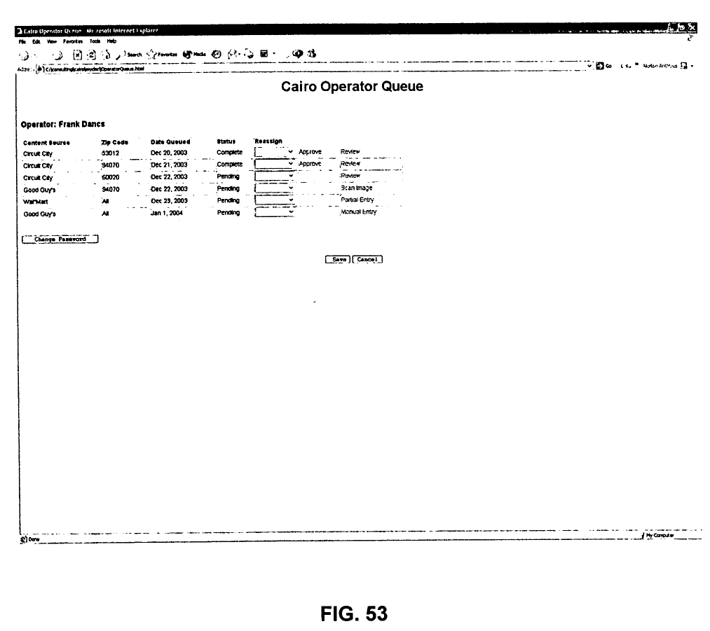

Each starts with the operator's queue (e.g., see FIG. 53). Note: for manually capturing print only ads, two steps are required and both are queued. The first step that is queued is the scan image step. This step requires the operator to associate the scanned image with a given ad zone and queue it up for the second step of manual entry of data elements.

The operator queue maintains the list of tasks for a given operator and is initially sorted by the date it was added to the queue. Each operator is responsible for monitoring their own queue and reviewing and/or manually completing the details for each content source that is listed. Depending on the type of extraction method used for the given content source, the Content Factory Operator is shown one of the following screens to review and/or insert the ad items.

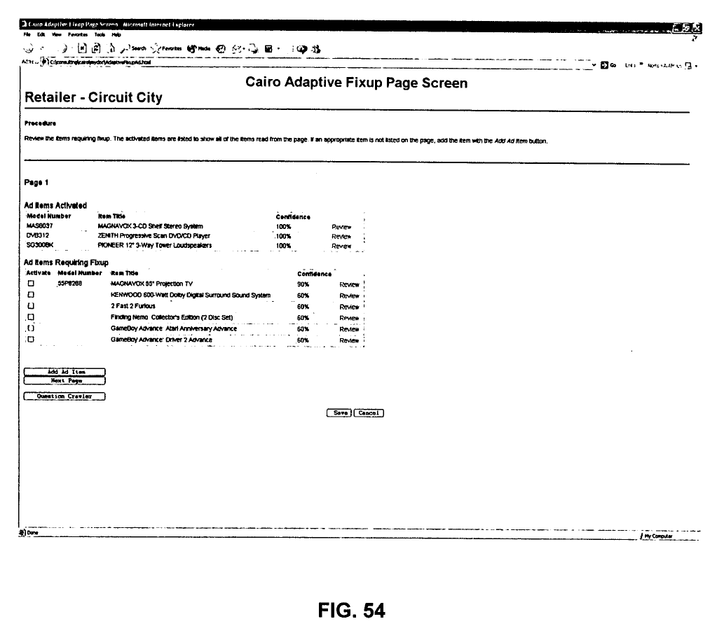

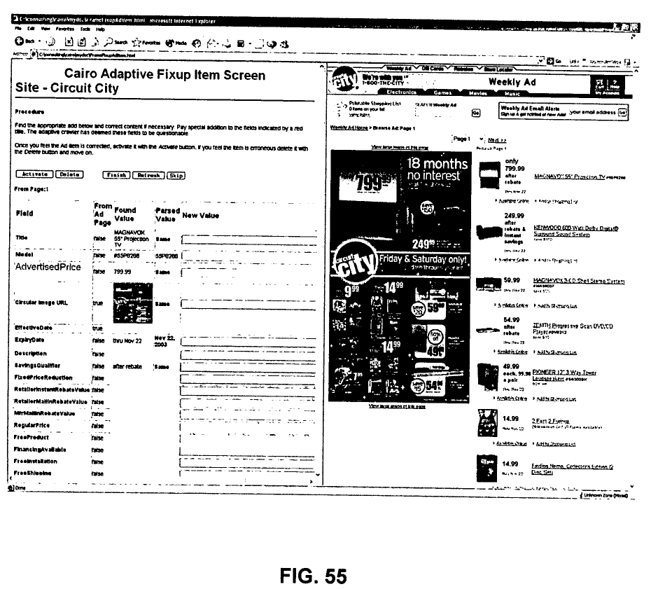

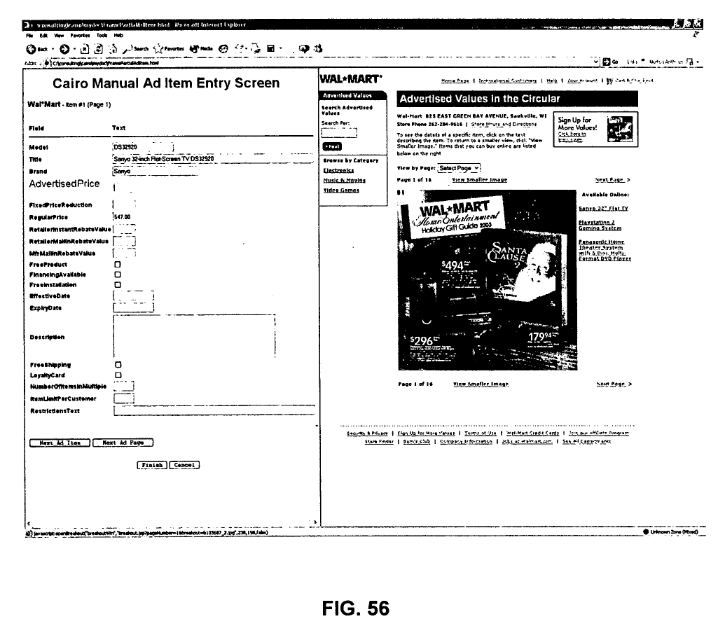

FIGS. 54 and 55 illustrate ad page and ad item “fix up” screens for the adaptive crawl extraction method. FIG. 56 illustrates a manual completion screen for the partial adaptive crawl extraction method.

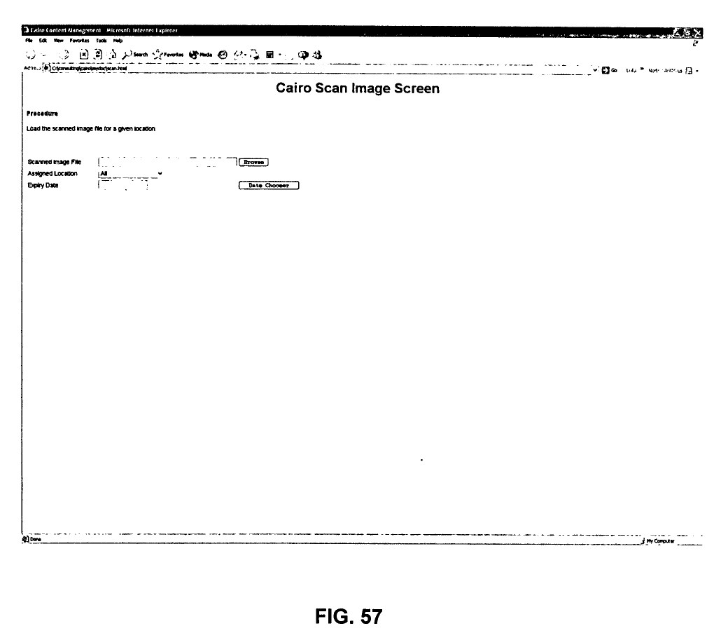

For content sources which depend upon the scanning of print only ads, an operator must physically scan the images using a scanner and the file must be associated with a list of retailer locations (e.g., see FIG. 57). For national ads, they choose the All option.

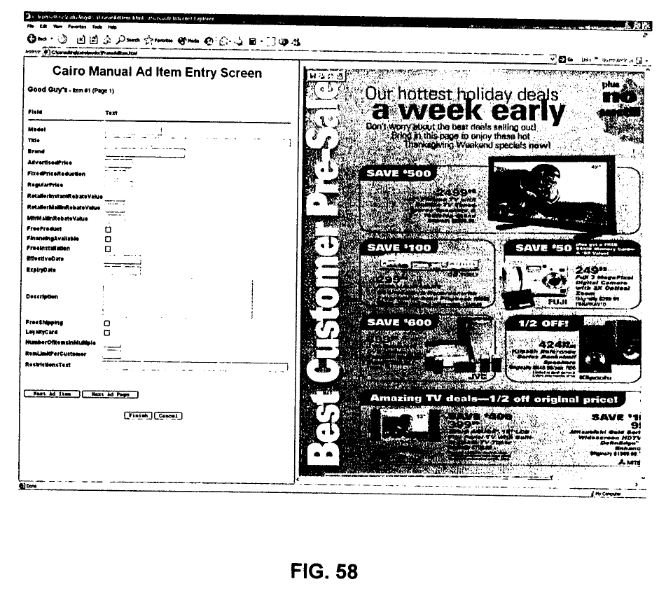

The manual ad entry screen (e.g., FIG. 58) displays the scanned image side by side with the data elements that must be captured. For many operators the actual hardcopy of the ad may also be available and easier to read than the scanned image. However, it is also possible that images are scanned in the United States prior to transfer to an “offshore” content factory for manual entry.

Review, Approval, and Release to Production

The overall confidence of the ad is determined by assessing the individual ad item confidence levels and taking into account the skill level of the Content Factory Operator in the case of ads requiring some degree of manual entry. If the cumulative confidence level requires review, the staged ad is placed on a queue of the Content Factory Supervisor to QA. The Content Factory Supervisor reviews and approves the ad for activation.

Once the ad is approved, it is ready for activation. Activation is the processes of creating Ad, AdPage, and AdItem objects from equivalent staged objects. This includes looking up the proper product object given the model number, etc. With the Ad, AdPages and AdItems created, the id's for each of these objects are updated into the liveId field of the corresponding staged object. According to some embodiments, a mechanism is provided to deactivate live objects if an error is discovered after the objects have gone live.

When all the live objects have been created, the search index is updated. At this point the ad is completely searchable by Cairo users on the public website.

The schema for the staged tables is separated from the live schema. In other words, it resides in a different database user account. When higher scalability is required, this account is moved to a separate database.

If the staged tables are never cleaned, they will grow endlessly. Therefore, after the staged to live process has completed, that same process removes the previous but one staged ad. The two most recent copies of the staged items are always kept for future use. Some ads may not change dramatically and therefore can still be used for the next circular from the same retailer.

The Adaptive Crawler

Content Extraction

The adaptive-crawler uses a site specific XML configuration file created for each retailer to perform two general tasks.
Ad content extraction
Retailer location extraction

Each of these tasks is performed using the same techniques but are separated in the configuration file with the <ad> and <location> tag elements.

The adaptive-crawler is designed with the assumption that most retailers' websites use some sort of definable HTML expressions. The web pages designed for ad circulars and store location data are regular and repeatable. In other words, the format of the HTML does not change very often. Furthermore, the type of HTML expression used is typically in a form that makes identifying a particular data element possible. For example, style sheets are often used to display a particular data element in a consistent manner. A price might be displayed utilizing a style sheet in the follow manner.
<SPAN class=popprice>299.99</SPAN>

Going with the assumption that most websites utilize this kind of identifiable HTML, the adaptive crawler is designed to locate well known HTML expressions to extract content pieces.

Given this type of an example, the adaptive crawler simply looks for the SPAN HTML elements with ‘popprice’ as the value of the CLASS attribute. Of course, this is a little more complicated than that. The adaptive crawler must group the pieces of content (i.e. price, title, model number, etc) into one logical ad item. To do this it must traverse the HTML document to locate what constitutes an ad item instead of simply doing a full scan of the document looking for ‘popprice’.

Typically, an ad item takes the form of:

```
<table>
  <tr>
    <table>
      <tr><td><span class=”popprice”>299.99</span></td>
          <td><span class=”poptitle”>42” Sony HDTV</span></td>
      <tr><td>This TV is the clearest ... Model: KRG456</td>
```

Therefore, adaptive crawler is designed to traverse the HTML hierarchy searching for <table>, <tr>, <table> in order to find what constitutes an ad item. The adaptive crawler defines a XML language that is used to traverse the HTML document. The XML tags available are defined in the sites.dtd file listed below.

At the root of site XML configuration file is the <site> tag. It simply names the content source defined in the file and initializes the implementation class used for ad zone inputs as well as extraction outputs. This class must implement the cairo.adaptive.Site interface, which supplies implementations for the cairo.adaptive.Ad, cairo.adaptive.AdPage, and cairo.adaptive.AdItem interfaces.

Two tags used to schedule the two possible extraction methods are available. They are referred to as schedulers.
<location>
<ad>

The <location> tag defines the way the retailer locations are extracted. It is independently scheduled and specifies a starting URL using the available attributes (see sites.dtd).

The <ad> tag defines the way an ad is extracted. It is also independently scheduled and specifies a starting URL. Both utilize the same set of tags to achieve their extraction capabilities.

Tags are defined to control the flow of processing. For example, the <repeat> element is used to loop for all available responses. This is used to control the flow of zip codes POSTed to the website.
<repeat>—loops for each possible input obtained from the cairo.adaptive.Site.getResponses( )

The Locators are used to traverse the hierarchy. For example, the <search> element is used to traverse the hierarchy to find a particular tag. <tag> is used to find a tag within the current hierarchical level.
<tag>—tests if the HTML tag at the current hierarchy is the element defined with this tag and executes any executor grouped within this tag.
<method>—tests if the HTML tag at the current hierarchy is a method with the name defined in the <method> element and executes any executor grouped within this tag.
<search>—search throughout the HTML tag hierarchy for the given tag defined in the <search> tag and executes any executor grouped within this tag.

The Executors are used to perform a task once the proper HTML element is found. For example, the <adfield> stores a particular ad item data element and the <link> element traverses an href and executes a new page.
<response>—responds to the input HTML tag.
<link>—follows a HREF link with the page defined in the <link> tag.
<aditem>—groups all executors within it as one ad item.
<adfield>—records the data element as the one defined by the tag.
<next>—follows a next link to repeat processing.
<process>—processes the rest of a HTML document using a page declaration. This is similar to the link tag but doesn't follow a HREF. Typically this used for debugging.

Pages are a way of grouping locators. Some of them define what constitutes an ad page while others define what constitutes a new HTML document.
<page>—groups tags defined to execute a new HTML document. For example, this tag must be used if a link must be followed to obtain an ad item element.
<adpage>—groups tags to define an ad page.
<locationpage>—groups tags to define a location page.
<taggroup>—simply groups tags into a named component.
   Example Site XML Configuration File

Listed below is an example of a site XML configuration file. It is defined for the www.circuitcity.com website. There are several issues with this example.
The address page on the website, in this example, does not contain the zip code. In this case the implementer of cairo.adaptive.Location must obtain the zip code from the address. This can be done by using a third-party map service.
There is another way to get the location. However, at this time the adaptive-crawler does not have the capability to parse those locations (see Issues section).
The description section has not been completed.

Using the following snippet from the example, the overall philosophy of the location ability can be demonstrated. First, the <search> tag traverses the entire HTML document looking for HTML “table” tags with a class attribute with a value of “poptable”. For those HTML tags satisfying that tag, all <tr> tags are processed. Each one executes the <aditem> tag which groups children of the <tr> tag as part of the same ad item.

```
<search type=“table” attribute=“class” value=“poptable”>
      <tag type=“tr” forall=“true”>
        <aditem group=“aditem”/>
      </tag>
</search>
circuitcity.xml
<!DOCTYPE site SYSTEM “../dtd/sites.dtd”>
<site name=“circuitcity” context=“cairo.site.Zip”>
  <location period=“manual”>
    <repeat href=
“http://weeklyad.circuitcity.com/circuitcity/
store_location_zip_entry.asp?
StoreID=2397411”>
      <search type=“form” attribute=“id” value=“zipform”>
        <response name=“CityStateZip” page=“location”/>
      </search>
    </repeat>
  </location>
  <locationpage name=“location”>
    <search type=“td”/>
      <tag type=“span” attribute=“class”>
        <adfield value=“storeheader2” field=“Name”/>
        <adfield value=“defaultfont” field=“Address”/>
      </tag>
    </search>
  </locationpage>
  <ad period=“weekly”>
    <repeat
href=“http://weeklyad.circuitcity.com/circuitcity/new_user_entry.asp”>
      <!-- zip processing -->
      <search type=“form” attribute=“id” value=“zipform”>
        <response name=“CityStateZip” page=“firstpage”/>
      </search>
    </repeat>
  </ad>
  <page name=“firstpage”>
    <search type=“a” contains=“Browse This Circular”>
      <link page=“adpage”/>
    </search>
  </page>
  <adpage name=“adpage”>
      !-- traverse the next link -->
    <search type=“a” contains=“Next”>
      <next page=“adpage”/>
    </search>
    <search type=“div” attribute=“class” value=“circularpage”>
      <tag type=“div”>
        <tag type=“img”>
          <adfield attribute=“href” field=“Image”/>
        </tag>
      </tag>
    </search>
    <search type=“table” attribute=“class” value=“poptable”>
      <tag type=“tr” forall=“true”>
        <aditem group=“aditem”/>
      </tag>
    </search>
  </adpage>
<!-- This entities
  <taggroup name=“aditem”>
    <tag type=“td”>
      <tag type=“span” attribute=“class”>
        <adfield value=“thumbFinalPrice” field=“AdvertisedPrice”/>
        <adfield value=“thumbDates” findstr=“thru %”
field=“ExpiryDate”/>
      </tag>
    </tag>
    <tag type=“td” attribute=“class” value=“thumbTitle”>
      <tag type=“span” attribute=“class“>
        <adfield value=“thumbSKU” field=“Product”/>
        <adfield value=“thumbDealInfo”>
          <adfield findstr=“%price break”
field=“FixedPriceReduction”/>
          <adfield findstr=“no interest”
field=“FinancingAvailable” result=“true”/>
        </adfield>
        <adfield field=“Title”/>
        <link page=“description”/>
      </tag>
    </taggroup>
    <page name=“description”>
    </page>
  </site>
```

The DTD for Site XML Configuration File
<?xml version=“1.0” encoding=“ISO-8859-1”?>
<!--

Copyright 2003 Cairo Incorporated.

This is the XML DTD definition for the Adaptive crawler. The Adaptive crawler is used to parse and interpret a store's website to extract product content and pricing for ad items. Since it is crucial to extract specific content from the website instead of just indexing somewhat random data the way most crawlers do, the Adaptive crawler must know precise locations of content elements. In fact, to start with, it must identify which ad items constitute weekly ad circular data and which price identifies the price available in the store and not the on-line price.

A site XML is indicated with the site tag;
site—the root of all XML file that defines a site for which this file is designed for.
   For example,
      <site name=“circuitcity” context=“cairo.site.Zip”>defines the file for the circuitcity site.

It is then subdivided into two different uses called controllers. These define the different tasks that can be performed
location—when run this defines how to find the physical locations of of the stores.
ad—when run this processing the ads for a particular week.

This DTD defines a method for traversing the HTML hierarchy of the store websites's HTML document. There are three basic tag elements that are used to locate the proper HTML elements. They are called LOCATORS and are the following;
tag—within the current HTML hierarchy, find all the tags of this type that meet the conditions defined by the TAG attributes.
   For example,
      <tag type=“table” attribute=“class” value=“poptable”>
   would locate
      <table class=“poptable”>
   if the HTML element is at the current level.
search—search is the same as TAG but it recursively traverses the entire HTML hierarchy.
   For example,
      <search type=“table” attribute=“class” value=“poptable”>
   would locate
      <table class=“poptable”>
   if the HTML element falls anywhere beneath the current hierarchical level of the HTML document.
method—Search for a given method within the current HTML element. This is used for popup pages whether the content is within a javascript method.
   For example,
      <method event=“onmouseover” name=“overlib”>
   would locate
      <area shape=“poly”
         onmouseover=“return overlib(‘<TABLE .. >’);”>
   if the method is defined in the found HTML element (i.e. a <tag=“area”..> was already used).

Once the proper HTML element is found, there are five tag elements used to define an action to execute. These so called EXECUTORS are used to define what is to be done with the content once located. They are all used in conjunction with the LOCATORS. The tag must be located before an EXECUTOR can be applied. The tag elements are;
aditem—indicates everything below is considered part of the same aditem.
next—indicates this link is to be used to go to the next page.
adfield—extract the content from the current tag and output in the output file as the content defined by the RESULT attribute.
   For example,
      <adfield value=“poptitle” field=“title”>
   would insert the following table into the output stream
      <td class=“poptitle”>Sony DVD player</tr>
link—follow the link to the next page to parse the HTML document using the PAGE definition.
   For example,
      <link page=“description”>
   would traverse the current HREF and use the page definition to interpret the referenced HTML document.
response—send the website a response for the given FORM definition. This is typically used when entering zip codes for a site.
   For example,
      <response name=“CityStateZip” page=“firstpage”/>
   would respond to the
      <input type=“text” name=“CityStateZip”>
   with the value returned from getNextResponse( ) method implemented by class implementing the cairo.sites.Context interface.
process—process a page. This is typically used for production when following a link is not possible.

There is one tag that is used to control the flow. It is the repeat tag.
repeat—the REPEAT tag is used to tell the adaptive crawler to loop for each value returned by the class defined by the CONTEXT attribute of the site tag. This class implements the cairo.site.Context interface which defines a way to return values. These values define the responses. Typically this would be zip codes.
   For example,
      <repeat href=“http://weeklyad.circuitcity.com/circuitcity/new user_entry.asp”>
   access the URL until the stop method return true as implemented using the cairo.site.Context interface.

There are three ways of grouping tag definitions. They are called groups.
locationpage—indicates everything under this tag is part of an location.
adpage—indicates everything under this tag is part of an ad page.
taggroup—a simple way of grouping tags together. Often used in conjunction with an aditem.
page—defines the entire HTML page.

For example,

```
          <page name=“adpage”>
              <tag type=“table” attribute=“class”
value=“poptable”>
                  <tag type=“tr” aditem=“true”>
                    <tag type=“td”>
            . . . .
```

would start at the root of the HTML document and locate the tags using the defined locators.

An example XML file is listed below;

The general idea is to define the HTML path to the given content. In this example, the content is located in HTML such as

```
  <TABLE class=poptable>
  <TD align=left width=“20%”>
    <SPAN class=thumbFinalPrice>2799.99</SPAN>
  </TD>
  <TD class=thumbTitle width=“60%”>
    <A href=“http://weeklyad.circuitcity.com/circuitcity/buy_online.asp?
\
        ListingID=−2098458455&amp;ProductCode=http%3A%2F%2Fwww%2E \
        circuitcity%2Ecom%2Finit%2Ejsp%3FKey%3D85%26oid%3D77746&amp;\
        redirect=http%3A%2F%2Fwww%2Ecircuitcity%2Ecom%2Finit%2Ejsp% \
        3FKey%3D85%26oid%3D77746” target=_top>
      SONY 42″ Grand Wega high-definition TV monitor</A>
    <SPAN class=thumbSKU>#KF42WE610</SPAN>
    <SPAN class=thumbDealInfo>
      <BR>save $100, no interest** &amp; no payments</SPAN>
  </TD>
  </TR>
```

The page section of XML file to crawl this site would look something like;

```
<adpage name=“adpage”>
    <!-- traverse the next link -->
  <search type=“a” contains=“Next”>
    <next page=“adpage”/>
  </search>
  <search type=“div” attribute=“class” value=“circularpage”>
    <tag type=“div”>
      <tag type=“img”>
        <adfield attribute=“href” field=“Image”/>
      </tag>
    </tag>
  </search>
  <search type=“table” attribute=“class” value=“poptable”>
    <tag type=“tr” forall=“true”>
      <aditem group=“aditem”/>
    </tag>
  </search>
</adpage>
<taggroup name=“aditem”>
  <tag type=“td”>
    <tag type=“span” attribute=“class”>
      <adfield value=“thumbFinalPrice” field=“AdvertisedPrice”/>
    </tag>
  </tag>
    <tag type=“td” attribute=“class” value=“thumbTitle”>
    <tag type=“a”>
      <adfield field=“Title”/>
    </tag>
      <tag type=“span” attribute=“class”>
        <adfield value=“thumbSKU” field=“Product”/>
        <adfield value=“thumbDealInfo”>
          <adfield findstr=“save %,” field=“FixedPriceReduction”/>
          <adfield findstr=“no interest”
field=“FinancingAvailable”
              result=“true”/>
        </adfield>
      </tag>
      <link page=“description”/>
    </tag>
  </taggroup>
  <page name=“description”>
  </page>
-->
<!ENTITY true “true”>
<!ENTITY false “false”>
<!ENTITY % boolean “(true | false)”>
<!--
```

These entities define the list of fields that are available to an ADFIELD definition. A field is the predefined content that the tool is looking for.
-->
<!ENTITY AdPageNumber “AdPageNumber”>
<!ENTITY Product “Product”>
<!ENTITY Title “Title”>
<!ENTITY Description “Description”>
<!ENTITY EffectiveDate “EffectiveDate”>
<!ENTITY ExpiryDate “ExpiryDate”>
<!ENTITY AdvertisedPrice “AdvertisedPrice”>
<!ENTITY FixedPriceReduction “FixedPriceReduction”>
<!ENTITY RetailerInstantRebateValue “RetailerInstantRebateValue”>
<!ENTITY RetailerMailInRebateValue “RetailerMailInRebateValue”>
<!ENTITY MfrMailInRebateValue “MfrMailInRebateValue”>
<!ENTITY RegularPrice “RegularPrice”>
<!ENTITY FreeProduct “FreeProduct”>
<!ENTITY FinancingAvailable “FinancingAvailable”>
<!ENTITY FreeInstallation “FreeInstallation”>
<!ENTITY FreeShipping “FreeShipping”>
<!ENTITY LoyaltyCard “LoyaltyCard”>
<!ENTITY NumberofItemsInMultiple “NumberofItemsInMultiple”>
<!ENTITY ItemLimitPerCustomer “ItemLimitPerCustomer”>
<!ENTITY RestrictionsText “RestrictionsText”>
<!ENTITY Image “Image”>
<!ENTITY Thumbnail “Thumbnail”>
<!ENTITY BarCode “BarCode”>
<!ENTITY URL “URL”>
   are used for locations -->
<!ENTITY Street “Street”>
<!ENTITY City “City”>
<!ENTITY State “State”>
<!ENTITY Zip “Zip”>
<!ENTITY Address “Address”>
<!ENTITY PhoneNumber “PhoneNumber”>
<!ENTITY StoreHours “StoreHours”>
<!ENTITY StoreId “StoreId”>
<!ENTITY % fields
   “(AdPageNumber |
      Product |
      Title |
      Description |
      EffectiveDate |
      ExpiryDate |
      AdvertisedPrice |
      FixedPriceReduction |
      RetailerInstantRebateValue |
      RetailerMailInRebateValue |
      MfrMailInRebateValue |
      RegularPrice |
      FreeProduct |
      FinancingAvailable |
      FreeInstallation |
      FreeShipping |
      LoyaltyCard |
      NumberOfItemsInMultiple |
      ItemLimitPerCustomer |
      RestrictionsText |
      Image |
      Thumbnail |
      BarCode |
      URL
      Street |
      City |
      State |
      Zip |
      PhoneNumber |
      StoreHours |
      StoreId |
      Address |
      Name
      )”>
<!-- These entities define the list of TAG and SEARCH types available. -->
<!ENTITY map “map”
<!ENTITY area “area”>
<!ENTITY span “span”>
<!ENTITY table “table”>
<!ENTITY td “td”>
<!ENTITY tr “tr”>
<!ENTITY script “script”>
<!ENTITY img “img”>
<!ENTITY form “form”>
<!ENTITY input “input”>
<!ENTITY a “a”>
<!ENTITY div “div”>
<!ENTITY html “html”>
<!ENTITY % tagtypes “(map | area | span | table | td | tr | script | img | form | input | a | div | html)”>
<!-- SEARCH and TAG share these attributes. -->
<!ENTITY % tagattr
   “type %tagtypes; #REQUIRED
   attribute CDATA #IMPLIED
   value CDATA #IMPLIED
   contains CDATA #IMPLIED
   exact CDATA #IMPLIED
   forall CDATA #IMPLIED”
>
<!-- The ADFIELD has the following attributes.
field—Defines what type of content this aditem is defined for Taken from the list defined by the entity FIELDS.

value—The value of an attribute if applicable. This is used in conjunction with a TAG element as in the following example.

```
site.html
  <span class=“popdeal”>$100</span>
site.xml
  <tag name=“span” attribute=“class”>
    <aditem name=“popdeal” field=“advertisedPrice”>
```

findstr—Used if a string is to be located in the result (i.e. This product . . . Model: xxxbx)

For example,

```
          site.html
            <span class=“popdesc”>
                This product does xyx Model: K67X24
            </span>
          site.xml
              <aditem name=“popdesc” findstr=“Model:%”
field=“model”/>
```

If description was also needed then the proper site.xml might look like,

```
site.xml
    <aditem name=“popdesc”>
      <aditem findstr=“%Model:” field=“description”/>
      <aditem findstr=“Model:%” field=“model”/>
    </aditem>
```

attribute—Instead of taking the content from the string portion of the HTML element, the content is taken from a particular attribute.
required—Set to True if this field is required. If a required field is not included, the item is set to require fixup.

result—If actual result printed to the output file should be substituted by this value if the content is found. This is typically used with findstr.

| --> | | |
|---|---|---|
| <!ENTITY % adattr | | |
| “field | %fields; | #IMPLIED |
| findstr | CDATA | #IMPLIED |
| value | CDATA | #IMPLIED |
| attribute | CDATA | #IMPLIED |
| result | CDATA | #IMPLIED |
| required | %boolean; | #IMPLIED” |

>
<!ENTITY manual “manual”>
<!ENTITY daily “daily”>
<!ENTITY weekly “weekly”>
<!ENTITY yearly “yearly”>
<!ENTITY % periods “(manual | daily | weekly | yearly)”>
<!ENTITY % controlAttr “period %periods; #REQUIRED”>
<!ENTITY % executors “(response | link | aditem | adfield | next |
process)”>
<!ENTITY % locators “(tag | method | search)”>
<!ENTITY % controlerElements “(repeat)”>
<!ENTITY % tagElements “(%locators;?, %executors;?)”>
<!ENTITY % schedulers “(%location;?, %ad;?)”>
<!-- ============================ The CONTROLLERS
============================ -->
<!--

The site element is the root of the configuration file for a website.

```
-->
<!ELEMENT site (schedulers, (locationpage?, page?, adpage?,
taggroup?)*)>
    <!-- the name of the website -->
<!ATTLIST site name CDATA #REQUIRED>
    <!-- the class for response and output (i.e. “cairo.site.Zip”) -->
<!ATTLIST site class CDATA #REQUIRED>
<!ELEMENT location (%controlerElements;)>
  <!ATTLIST location %controlAttr;>
<!ELEMENT ad (%controlerElements;)>
  <!ATTLIST ad %controlAttr;>
<!ELEMENT page (%locators;)*>
        <!-- name of page -->
    <!ATTLIST page name CDATA #REQUIRED>
<!ELEMENT locationpage (%locators;)*>
        <!-- name of page -->
    <!ATTLIST locationpage name CDATA #REQUIRED>
<!--
```

Everything within an ADPAGE is considered part of one adpage in the output stream.

```
-->
<!ELEMENT adpage (%locators;)*>
    <!-- name of page -->
  <!ATTLIST adpage name CDATA #IMPLIED>
  <!ATTLIST adpage page CDATA #IMPLIED>
<!--
```

The TAGGROUP packages a set of locators into a named group. This makes the XML file look a little neater and can be called from multiple places.

```
-->
<!ELEMENT taggroup (%locators;)*>
      <!-- name of page -->
    <!ATTLIST taggroup name CDATA #REQUIRED>
  <!ELEMENT repeat (tag?, search?, process?)*>
      <!ATTLIST repeat href CDATA #REQUIRED>
<!-- ================= The LOCATORS ================= -->
<!--
```

The tag element is used as the main component to locate expected HTML elements at a given branch in the HTML hierarchy.

For example,

```
    <search type=“table”>
    <tag type=“tr”>
      <tag type=“td”>
-->
<!ELEMENT tag (%tagElements;)*>
  <!ATTLIST tag %tagattr;>
<!--
```

The tag element is used as the main component to search for a given HTML tag recursively throughout the entire document and process each tag found.

-->
<!ELEMENT search (%tagElements;)>
<!ATTLIST search %tagattr;>
<!--

The method element is used to define when a method is to be traversed. With many pages the content is listed within a method call since the javascript is used to define a popup page.

```
-->
<!ELEMENT method (tag?, search?)>
  <!ATTLIST method event CDATA #REQUIRED>
    <!-- What event the method is found on -->
  <!ATTLIST method name CDATA #REQUIRED>
    <!-- The name of the method -->
<!-- ================== The EXECUTORS ==================
-->
<!--
```

Between the <aditem> and </aditem> elements all ADFIELD's are defined for one aditem.

-->
<!ELEMENT aditem (%locators;)*>
<!ATTLIST aditem group CDATA #IMPLIED>
<!--

The adfield element is used to output the found data. This is the last of the qualifiers for finding the appropriate tag and defines which output field the data is used by.

-->
<!ELEMENT adfield (adfield?)*>
<!ATTLIST adfield %adattr;>
<!--

If a next page URL is found register it so the ADPAGE goes to the next page once it's finished processing the current.

```
-->
<!ELEMENT next EMPTY>
  <!ATTLIST next page CDATA #REQUIRED>
<!--
    Used to response to a form tag.
-->
<!ELEMENT response EMPTY>
    <!-- the name of the INPUT field (ie <INPUT type=“text”
name=“CityStateZip” -->
  <!ATTLIST response name CDATA #REQUIRED>
    <!-- the page name to execute once we get a response -->
  <!ATTLIST response page CDATA #REQUIRED>
<!--
```

The link element is used when a link must be followed to get another HTML page.

```
-->
<!ELEMENT link (tag?)>
    <!-- -->
  <!ATTLIST link value CDATA #IMPLIED>
    <!-- if there is text before the link starts -->
  <!ATTLIST link pretext CDATA #IMPLIED>
    <!-- use this page declaration to process the HTML -->
  <!ATTLIST link page CDATA #REQUIRED>
<!--
  The process element process a page. It is similar to link
  except it does the page without traversing to a link.
  This is typically used for debugging.
-->
<!ELEMENT process EMPTY>
    <!-- use this page for processing -->
  <!ATTLIST process page CDATA #REQUIRED>
```

Results of Adaptive Crawling

Specified in the XML file is a class that implements the cairo.adaptive.Site interface. This interface implements overall site control functionality. In particular, it defines the response values for the given site (typically the list of zip codes) and creates implementations for the following four interfaces:
cairo.adaptive.Ad
cairo.adaptive.AdPage
cairo.adaptive.AdItem
cairo.adaptive.Location

These four interfaces define the way the adaptive crawler outputs the found content, performs final cleanup of the content, and stores it in the content staging tables in the database.

However, not all content can be obtained accurately. The adaptive crawler estimates the confidence it has in each ad item gathered. Those items below a certain confidence enter a required review stage before becoming active.

The implementations of these interfaces are responsible for providing sophisticated parsing implementations for each type of value found. For example, many different proper formats are tried to correctly parse a date. Removing extra characters often found in a data element is also expected during this phase.

The implementations are also responsible for ad and ad page duplication checks. Once all automatic cleanup is performed, the results are inserted into the proper staging tables. Experimenting with many different websites is useful to enumerate all the different forms a website might take.

Site.java

package cairo.adaptive;
/**
   * This is the root output interface. There is one object implementing
   * this interface created for each site processed. A site can use the
   * generic implementation or it can use the one specifically designed for
   * a given site.
   *
   * The class implementing this interface is set in the XML file as;
   * <site name=“circuitcity” class=“outputs.Zip”>
   *
   * There is no output method defined in the interface because it's strictly
   * up to the implementation to define the output. The implementation can
   * format the output by insert it directly into the database or output it
   * to a CSV file. The interface is only useful for outputting
   * the values obtained by the adaptive-crawler.
   *
   * There is, however, a method (complete) that is called when the
   * adaptive-crawler finishes the site completely (i.e. finishes
   * all zip codes).
   */
public interface Site
{
   /**
      * Initialize the object implementing the Site interface for the given
      * site crawled.
      */
   public void initialize (String siteName);
   /**
      * Return the responses for a given site. This is typically a list of
      * zip codes but code be something specific to a site. This value
      * is given to the response page of the initial site URL.
      */
   public Vector getResponses ( );
   /**
      * Add an Ad for a given response (i.e. zip code).
      * @param response—the given response.
      * @param—the given response.
      */
   public void addAd (String response, Ad ad);
   /**
      * When the adaptive-crawler finishes the site
      * it calls complete to allow the Site to
      * finish all processing. There is no
      * exception called. If the Site is not
      * able to successfully complete processing,
      * it must store the failure and indicate
      * the adaptive-crawler needs to process this
      * site again.
      */
   public void complete ( );
   */
      * The adaptive-crawler calls parseFailure
      * if it cannot interpret the site's HTML and
      * find values. Typically this occurs if the
      * site has changed.
      */
   public void parseFailure ( );
   /**
      * ioException is called if the site is
      * unreachable due to some kind of IOException.
      * @param ioex—the actual IOException
      */
   public void ioException ( );
   /**
      * unavailable is called when the site
      * returns a page indicating it is under
      * construction and is unavailable.
      */
   public void unavailable ( );
   /**
      * Create an object implement the Ad interface for
      * content output. This can be overridden from the
      * generic implementation to get specific customizations
      * for a given site.
      * @return—an object implement the Ad interface.
      */
   public Ad createAd ( );
   /**
      * Create an object implement the AdPage interface for
      * content output. This can be overridden from the
      * generic implementation to get specific customizations
      * for a given site.
      * @return—an object implement the AdPage interface.
      */
   public AdAdPage createAdPage ( );
   /**
      * Create an object implement the AdItem interface for
      * content output. This can be overridden from the
      * generic implementation to get specific customizations
      * for a given site.
      * @return—an object implement the AdItem interface.
      */
   public AdItem createAdItem ( );
      Ad.java
/**
   * The implementer of the Ad interface accepts the various outputs from the
   * adaptive-crawler for a given response (i.e. zip code). For each response, an
   * object implementing the Ad interface is created and updated with
   * each page of the site.
   *
   */
public interface Ad
{
   /**
      * Set the name for the site being output (i.e. circuitcity).
      * @param value—the name of the site as read from the
      * site XML file.
      */
   public void setSiteName (String value);
   /**
      * Set the initial URL for the site being processed.
      * @param url—the URL.
      */
   public void setSiteURL (String url);
   /**
      Add and AdPage to the list of pages. These
      * pages are ordered. Therefore, the first one
      * is considered page 1, etc.
      */
   public void addAdPage (AdPage adPage);
   /**
      If the site is divided by zip codes, this is the
      * entered zip code.
      * @param zip—the zip code.
   public void setzipCode (String zip);
}
   AdPage.java
package cairo.adaptive;
/**
   * The implementer of the AdPage interface accepts the various outputs
   * for a given ad page. This includes the URL for the circular image
   * which should be fetched by the implementer and stored.
   *
   * Values that apply to the entire page as opposed to an individual
   * items are accepted by the implementer of this interface.
   */
public interface AdPage
{
   /**
      * Add the AdItem to this page.
      * @param adItem—the ad item to add.
      */
   public void addAdItem (AdItemOutput adItem);
   /**
      * Set the URL for the circular image.
      * @param url—the url for the image.
   public void setImageURL (String url);
   /**
      * Set the URL for the circular ad page.
      * @param url—the url for the ad page.
      */
   public void setPageURL (String url);
   /**
      * Set the date the sale takes effect
      * applicable to an entire page.
      * @param name—the found value.
      */
   public void setEffectiveDate (String value);
   /**
      * Set the date the sale expires
      * applicable to an entire page.
      * @param name—the found value.
      */
   public void setExpiryDate (String value);
   /**
      * Set the value of available financing
      * applicable to an entire page.
      * @param name—the found value.
      */
   public void setFinancingAvailable (String value);
   /**
      Set the value of possible free installation
      * applicable to an entire page.
      * This value often looks like “free installation”. The
      * output should be ‘true’
      * @param name—the found value.
      */
   public void setFreeInstallation (String value);
   /**
      * Set the value of possible free shipping
      * applicable to an entire page.
      * This value often looks like “free shipping”. The
      * output should be ‘true’
      * @param name—the found value.
      */
   public void setFreeShipping (String value);
   /**
      * Set the value of the restrictions text
      * applicable to an entire page.
      * @param name—the found value.
      */
   public void setRestrictionsText (String value);
}
   Ad Item.java
/**
   The implementer of the AdItem interface accepts the various outputs from
   the adaptive-crawler and outputs cleaned data. It can use any technique
   to clean the data including looking up values in the database, understanding
   specific details of site colloquialisms, and parsing specific known formats
   (i.e. $ before a price).
   It is expected the default implementation uses the stored phrases to parse the various values.
   The resulting confidence is set by the implementer of AdItem. It is
   accumulated from the fixed number associated with the site along with the
   values obtained. Not all values are expected to be exact. Some of the
   data can be bad. For example, there might be words found in place of the
   price (i.e. “Call for final price”). The confidence should reflect it. In other
   words, there are no failures that can be reported back to the adaptive-crawler.
   It is assumed the adaptive-crawler does the best it can do to read the data
   and the AdItem is responsible for determine how accurate the data is.
   The output from this is not part of the interface. The implementation can
   decide on the format to output the final results (i.e., in the database,
   outputted to a CSV type file). The interface is only useful for outputting
   the values obtained by the adaptive-crawler.
*/
public interface AdItem
{
   /**
      * The AdPage this item belongs to. This is the first value
      * set. It may need the AdPage and the Ad to obtain specific
      * information, such as, site name.
      * @param adPage—the value of the AdPage.
      */
   public void setAdPage (AdPage adpage);
   /**
      Set the model number of the item.
      * @param name—the found value.
      */
   public void setProduct (String value);
   /**
      Set the title of the item.
      * @param name—the found value.
      */
   public void setTitle (String value);
   /**
      Set the description of the item.
      * @param name—the found value.
      */
   public void setDescription (String value);
   /**
      * Set the date the sale takes effect.
      * @param name—the found value.
      */
   public void setEffectiveDate (String value);
   /**
      * Set the date the sale expires.
      * @param name—the found value.
      */
   public void setExpiryDate (String value);
   /**
      * Set the advertised price
      * @param name—the found value.
      */
   public void setAdvertisedPrice (String value);
   /**
      * Set the fixed price reduction. If the value
      * contains a % the fixed price should be calculated.
      * @param name—the found value.
      */
   public void setFixedPriceReduction (String value);
   /**
      * Set the value of the retailers instant rebate.
      * @param name—the found value.
      */
   public void setRetailerInstantRebateValue (String value);
   /**
      * Set the value of the retailers mail in rebate.
      * @param name—the found value.
      */
   public void setRetailerMailInRebateValue (String value);
   /**
      * Set the value of the manufacturer's mail in rebate.
      * @param name—the found value.
      */
   public void setMfrMailInRebateValue (String value);
   /**
      * Set the value of the regular price.
      * @param name—the found value.
      */
   public void setRegularPrice (String value);
   /**
      * Set the value for any free product available.
      * @param name—the found value.
      */
   public void setFreeProduct (String value);
   /**
      * Set the value of available financing.
      * @param name—the found value.
      */
   public void setFinancingAvailable (String value);
   /**
      * Set the value of possible free installation.
      * This value often looks like “free installation”. The
      * output should be ‘true’
      * @param name—the found value.
      */
   public void setFreeInstallation (String value);
   /**
      * Set the value of possible free shipping.
      * This value often looks like “free shipping”. The
      * output should be ‘true’
      * @param name—the found value.
      */
   public void setFreeShipping (String value);
   /**
      * Set the value if a loyalty card is required.
      * @param name—the found value.
      */
   public void setLoyaltyCard (String value);
   /**
      * Set the value of how many items are required to
      * purchase.
      * @param name—the found value.
      */
   public void setNumberOfItemsInMultiple (String value);
   /**
      * Set the value of any per customer limits are enforced.
      * @param name—the found value.
      */
   public void setItemLimitPerCustomer (String value);
   /**
      Set the value of the restrictions text.
      * @param name—the found value.
      */
   public void setRestrictionsText (String value);
   /*
      * The image of the AdItem. This is not
      * the circular image.
         * @param name—the found value.
      */
   public void setImage (String value);
   /*
      * Set the value for the bar code.
         * @param name—the found value.
      */
   public void setBarCode (String value);
   /*
      * The URL of the AdItem
         * @param value—the ad item URL.
      */
   public void setItemURL (String value);
}
   Location.java
package cairo.adaptive;
/**
   * The implementer of the Location interface accepts the various outputs
   * from the * adaptive-crawler for a given location.
   */
public interface Location
{
   /**
      * Set the street value
      * @param street—the Street value.
      */
   public void setStreet (String street);
   /**
      * Set the city value
      * @param city—the city value.
      */
   public void setcity (String city);
   /**
      * Set the State value
      * @param state—the State value.
      */
   public void setState (String state);
   /**
      * Set the Zip value
      * @param zip—the Zip value.
      */
   public void setzip (String zip);
   /**
      * Set the PhoneNumber value
      * @param number—the phone number value.
      */
   public void setPhoneNumber (String number);
   /**
      * Set the StoreId value
      * @param storeId—the store id value.
      */
   public void setStoreId (String storeId);
   /**
      * Set the StoreHours value
      * @param hours—the store hours value.
      */
   public void setStoreHours (String hours);
   /**
      * Set the Address value. This is used when the entire
      * address is given as one string. It is up to the
      * implementer to deconstruct the address into
      * individual components.
      * @param address—the address value.
      */
   public void setAddress (String address);
}
   Duplicate Ad Images

When the adaptive crawler accesses the online ad circular on a retailer's website, it first determines whether the ad is a duplicate of an existing ad from another ad zone. It does this by comparing the ad images. Comparing an ad image is often as simple as comparing the URL, as most websites reference the same URL for identical images. In addition, the ad images themselves are compared using CRC and other techniques. This all takes place page by page to determine if one or more of the ad pages are the same, even if the entire ad is not identical.

As noted in a previous section, staged ads are retained until the newest ad is activated. This may be necessary to determine if the newest ad is simply a duplicate of a previous ad. If duplicate images are found, these items are not registered for review. The previous ad is used.

Content Management Object Model

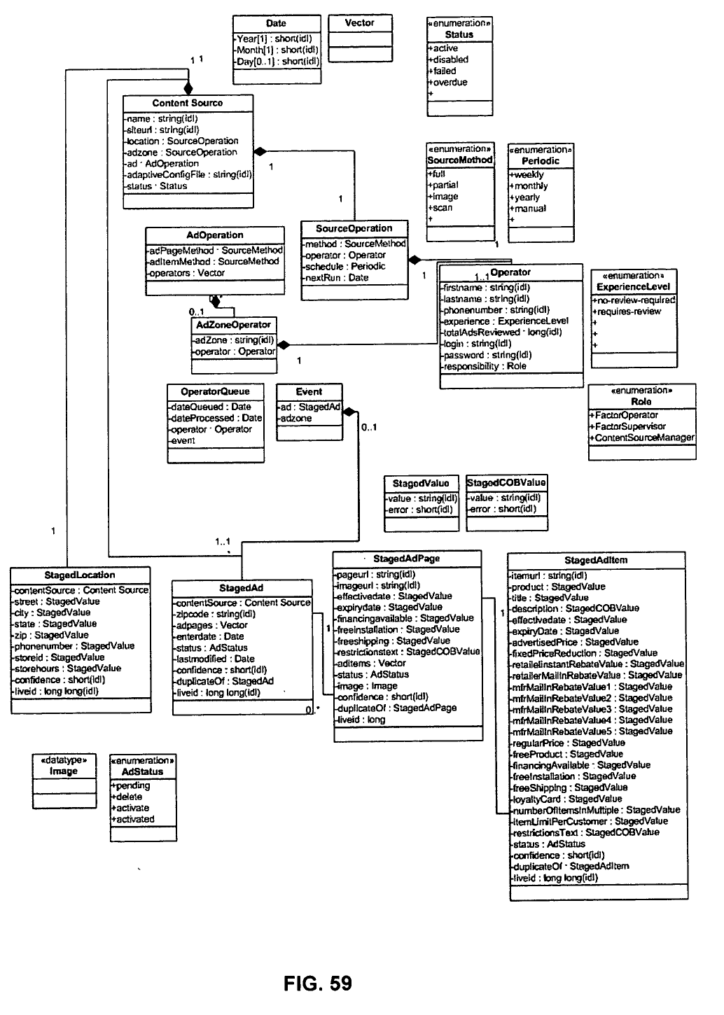

The schema supporting object model for the content management (shown in FIG. 59) resides in its own database user. No foreign keys or other types of links exist between the content management's schema and the Cairo server's schema.

There are two basic parts to the object model, staging tables and operator queuing. The staging tables support the storage and retrieval of all content extraction. The operator queuing objects support the operation of the Content Management tool, including events and source maintenance.

Cairo Revenue Model and Business Services

Cairo provides a unique channel to the consumer for retailers, manufacturers, and other advertisers—focused on price comparison and advertising within a local retail market, reaching consumers at the point of decision making about what to buy and where to shop. This presents many advertising, targeted marketing, and one-to-one pricing opportunities, enhanced by the rich consumer segmentation data about Cairo members.

This section describes Cairo's planned revenue streams and associated business services, including the web affiliate program offering embedded Cairo web services.

Cairo Revenue Streams

Cairo may generate revenues from some combination of the following sources (each of which is described in more detail below):
Cairo membership fees (from consumers).
Transaction fees for “automated” Cairo Price Match refunds.
Paid sponsorship of local ads in Cairo Search results, ad thumbnails on the Cairo Home Page, and “context specific” ad thumbnails on product category pages.
Banner ads and pop ups on the Cairo Home Page and when using Cairo Ad Alerts, Cairo Everyday Savings, and/or the Cairo Store Locator.
One-to-one offers and pricing within Cairo Everyday Savings (influencing the “alternative” offers and manufacturer coupons displayed).
Data syndication fees from selling customer segmentation and behavioral data.
Competitive price data services for retailers and manufacturers.
   Cairo Membership Fees

Cairo may support a tiered membership model, including the following levels:
Basic Membership
Full Membership
Unlimited Membership

“Basic” membership is free and provides the consumer with full access to Cairo Search, bundled with limited capacity to access more advanced Cairo services. For example, the consumer may be limited to no more than ten Cairo Ad Alerts at any time, up to five Cairo Price Match purchases, and/or a limited number of Cairo Everyday Savings shopping trips. This encourages them to “test drive” all Cairo services.

“Full” membership requires a nominal upfront, annual fee (e.g. $10 per year) and provides access to all Cairo services, capped to fairly generous capacity limits for each type of service (e.g. up to 25 Cairo Price Match purchases per year).

“Unlimited” membership also requires an upfront annual fee but provides full Cairo access with no capacity constraints. This is priced attractively at a relatively small premium to “full” membership, to upsell the consumer to the more expensive choice.

Transaction Fees from Cairo Price Match

Basic access to Cairo Price Match is covered by Cairo Membership fees. This helps the consumer identify Cairo Price Match refunds and provide instructions for the consumer to claim the refund from the retailer (usually by returning to the original store).

Cairo also offers a service to fully automate the process for claiming the refund (or store credit) as described in the Cairo Price Match section. This allows the consumer to simply log the Cairo Price Match purchase and wait to see if a refund or store credit arrives in the mail (or their email inbox). An additional transaction fee is charged by Cairo for this automated refund process—as a percentage of the refund amount (e.g. Cairo may deduct 10% of any refund amount paid to the consumer). This usually results in the consumer still receiving a refund for any price difference, as retailer's price match policies most times refund the difference in price plus 10% (or more).

Consumers must “opt in” to automated Cairo Price Match refunds and agree to pay the Cairo transaction fees for each refund paid (which most will find an easy decision).

Paid Sponsorship of Local Ads

Cairo may allow retailers to sponsor their local ads to influence their positioning within Cairo Search Results. Sponsorship also allows the retailer to profile their local ads on the Cairo Home Page, in any of the Cairo product category drill down pages (context specific to that category), and within the Browse by Retailer pages. Cairo ad sponsorship functions in a similar manner to existing “paid search” models, but is 100% focused on local ad content (as opposed to broad Internet search). Fees are paid based on “click through” results to the retailer's website and online circular (or may be based on consumer requests to view a larger version of the retailer's ad in the Cairo Ad Browser).

Banner Ads and Pop Ups

Traditional Internet advertising using banner ads and pop ups may generate additional revenues and can be highly context sensitive based on the consumer's actions. This provides and effective way of reaching the consumer with advertising messages tailored to the items they are trying to purchase. For example, banner ads in Cairo Everyday Savings may be targeted based on the consumer's preferences for a specific brand or item. Alternatively, banner ads in the Cairo Store Locator may be based upon the store type that is being located.

One-to-One Marketing and Individual Pricing

Cairo allows the consumer to easily search and compare locally advertised prices from retailer's existing “mass market” ad circulars. But, retailers and manufacturers may also leverage Cairo as a channel to the consumer for tailored or targeted offers (or individual pricing) for a very specific consumer segment (determined based on the consumer's shopping preferences and search/purchase history). Cairo may charge retailers and manufacturers transaction fees for delivering targeted offers and individual pricing through the results pages of Cairo Search, Cairo Ad Alerts, and Cairo Everyday Savings. Cairo Everyday Savings is highly focused on items that typically attract significant trade marketing dollars from manufacturers. The “alternative offers” and “manufacturer coupons” columns provide a targeted delivery mechanism, to display offers which are highly correlated to the consumer's shopping preference, but that encourage them to try something different. For example, if a new laundry detergent is being introduced, the manufacturer may pay to display ads for their new product together with a coupon for that item—these ads are shown right next to the best offers that Cairo can find for the consumer's preferred laundry detergent at the time they are finalizing their shopping list.

Data Syndication

Cairo captures a large amount of “consumer centric” data based on each consumer's shopping preferences, their search/purchase history, and their responsiveness to special offers and advertised prices. This data is cross retailer and product category, providing valuable insight to retailers, manufacturers, and other advertisers about how different consumer segments respond to their advertising and marketing and how to better influence consumer behavior.

This data are sold by Cairo through existing data syndication players, like ACNeilsen and IRI, to supplement existing POS and loyalty data sources in the CPG and other retail segments. Data syndication is currently a $1 billion business in the US market alone. Cairo information may be sold only at the aggregated, as opposed to personal level, ensuring that the privacy of Cairo members is not compromised.

Competitive Price Services (for Retailers and Manufacturers)

Retailers are constantly evaluating their competitive positioning in the market and currently pay competitive shopping services to survey both regular and advertised prices at competing stores. This is currently about a $50m business in the US, led by companies like QRS. Most retailers are unhappy with the quality of the data captured by these providers, but face increasing needs for this type of data (e.g. to support new price optimization technologies).

Cairo captures significant regular and advertised price information across many retailers to support its consumer facing services. It is also well placed to sell this same data back to the retailers, providing this data more economically and accurately than the existing competitive price shopping service. In the short term, Cairo may focus on supplementing existing price shopping services with Cairo's local ad prices and content. Once retailers are sending prices electronically to Cairo to be published in the public domain, Cairo is well placed to act as a clearing house for price information amongst retailers.

Web Affiliates Program

Cairo's web affiliates program allows other web site operators to embed Cairo technology within their own websites to provide value added Cairo services for their own online communities, including Cairo Search™ and Cairo Price Match™. Other Cairo services, including Cairo Everyday Savings™, may be offered via web affiliates. Both the Cairo Price Match and Cairo Search sections describe the detailed use cases for web affiliates to deploy and make available Cairo's embeddable widgets.

Any ad sponsorship revenues that are generated from consumer access to Cairo's web services via the embedded Cairo widgets may be shared with the applicable affiliate partner. This requires Cairo to track the origin of consumer's access to Cairo web services and capture this information alongside “click through” activity to retailer's local ads. Cairo may also share any transaction fees resulting from automated Cairo Price Match refunds captured via the embeddable Price Match widget in affiliate web sites.

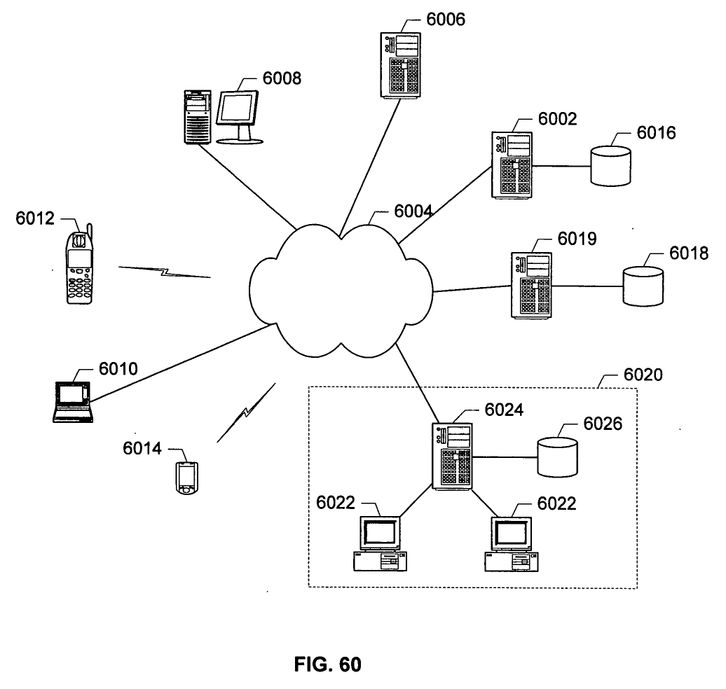

FIG. 60 is a generalized diagram illustrating exemplary computing devices and networks which may be employed to implement various embodiments of the inventions described herein. It will be understood that this diagram is intended to provide examples of the manner in which various embodiments may be implemented. As such, neither this diagram nor the following description should be used to limit the scope of the invention.

A hosted platform 6002 may be employed to facilitate many of the functionalities described herein via network 6004. As will be understood platform 6002 may represent anything from a single, stand-alone server to a distributed collection of network devices. Likewise, network 6004 may correspond to any type or combination of networks including, for example, local and wide area networks, the Internet, the World Wide Web, wired and wireless telecommunications networks, cable networks etc. Various of the functionalities described herein may also be embedded in third party sites represented by server 6006.

Consumers may access the functionalities of the present invention and provide information required to facilitate such access in a variety of ways as represented by tower and laptop computers 6008 and 6010, wireless communication device 6012, and handheld mobile computing device 6014. It will be understood that these exemplary devices are not intended to represent an exhaustive list. Rather, the point being made is that the means by which consumers take advantage of the present invention should not be viewed restrictively.

The content underlying many of the functionalities described herein may reside in a data store 6016 associated with platform 6002, or in a data store 6018 at some remote site 6019 on the network. The content may also reside in a content factory 6020 represented by computers 6022, server 6024, and data store 6026.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein which employ many conventional Internet and Web technologies to deliver the various novel functionalities of the present invention. However, the invention is not restricted to the Internet, the Web or the specific mechanisms described. Rather, reference to the Internet, the Web and specific Web-related technologies is made merely for illustrative purposes. It should be understood that the present invention may be implemented using any of a wide variety of computing and networking paradigms.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

1. A computer-implemented method for aggregating local retail information, comprising:
identifying a plurality of web sites including retail information, the retail information including geographic location information for corresponding retailers;
retrieving and storing at least a portion of the retail information in a database indexed by the geographical location information;
monitoring the plurality of web sites on an ongoing basis to detect changes in the retail information; and
updating the database in response to the changes in the retail information.

2. The method of claim 1 wherein the plurality of web sites comprises any of retailer web sites corresponding to the retailers and newspaper web sites which provide advertising corresponding to the retailers.

3. The method of claim 1 wherein monitoring the plurality of web sites comprises periodically monitoring the web sites to determine whether the changes have been made to the retail information.

4. The method of claim 1 wherein monitoring the plurality of web sites comprises receiving alerts from the web sites when the changes have been made to the retail information.

5. The method of claim 1 wherein at least a portion of the retail information and at least a portion of the changes in the retail information are extracted automatically from at least some of the plurality of web sites.

6. The method of claim 1 further comprising generating a notification message when at least a portion of the retail information or at least a portion of the changes in the retail information cannot be extracted automatically from at least some of the plurality of web sites.

7. The method of claim 6 further comprising extracting the at least a portion of the retail information or the at least a portion of the changes in the retail information manually in response to the notification.

8. The method of claim 1 wherein at least a portion of the retail information and at least a portion of the changes in the retail information are provided by selected ones of the retailers.

9. The method of claim 1 wherein monitoring of the plurality of web sites is accomplished using multiple web crawlers, each of which is responsible for a portion of the retail information corresponding to a particular geographic region.

10. The method of claim 1 wherein the retail information comprises any of retailer name, a valid ad location, a valid ad time period, product information, price information, promotion information, one or more key search words, UPC information, product image.

11. The method of claim 1 further comprising providing the retail information for a particular geographic region to a consumer, wherein the geographic region corresponds to a portion of the geographic location information and is determined with reference to geographic region information corresponding to the consumer.

12. The method of claim 11 wherein the geographic region information is provided by the consumer.

13. The method of claim 12 wherein the geographic region information comprises any of zip code, city, county, street address, and street intersection.

14. The method of claim 11 wherein the geographic region information is determined with reference to a current location of the consumer without requiring input by the consumer.

15. The method of claim 14 wherein the current location of the consumer is determined with reference to a location of a computing platform associated with the consumer.

16. A computer program product comprising at least one computer-readable medium having computer program instructions stored therein which are operable to cause a computer to perform the method of claim 1.

17. At least one computer-readable medium comprising a database generated according to the method of claim 1.
